(19) United States
(12) Patent Application Publication
(10) Pub. No.: US 2026/0219498 A1
(43) Pub. Date: Jul. 30, 2026

(54) Reflection Suppression Device

(71) Applicant: Envisics Ltd, Milton Keynes (GB)

(72) Inventors: Yiren Xia, Milton Keynes (GB); Timothy Smeeton, Milton Keynes (GB); Celedonia Krawczyk, Milton Keynes (GB)

(21) Appl. No.: 19/157,901

(22) PCT Filed: Oct. 17, 2023
(86) PCT No.: PCT/EP2023/078809

§ 371 Date: Aug. 19, 2025

(30) Foreign Application Priority Data
Mar. 10, 2023 (GB) 2303536.3

(51) Int. Cl. G02B 27/01; B32B 3/30; B32B 7/023; B60K 35/23

(52) U.S. Cl. CPC G02B 27/0103; B32B 3/30; B32B 7/023; B32B 2307/412; B32B 2605/00; B60K 35/23; B60K 2360/23; B60K 2360/29; G02B 2027/0118; G02B 2207/123

(57) ABSTRACT

There is provided a head-up display for a vehicle. The head-up display comprises a substantially planar waveguide having a reflective surface arranged, during head-up display operation, in a configuration that is conducive to sunlight glare. The head-up display further comprises a reflection suppression device. The reflection suppression device comprises a first layer comprising a first serrated surface arranged to receive a holographic wavefront from the waveguide and provide a first turn of the holographic wavefront having at least a component on a first plane containing a surface normal of the waveguide, wherein the first layer is formed of transparent material. The reflection suppression device further comprises an intermediate layer arranged to receive the holographic wavefront from the first layer, wherein the intermediate layer comprises a plurality of louvres in an array, each louvre comprising a light absorbing material. The reflection suppression device further comprises a second layer arranged to receive the holographic wavefront from the intermediate layer. The second layer comprises a second serrated surface arranged to provide a second turn of the holographic wavefront having at least a component on the first plane. The component of the second turn on the first plane is equal and opposite to the component of the first turn on the first plane.

### FIELD

The present disclosure relates to a reflection suppression device and to methods of manufacturing a reflection suppression device. More specifically, the present disclosure relates to a reflection suppression device for use with an optical component of a head-up display for a vehicle.

### BACKGROUND AND INTRODUCTION

Light scattered from an object contains both amplitude and phase information. This amplitude and phase information can be captured on, for example, a photosensitive plate by well-known interference techniques to form a holographic recording, or “hologram”, comprising interference fringes. The hologram may be reconstructed by illumination with suitable light to form a two-dimensional or three-dimensional holographic reconstruction, or replay image, representative of the original object.

Computer-generated holography may numerically simulate the interference process. A computer-generated hologram may be calculated by a technique based on a mathematical transformation such as a Fresnel or Fourier transform. These types of holograms may be referred to as Fresnel/Fourier transform holograms or simply Fresnel/Fourier holograms. A Fourier hologram may be considered a Fourier domain/plane representation of the object or a frequency domain/plane representation of the object. A computer-generated hologram may also be calculated by coherent ray tracing or a point cloud technique, for example.

A computer-generated hologram may be encoded on a spatial light modulator arranged to modulate the amplitude and/or phase of incident light. Light modulation may be achieved using electrically-addressable liquid crystals, optically-addressable liquid crystals or micro-mirrors, for example.

A spatial light modulator typically comprises a plurality of individually-addressable pixels which may also be referred to as cells or elements. The light modulation scheme may be binary, multilevel or continuous. Alternatively, the device may be continuous (i.e. is not comprised of pixels) and light modulation may therefore be continuous across the device. The spatial light modulator may be reflective meaning that modulated light is output in reflection. The spatial light modulator may equally be transmissive meaning that modulated light is output in transmission.

A holographic projector may be provided using the system described herein. Such projectors have found application in head-up displays, “HUD”.

### SUMMARY

Aspects of the present disclosure are defined in the appended independent claims.

Broadly, the disclosure relates to a head-up display comprising an optical component, such as a waveguide, having a reflective surface. The head-up display is arranged such that light encoded with picture content is directly or indirectly relayed towards an eye-box. The light encoded with picture content may be a holographic wavefront (in other words, light which is spatially modulated in accordance with a hologram of the picture). The head-up display further comprises a reflection suppression device. The reflective surface may be susceptible to cause glare by reflecting sunlight onto an optical path to a user. This could be distracting and uncomfortable for a driver of the vehicle. Thus, the reflection suppression device is provided to reduce said glare.

The reflection suppression device according to the disclosure comprises a plurality of louvres arranged in an array, each louvre comprising a light absorbing material. The head-up display may be arranged so that the holographic wavefront is relayed from the optical component (e.g. waveguide) over a limited range of angles. The louvres of the reflection suppression device are arranged to allow for the transmission of the holographic wavefront substantially over the limited range of angles while blocking/absorbing light incident on the reflection suppression device outside of this range of angles. The reflection suppression device further comprises a serrated surface. The serrated surface provides an array of angled surfaces that direct sunlight away from the eye-box. In particular, most sunlight incident on the serrated top surface may be reflected and the angled surfaces change the course or path of the specular reflection of the sunlight or glare.

As used herein, “light absorbing” (for example in the context of the light absorbing material) means that at least 90% of incident light, optionally at least 95%, optionally 99% of light incident thereon is absorbed. In some embodiments, light absorbing may mean that light incident thereon is substantially blocked. Thus, the louvres (formed of light absorbing material) may absorb at least 90% (optionally at least 95%, or 99%) of light incident thereon. The louvres may therefore be effective at absorbing sunlight/glare.

As above, a head-up display may be arranged such that holographic wavefront is directly or indirectly relayed towards an eye-box by optical components (including the waveguide having a reflective surface). The holographic wavefront must follow the correct optical path if it is to be relayed to the eye-box. Each of the optical components should be correctly aligned to ensure that the holographic wavefront follows that path. To ensure that the holographic wavefront follows the desired path, the reflection suppression device according to the disclosure is advantageously arranged such that a net turn (i.e. change in direction) of the holographic wavefront provided by features of the reflection suppression device on at least a first plane is zero. In particular, the reflection suppression device comprises top and bottom layers. The reflective suppression device may be formed from a transparent material such as glass or plastic. The top layer may comprise the above described serrated surface arranged to deflect sunlight but this top layer may introduce a turn component on at least the first plane owing to a refractive index difference with the surrounding medium which may be air. The inventors have recognised that a bottom layer comprising another serrated surface can be provided to cancel out this turn component (at least on the first plane). Thus, there is no need to correct for deviations of the holographic wavefront (in at least the first plane) by altering the optical components of the head-up display to compensate for the changes introduced by the reflection suppression device (for example, by tilting the waveguide) or even by tilting the entire head-up display. Both of these alternative compensation approaches are undesirable because they may increase the overall volume of space that needs to be reserved for the head-up display. For example, the head-up display may be substantially comprised within the dashboard of a vehicle. In this part of the vehicle, real-estate/space may be highly valuable. In some cases, the optimum packaging of the head-up display may comprise the waveguide lying substantially horizontal within the dashboard. Thus tilting the waveguide (or the entire head-up display) may deviate from this optimum packaging and undesirably increase the volume (within the dashboard) needed to be reserved for the head-up display.

The reflection suppression device according to the disclosure advantageously has a layered structure. In particular, top and bottom layers of the reflection suppression device comprise serrated surfaces while an inner (intermediate) layer comprising the array of louvres is sandwiched between the top and bottom layers. The inventors have found that such an arrangement may be suitably mechanically strong and rigid to meet requirements for head-up displays in vehicles (such as cars). This may include being able to withstand deformation in response to vibrations of a moving vehicle. This may also include being able to withstand cleaning of exterior surfaces of the reflection suppression device (which may be a/the only exposed surface of the head-up display in a vehicle). For example, the louvres of the intermediate layer may be relatively thin and may be delicate. The louvres of the intermediate layer per se may not have suitable strength to support themselves. In some embodiments, the louvres/intermediate layer may be provided as a film. The louvres may be microstructures formed on/as part of the film. Again, the film or the microstructures may be delicate and may not be self-supporting. However, the top and bottom layers advantageously sandwich the intermediate layer. The top and bottom layers may be made of relatively strong and durable materials such as hard (transparent) plastics and so may protect the (inner) intermediate layer. Furthermore, such top and bottom layers may advantageously provide mechanical support and rigidity to the reflection suppression device as a whole while also providing external surfaces of the reflection suppression device/head-up display that are strong enough to withstand cleaning.

Furthermore, because the reflection suppression device according to the disclosure is layered, a fast, simple and low-cost manufacturing method may be used to manufacture the reflection suppression device. For example, in such methods, each of the layers of the reflection suppression device may be provided separately. For example, the layers may be manufactured separately and/or may be provided as “of the shelf” components. It may be straightforward to combine the three (separate) layers/components (i.e. to combine separate first, intermediate and second layers). For example, the first layer may be at least partially fixed to one side of the intermediate layer and the second layer may be at least partially fixed to an opposite side of the intermediate layer. This may be in a lamination process. An adhesive may be used to permanently fix the layers together in the lamination process. Such a lamination process may advantageously be fast, simple and may be suitable for mass production. In some embodiments, a continuous lamination process may be used in which continuous sources (such as rolls) of the first, intermediate and second layers are combined/laminated together to form a continuous reflection suppression device. The continuous reflection suppression device may advantageously be cut to a desired size to create an individual reflection suppression device for use in a head-up display. Such (continuous) manufacturing methods are fast, low cost and simple and so it is advantageous that the layered reflection suppression device of the first aspect can be manufactured according to such methods.

In some embodiments, the reflection suppression device of the present disclosure is advantageously arranged to simultaneously perform the function of glare reduction and the function of another optical component such as another optical component necessary to optimise packaging within a head-up display. In particular, the reflection suppression device of the present disclosure may advantageously be arranged to perform the function of glare reduction while also replacing the functionality of a light turning layer arranged to align the output of the head-up display with a desired viewing area or volume. Some head-up displays comprise a turning layer or film to turn the light of the head-up display (for example, such that the holographic wavefront is received at an eye-box on the driver side of a vehicle despite the waveguide being substantially centrally located in the vehicle in some examples). In some embodiments, the reflection suppression device may be arranged to perform that turning function and so may advantageously replace the turning layer. Thus the reflection suppression device disclosed herein may advantageously reduce the number of components needed to manufacture a head-up display (comprising a reflection suppression device) which may provide associated reductions in cost and complexity of the head-up display.

In summary, the reflection suppression device provided in the present disclosure is advantageously a) able to substantially suppress or eliminate sunlight or glare from being reflected by a reflective surface (of a waveguide) from reaching an eye-box of a head-up display; b) mechanically strong and rigid; c) suitable for reliable, fast and efficient mass production; d) substantially eliminates deviations in the holographic wavefront that is received by the reflection suppression relative to the holographic wavefront that is transmitted by reflection suppression device (at least in a first plane); and e) (in some embodiments) replaces the function of a turning film which might otherwise be present in the system.

In a first aspect, there is provided a head-up display for a vehicle. The head-up display comprises a substantially planar waveguide. The waveguide comprises a reflective surface. The reflective surface is arranged, during head-up display operation, in a configuration that is conducive or susceptible to causing sunlight glare. As such, in the absence of a reflection suppression device, sunlight or glare at certain angles may be reflected by reflective surface and relayed (directly or indirectly) to an eye-box. Thus, the head-up display further comprises a reflection suppression device which is arranged to substantially suppress said reflections of sunlight or glare and prevent the sunlight or glare from reaching the eye-box.

The reflection suppression device comprises a first layer comprising a first serrated surface arranged to (directly or indirectly) receive a holographic wavefront from the waveguide. The first layer is also arranged to provide a first turn (e.g. rotation/change of angle) of the holographic wavefront having at least a component on a first plane containing a surface normal of the waveguide. The first layer is formed of transparent material.

The reflection suppression device further comprises an intermediate layer. The intermediate layer is arranged to receive the holographic wavefront from the first layer. The intermediate layer comprises a plurality of louvres in an array. Each louvre of the array of louvres comprises a light absorbing material. In some embodiments, a periodicity of the first serrated surface is substantially equal to a periodicity of the array of louvres.

The reflection suppression device further comprises a second layer arranged to receive the holographic wavefront from the intermediate layer. The second layer comprises a second serrated surface arranged to provide a second turn of the holographic wavefront. The second turn of the holographic wavefront has at least a component on the first plane. The component of the second turn on the first plane is equal and opposite to the component of the first turn on the first plane. In other words, the net or sum of the components of the first and second turns on the first plane is zero. In yet other words, the two turns or rotations cancel each other out—at least on the first plane.

As used herein, a layer of the reflection suppression device “providing a turn” of the holographic wavefront means that the respective layer causes a change/turn/bend/corner to a (general) propagation path of the holographic wavefront. In particular, the respective layer may cause the holographic wavefront to deviate from an initial propagation path (when the holographic wavefront is incident on the respective layer), thus introducing a turn in the propagation path. There may be a non-zero angle between a first portion of the propagation path of the holographic wavefront on the input on the respective layer and a second portion of the propagation path on an output of the respective layer. In some examples, the first layer providing a first turn of the holographic wavefront may cause a first change/turn/bend in the propagation path of the holographic wavefront. In some examples, the second layer providing a second turn of the holographic wavefront may cause a second change/turn/bend in the propagation path of the holographic wavefront.

The first and second layers are defined above in terms of first and second turns provided to a holographic wavefront received from the waveguide. However, it should be clear that corresponding turns will also be provided by the first and second layers to light propagating through the reflection suppression device in the opposite direction (e.g. sunlight or glare received at the second surface initially). As will be described in more detail below, the application of these turns to sunlight/glare has the purpose of glare suppression. The inventors have recognised that, by having first and second layers being arranged to provide turns having equal and opposite components on the first plane, this glare suppression effect can be achieved without changing the angle of the holographic wavefront output by the reflection suppression device relative to the holographic wavefront input to the reflection suppression device. In particular, by cancelling out the components of the turns on at least the first plane, light that is received by the reflection suppression device may be substantially parallel (in the first plane) to the light that is transmitted at the opposite side of the reflection suppression device. Thus, the inclusion of the reflection suppression device advantageously does not require a change in the position or angle of the waveguide and/or head-up display as a whole to compensate for deviations of the holographic wavefront in the first plane (and, optionally, the second plane).

The first layer may be a bottom layer of the reflection suppression device. The first (bottom) layer may be closer to the waveguide of the head-up display than the second layer. The second layer may be a top layer of the reflection suppression device. The second (top) layer may be closer to first layer than the waveguide of the head-up display. The reflection suppression device may be described as having an input side and an output side. In some embodiments, the first layer may form the input side and the second layer may form the output side. In some embodiments, the input side may be arranged to receive the holographic wavefront from the waveguide and the output side may be arranged to output the holographic wavefront after it has propagated through the first, intermediate and second layers. The angle of light received at the input side of the reflection suppression device relative to the angle of light transmitted at the output side of the reflection suppression device in the first plane may be zero degrees.

The reflection suppression device advantageously substantially reduces or eliminates sunlight or glare from being reflected by the reflective surface of the waveguide to an eye-box of the head-up display.

Said light (in particular, sunlight or glare) may be received at the reflection suppression device at the output/second layer (i.e. an opposite side to that which receives the holographic wavefront). The serrations of the second serrated surface advantageously are arranged to reflect a relatively large proportion of the sunlight/glare and to redirect that reflection away from an eye-box of the head-up display. A remaining proportion of the sunlight/glare may be transmitted by the second serrated surface (rather than reflected). The second layer of the reflection suppression device may provide a first turn on the transmitted portion of sunlight/glare. The (turned) transmitted portion of sunlight/glare may propagate to the intermediate layer. Mostly, the turned sunlight or glare will be received and absorbed by one or more of the louvres of the intermediate layer. Some sunlight/glare, having a narrow range of propagation angles, may continue to propagate from the intermediate layer to the first layer. The first layer may provide a second turn on the sunlight/glare which may then be reflected by the reflective surface of the waveguide back to the first layer again. The first layer may then provide a third turn on the sunlight/glare before the sunlight/glare is received by the intermediate layer a second time. Through experimentation and simulation, the inventors have found that, after this third turn, any remaining sunlight/glare will substantially all be absorbed by the louvres of the intermediate layer. In particular, the inventors have found that providing the turn at the first layer (twice) as the sunlight/glare propagates between the first layer and waveguide and back makes it effectively inevitable that the sunlight/glare will be absorbed by a louvres. So, the reflection suppression device (with the second layer) can be arranged such that substantially no sunlight/glare that is transmitted into the reflection suppression device at the second layer is able to escape the reflection suppression device. Thus, glare at the eye-box may be substantially eliminated by the reflection suppression device.

In some embodiments, at least one of the first, intermediate and second layers lie in respective planes that are substantially parallel to a plane of the waveguide. Optionally, each of the first, intermediate and second layers lies in respective planes each of which is substantially parallel to the plane of the waveguide. In other words, the surface normal of the waveguide may be substantially parallel to a surface normal of at least one of the first, intermediate and second layers, optionally each of the first, intermediate and second layers.

In some embodiments, the first layer comprises/is formed of a substantially transparent material having a refractive index greater than 1. The first layer may be arranged such that the combination of the shape of the first layer and the refractive index of the first layer (relative to an adjacent component/air) provides the first turn to the holographic wavefront. In some embodiments, the second layer comprises/is formed of a substantially transparent material having a refractive index greater than 1. Similarly, the second layer may be arranged such that the combination of the shape of the second layer and the refractive index of the second layer (relative to an adjacent component/air) provides the second turn to the holographic wavefront.

In some embodiments, the refractive index of the material of the first layer is substantially the same as the refractive index of the material of the second layer.

In some embodiments, the intermediate layer comprises a substantially transparent material. The array of louvres of the intermediate layer may be contained or embedded in, or otherwise separated by, the substantially transparent material. The substantially transparent material of the intermediate layer may have a refractive index that is substantially equal to (e.g. equal to) the refractive index of the substantially transparent material of the first layer. The substantially transparent mater of the intermediate layer may have a refractive index that is substantially equal to (e.g. equal to) the refractive index of the substantially transparent material of the second layer. After thorough simulation and experimentation, the inventors have surprisingly found that matching the refractive index of the substantially transparent material of the intermediate layer with that of the first and/or second layer may reduce glare at an eye-box/viewing window at specific angles.

In some embodiments, a thickness of the first layer in the first plane may be defined between the first serrated surface and an opposing second surface of the first layer. The thickness of the first layer in the first plane may vary along a length of each individual serration in the first plane in a first direction. The serrations of the first layer having a profile/shape in this way may provide the component of the first turn of the holographic wavefront in the first plane. The first layer may be solid between the first serrated surface and the opposing second surface of the first layer. The first serrated surface may comprise a plurality of individual serrations. Each serration may be defined by a surface portion which is angled (in particular, not-parallel) with respect to a corresponding opposing portion of the second surface of the first layer.

In some embodiments, the first layer comprises a first non-serrated surface. The first non-serrated surface may be the second surface of the first layer (opposite to the first serrated surface). The first non-serrated surface may be substantially planar or flat. A normal of the first non-serrated surface may be substantially parallel to the surface normal of the waveguide. The first non-serrated surface is at least partially fixed to the intermediate layer and/or at least partially in contact with the intermediate layer. This may be particularly suitable for a method of manufacturing comprising lamination of the layers reflection suppression device.

In some embodiments, a thickness of the second layer in the first plane may be defined between the second serrated surface and an opposing second surface of the second layer. The thickness of the second layer in the first plane may vary along a length of each individual serration in the first plane in the first direction. The thickness of the second layer may vary in an opposite fashion to the thickness of the first layer (in the first direction). For example, if a first portion of first layer increases in thickness in the first direction, a corresponding portion of the second layer may decrease in thickness in the first direction. The serrations of the second layer having a profile/shape in this way may provide the component of the second turn of the holographic wavefront in the first plane. The second layer may be solid between the second serrated surface and the opposing second surface of the second layer. The second serrated surface may comprise a plurality of individual serrations. Each serration may be defined by a surface portion which is angled (in particular, not-parallel) with respect to a corresponding opposing portion of the opposing second surface of the second layer.

In some embodiments, the second layer comprises a second non-serrated surface opposite to the second serrated surface. The second non-serrated surface of the second layer may be the second surface of the second layer (opposite to the second serrated surface). The second non-serrated surface may be substantially planar or flat. A normal of the second non-serrated surface may be substantially parallel to the surface normal of the waveguide. The second non-serrated surface is at least partially fixed to the intermediate layer and/or at least partially in contact with the intermediate layer. This may be particularly suitable for a method of manufacturing comprising lamination of the layers reflection suppression device.

In some embodiments, the serrations of the second serrated surface may be substantially parallel to respective serrations of the first serrated surface. In particular, this may be the case at least for a cross-section of the serrations, the cross-section being in or parallel to the first plane.

In some embodiments, the angle of the angled surface portion of each serration of the second serrated surface is substantially equal, but opposite, to the angle of the angled surface portion of each serration of the first serrated surface. Said angle may be an angle between the normal of each angled surface portion of each serration of the second serrated surface and the normal of the respective angled surface portion of the first serrated surface (or vice versa). This may be the case when both the first and second layers are formed of/comprise a material having the same refractive index as such an arrangement/shape of serration may advantageously ensure that the components of the first and second turns that are on the first plane are equal and opposite.

Each of the serrations of the first or second serrated surfaces may be formed by a portion of the first or second serrated surface that is angled with respect to a general plane of the reflection suppression device. The or each portion of the first or second serrated surface forming a serration may have a constant angle with respect to the plane of the reflection suppression device. In other words, each serration/angled surface may have a linear profile. The first and/or second serrated surface may be described as having a sawtooth configuration or shape. In such cases, the angled surface portion associated with each serration of the first and/or second serrated surface may be substantially planar. This may result in the thickness of the first layer in the first plane linearly varying along a length of each individual serration in the first plane. Alternatively, the or each portion of the first or second serrated surface forming a serration may have a changing angle with respect to the plane of the reflection suppression device.

In some embodiments, a periodicity of the second serrated surface is substantially equal to the periodicity of the first serrated surface. Thus, the periodicity of the second serrated surface may also be substantially equal to the periodicity of the array of louvres. Each serration of the second serrated surface may be associated with or correspond to a respective serration of the first serrated surface.

In some embodiments, the first layer is arranged such that a net turn of the holographic wavefront by the reflection suppression device on a second plane is zero.

As used herein, a “net turn” in a plane that is provided by the reflection suppression device refers to the overall turn of the holographic wavefront at an output side of the reflection suppression device compared to the input. For example, the “net turn” (e.g. rotation or change of direction) on the first plane may refer to an angle between a component of the holographic wavefront at the output side of the reflection suppression device relative to a component of the holographic wavefront at the input side of the reflection suppression device. A zero net turn may mean that the holographic wavefront at the output side of the reflection suppression device is parallel to the holographic wavefront at the input side of the reflection suppression device (at least on a particular plane).

In some embodiments, the reflection suppression device may be arranged such that a component of the first turn on the second plane is equal to and opposite a component of the second turn on the second plane is equal. This may be such that the components of the first and second turns on the second plane cancel each other out (i.e. the net turn on the second plane is zero). In some embodiments, the components of the first and second turns on the second plane may be zero (such that the net turn on the second plane is also zero).

The second plane may be different to the first plane. In other words, the respective normal of the first and second planes may not be parallel to one another/may be angled with respect to one another.

In some embodiments, the second plane is orthogonal to the first plane. In some embodiments, the respective normal of both the first and second planes may be orthogonal to the surface normal of the waveguide.

In some embodiments, the head-up display further comprises a turning layer arranged to receive a holographic wavefront from the waveguide. The turning layer may be arranged to provide a turn having a component on the second plane containing a surface normal of the waveguide (described above). In a head-up display there may be a need to turn the holographic wavefront so that the eye-box is formed at a desired position. For example, for a head-up display in a vehicle, there may be a need for the eye-box to be formed on the driver-side of the vehicle. The turning layer may be arranged to provide a turn on the second plane which ensures that the eye-box is formed as desired (rather than, for example, at a more central position between a driver and a passenger). A turn in an opposite direction may be used if the eye-box is to be formed on the passenger-side of a the vehicle instead.

The turning layer may be adjacent to the first layer of the reflection suppression device. The turning layer may be in contact with the first layer of the reflection suppression device. The turning layer may be at least partially fixed to the first layer of the reflection suppression device. The first layer may be arranged to receive the holographic wavefront directly from the turning layer. The turn provided by the turning layer may be referred to as a third turn. The head-up display may be arranged such that the third turn is provided by the turning layer before the first turn (which is provided by the first layer).

In some embodiments, the first layer and/or second layer is arranged such that the first turn has a component on the second plane (defined above). In some embodiments, the reflection suppression device may be arranged such that a net turn of the holographic wavefront on the second plane is non-zero. In some embodiments, the net turn of the holographic wavefront on the second plane may be at least 5 degrees, optionally at least 10 degrees. For example, the first and second layers may be arranged such that the component of the first turn on the second plane is not equal and opposite to the component of the second turn on the second plane. In some embodiments, the first layer is arranged such that the magnitude of the component of the first turn on the second plane is greater than the magnitude of the component of the second turn on the second plane. In some embodiments, the second layer is arranged such that the magnitude of the component of the second turn on the second plane is greater than the magnitude of the component of the first turn on the second plane.

In some embodiments, the first and second layer are arranged such that the respective the first and second turns on the second plane are in the same (clockwise or anticlockwise) direction. In other words, the components of both the first and second turns on the second plane may be in the clockwise (or anticlockwise) direction on the second plane. Thus, the net turn of the holographic wavefront is in the clockwise direction. In such embodiments, the magnitude of the components of the first and second turns on the second plane may be the same or different. As used herein, a component of a turn of a holographic wavefront being in a “clockwise” or “anticlockwise” refers to the outgoing holographic wavefront (after the turn) relative to incoming the holographic wavefront (before the turn). The terms “clockwise” and “anticlockwise” are used to indicate turns in different relative directions when the system is viewed from the same direction or viewing position. In particular, the first turn and second being may be viewed from the same direction or viewing position.

The inventors have recognised that such a reflection suppression device (having a non-zero net turn on the second plane) may advantageously replace the turning film described above altogether. This may advantageously allow for a simpler head-up display comprising fewer components. In such embodiments, the first layer and/or second layer of the reflection suppression device may be described as providing a turning function, or as forming a turning layer (rather than the head-up display comprising a turning layer which is a component that is separate from the reflection suppression device).

In some embodiments, the first layer comprises a plurality of microstructures arranged to form the serrated surface. The plurality of microstructures of the first layer may form a (one dimensional) array. In some embodiments, the second layer comprises a plurality of microstructures arranged to form the serrated surface. The plurality of microstructures of the second layer may form a (one dimensional) array.

The louvres may extend longitudinally in a second direction, and may be spaced apart in a direction that is orthogonal to the second direction. The separation between adjacent louvre slats in the second direction may be defined as the pitch. In some arrangements the pitch may be for all louvre slats of the array. It may be said that the spacing or periodicity of the louvres is uniform for the array. In other arrangements, the pitch may vary between slats of the array, such as from a first end to a second end of the array. It may be said that the spacing or periodicity of the slats of the array is non-uniform for the array.

In some embodiments, each microstructure of the first layer extends longitudinally in the second direction. The second direction may be substantially parallel to the longitudinal extension of the louvres/substantially parallel to a normal of the first plane, optionally wherein the first layer is a prismatic first layer comprising a plurality of individual (micro-) prisms. In some embodiments, each microstructure of the second layer extends longitudinally in the second direction. In such embodiments, the first and second layers may be arranged to provide a net-zero turn on the second plane to the holographic wavefront.

In some embodiments, each microstructure of one of the first and second layers extends longitudinally in a third direction that is different to the second direction. In such embodiments, each microstructure of the other of the first or second layers may extend longitudinally in the second direction. In such embodiments, the first and/or second layers may be arranged to provide a non-zero net turn on the second plane to the holographic wavefront. The second and third directions both lie in a third plane that is perpendicular to the normal of the waveguide. In some embodiments, each microstructure of the first layer extends longitudinally in the third direction and each microstructure of the second layer extends longitudinally in the second direction. In some embodiments, each microstructure of the second layer extends longitudinally in the third direction and each microstructure of the first layer extends longitudinally in the second direction.

In some embodiments, each microstructure of one of the first and second layers extends longitudinally in a fourth direction that is different to the second and third directions. In such embodiments, each microstructure of the other of the first or second layers may extend longitudinally in the third direction. The third and fourth directions both lie in the third plane. These may be other embodiments in which the first and second layers are arranged to provide a non-zero net turn on the second plane to the holographic wavefront.

In some embodiments, either or both of the first and second layers may be prismatic layers. For example, the or each of the first and second layers may comprise a plurality or array of prisms. The prisms may be micro-prisms. The prisms of the or each of the first and second layers may form the first and/or second serrated surfaces, respectively.

In some embodiments, the waveguide is arranged to receive the holographic wavefront and waveguide the holographic wavefront between a pair of reflective opposing surfaces thereof. The waveguide may be arranged to waveguide the holographic wavefront in a waveguiding direction. In some embodiments, the waveguiding direction lies in the first plane or is parallel to a normal of the first plane.

The louvres of the array of louvres may comprise a material having one or more of: high absorption; high attenuation; low specular reflectivity, and high diffusivity of light. The person skilled in the art of optics appreciates what constitutes “high” and “low” in relation to the optical properties of a material. In some embodiments, the term “high” means greater than 80% such as greater than 90% or 95% and the term “low” means less than 20% such as less than 10% or 5%. For example, the term “high attenuation” may mean that the intensity of incident light (e.g. sunlight) is attenuated (i.e. reduced) by at least 95%.

The louvre structure comprises a one-dimensional array of parallel longitudinal slats, each slat having a length, width (height) and a thickness. In embodiments, the louvres/louvre slats have fixed positions in the array and remain static in use. In some embodiments, the slats have a uniform thickness. In other embodiments, the slats may vary in thickness, for example the thickness may be tapered along their width from the proximal end/edge to the distal end/edge.

In some arrangements, the angle of the (sidewalls of the) louvres/louvre slats may be uniform (i.e. constant) across the array. In other arrangements, the angle of the (sidewalls of the) louvres/louvre slats may vary across the array, such as from a first end to a second end of the array.

The louvres/slats (or slat sidewalls) may be orientated so as to be aligned with/parallel to a central or “gut” ray of the holographic wavefront received at the intermediate layer from the first layer. In this way, the louvres may be arranged to substantially transmissive to the holographic wavefront. Typically, the holographic wavefront received at the intermediate layer from the first layer will be non-parallel to the normal of the waveguide. So, the louvre/slats (or slat sidewalls) may be orientated (inclined) at a (non-zero) angle to the normal of the waveguiding surface.

In some embodiments, the array of louvres comprises louvres/louvre slats that are spatially separated by air. In other embodiments, the array of louvres includes a transparent structure between adjacent louvres/louvre slats of the array. The transparent structure may improve the structural and functional integrity of the louvre structure, so that it is more robust (less easily damaged) and may be more easily cleaned. In some such embodiments, the array of louvres may be embedded in the transparent structure. For example, the intermediate layer may comprise a film or microfilm comprising the array of (micro) louvres embedded in a transparent material. Such an intermediate layer may be suitable for high speed (optionally, continuous) mass-production methods of the reflection suppression device.

In some embodiments, the transparent structure of the intermediate layer comprises or is formed of a transparent material having a refractive index that is substantially equal to the refractive index of the material that forms the first and/or second layers. As described above, the inventors have found that matching the refractive index of the transparent structure of the intermediate layer with transparent material of the first and/or second layers may advantageously reduce glare.

In some embodiments, the first and/or second layers comprise an anti-reflective coating. In some embodiments, the anti-reflective coating may be applied on to the first and/or second serrated surfaces of the first and second layers, respectively.

In some embodiments, each serration of the first serrated surface may comprise a first facet surface. The first facet surface may comprise the angled portion and may have a first angle with respect to a plane of the first layer. Each serration of the first serrated surface may comprise a second facet surface having a second angle with respect to a plane of the first component. Thus, the first serrated surface may comprises the first and second facet surfaces in an alternating configuration. Each serration may be arranged such that holographic wavefront of the head-up display passes through the first facet surface. Each serration may be arranged such that the second facet is substantially aligned with (i.e. substantially parallel to) the holographic wavefront received by the first serrated surface. Each second facet surface may be substantially non-transmissive or opaque. For example, each second facet surface may be coated with a substantially non-transmissive or opaque coating, such as a black paint. Thus, each second facet may advantageously be arranged to not block the holographic wavefront (which is intended to be received at the eye-box) while blocking light at other angles which may include sunlight/glare or otherwise scattered light.

In some embodiments, each serration of the first or second serrated surface may comprise a first facet surface and a second facet surface. The first and second facet surfaces of the second serrated surface may be substantially similar to those described above in relation to the first serrated surface.

In some embodiments, the first and second facets of each serrations of at least the first surface (optionally also the second layer) meet at a respective corner. As the skilled person will appreciate, is desirable for this corner to be as sharp as possible to avoid unintended scattering of light by the corner. So, this corner may be a sharp corner formed by a knife edge. However, such sharp corners may be difficult and/or slow and expensive to manufacture. This may mean that each serration may comprises a substantially curved corner connecting the first and second facet (rather than a sharp corner, for example). The substantially curved corner may be an artefact of the manufacturing process. A radius of curvature of the (or each) curved corner may be relatively very small. The size of the radius of curvature of the corner may depend on the method of manufacture used to form the serrated surface. In particular, the size of the radius of curvature of the corner may depend on the minimum feature size that a particular method of manufacture is suitable for forming. For example, the serrated surface may be formed using an injection moulding method or a hot embossing method (examples of both of these methods are described in this document). In some embodiments, a hot embossing method may be suitable for achieving a smaller minimum feature size than an injection moulding method and so a smaller radius of curvature of corner may be achievable when using a hot embossing method.

In some embodiments, a radius of curvature of the (or each) corner may be 100 micrometres or less. In some embodiments, a radius of curvature of the (or each) corner may be 50 micrometres or less. In some embodiments, a radius of curvature of the (or each) corner may be 20 micrometres or less. In some embodiments, a radius of curvature of the (or each) corner may be 10 micrometres or less. In some embodiments, a radius of curvature of (or each) corner may be 5 micrometres of less.

To substantially reduce or eliminate glare caused by unintended scattering, each of the corners of the first and/or second layer may be treated/processed.

In some embodiments, the reflection suppression device is arranged such that light rays (e.g. representing the propagation of a holographic wavefront or some other light such as glare) may pass therethrough only at a specific range of angles. This may refer to a first pass through the reflection suppression device.

For example, the first and/or second layer and the louvres of the intermediate layer may be arranged in cooperation to define a range of light ray angles at which light rays can pass therethrough. Light rays passing therethrough may mean that the light rays are not blocked by a louvre, for example without incidence on a louvre of the louvre array. Again, this may be on a first pass through the reflection suppression device.

In summary, a range of light ray angles may be defined. In some embodiments, one or more light (ray) receiving surfaces of the first or second serrated surface make an angle with respect to a normal of a plane defined by the second layer. The angle may be greater than a maximum of the range of angles. The one or more light receiving surfaces may be the or each first facet of the first or second serrated surfaces. Another way of defining this angle could be with respect to the angle made by the one or more light (ray) receiving surfaces of the first or second serrated surfaces and a plane of a major surface of the device. When the angle is defined in this way, the angle may be less than the maximum angle of the range.

The inventors have found that, if the first facets of the serrated surfaces have an angle falling within the range of angles of the light ray paths, then there is a risk that at one or more particular angles, sunlight incident on the second surface may propagate through the reflection suppression device and may exit at the first serrated surface. The sunlight may then be reflected by the waveguide back towards the first serrated surface. The inventors have found that, at one or more very specific angles, the sunlight may make an angle with the serrations of the first serrated surface that is such the sunlight is substantially reflected back on its self. This could result in glare reaching an eye-box/viewing window at some very specific angles of incidence of sunlight. After thorough simulation and experimentation, the inventors have found that arranging the serrated surfaces such that the light receiving surfaces/first facets are angled as described eliminates this mechanism of glare.

In some embodiments, each serration corner of the first and/or second layer may be arranged to diffusely scatter light. For example, each serration corner may be frosted. Such diffuse scattering may mean that scattered light of low intensity is emitted over a range of angles (rather than more specular scattering in which higher intensity light is emitted at discrete angles). Thus, while some scattered light may be received at the eye-box, it will be of very low intensity and so be effectively negligible. By providing serration corners (of the second layer) that are arranged to diffusely scatter light, the manufacturing tolerances required to produce the second layer may be substantially reduced without overly increasing the amount of unwanted light being directed to the eye-box.

In some embodiments, at least a portion of each serration corner of the first and/or second layer may comprise a coating, for example a substantially opaque and/or diffuse coating. The coating may comprise paint such as black paint. The coating may be arranged to diffusely scatter light and/or absorb light to substantially reduce or eliminate glare caused by unintended scattering caused by the serration corner(s). The coating may cover at least 50% of the serration corner.

As described above, each of the second facets of the first and second layers may be painted. The paint on the second facet may extend to/around the serration corner. So, the paint on the second facet may also form the coating on the at least portion of the serration corner.

In some embodiments, a tangent to each serration corner may be defined at a first position on the serration corner. The tangent may be parallel to a plane of the respective first facet. The coating may extend around the serration corner from the second facet at least to the first position on the serration corner (defined by the tangent).

In some embodiments, the reflection suppression device may be described as comprising first and second major surfaces and one or more minor surfaces. The first serrated surface of the first layer may form the first major surface. The second serrated surface of the second layer may form the second major surface. So, the one or more minor surfaces may be surfaces (or faces) of the reflection suppression device extending at least partially from the first serrated surface to the second serrated surface. In some embodiments, the minor surface may be at least partially defined by one or more edge surfaces or faces of the intermediate layer. These edge surfaces or faces of the intermediate layer may be exposed.

Advantageously, the at least one edge surface of face of the reflection suppression device/intermediate layer may be arranged to suppress specular reflection of light incident thereon. For example, the at least one edge face of the reflection suppression device/intermediate layer may be arranged to absorb light incident thereon. The at least one edge face of the optical component may comprise a light absorbing material, optionally wherein the at least one edge face is coated with a light absorbing coating, such as a black coating. In some examples, the at least one edge face of the reflection suppression device/intermediate layer may be arranged to attenuate and/or diffusely reflect light incident thereon.

The head-up display may comprise a light source. The light source may be a coherent light source, such as a laser. The head-up display may further comprise a display device. The display device may be a pixellated display device. The display device may be a spatial light modulator, such as a liquid on crystal spatial light modulator. The head-up display may be arranged such that a hologram is displayed on the display device. The hologram may be a hologram of a picture. The light source may be arranged to illuminate the display device so that light is spatially modulated in accordance with the hologram. This may form the holographic wavefront. The head-up display may be further arranged such that the holographic wavefront is received by the waveguide.

There are disclosed herein methods for manufacturing a reflection suppression device that is able to control (e.g. reduce the negative effect of) incident sunlight that might cause glare when incident on an optical component (e.g. within a vehicle) without significantly altering the primary function of the optical component. There are also disclosed herein improved reflection suppression devices for a waveguide, picture or hologram generating unit or head-up display.

There is a need for reflection suppression devices in contexts in which a reflective optical element is susceptible to cause glare by reflecting sunlight onto an optical path to a user. For example, there may be a need for reflection suppression device in a head-up display for a vehicle. Such head-up displays typically comprise at least one reflective optical component such as a mirror, cover glass or a waveguide pupil expander other reflective optical surface that can receive sunlight. A head-up display is typically arranged such that the holographic wavefront is directly or indirectly relayed towards an eye-box by reflective optical components. However, any reflective surface of any optical component may receive sunlight and potentially direct the sunlight to the eye-box (or viewing window) of the head-up display to cause glare. This could be distracting and uncomfortable for a driver of the vehicle.

The inventors have developed a reflection suppression device comprising an array of louvres angled so as to be effective at supressing glare from most angles without altering the function of the associated optical component (for example, without blocking picture-forming light). The louvres are elongated and relatively thin. For example, the louvres may have a length of 100-500 millimetres but a width of a few millimetres, optionally no more than a fraction of a millimetre. This means that the louvres are susceptible to elastic or inelastic deformation, particularly in a direction perpendicular to the length of the louvre. Deformed louvres may not properly block sunlight. Louvre deformation is a particular problem in the context of supressing reflections in a head-up display in a vehicle. The reflection suppression device preferably should have sufficient mechanical strength and rigidity to prevent vibrations of the vehicle from causing the louvres to substantially deform/flex. The inventors have found that fixing the louvres to a transparent support structure provided between the louvres can improve the strength and rigidity of the louvres and of the reflection suppression device as a whole. The inventors have also found that, if the transparent support structure is provided with a serrated surface, then additional unwanted light may advantageously be reflected away from an optical path of the optical component by the serrated surface and so this light may not contribute to glare either.

In a second aspect there is provided a method of manufacturing a reflection suppression device. The method comprises a first step. The first step comprises forming a first component of the reflection suppression device by processing a transparent material to form a serrated surface. The serrated surface may be continuous or discontinuous. Processing the transparent material comprises at least one selected from the group comprising extruding, injection moulding, hot embossing or cutting the transparent material. The method further comprises a second step which may be performed before, simultaneously with or after the first step. The second step comprises forming a second component of the reflection suppression device by processing a light absorbing material to form a plurality of louvres arranged in an array. Processing the light absorbing material comprises at least one selected from the group comprising: adjoining, gluing, painting or supporting the light absorbing material in a support structure. At least one of the first and second steps comprises at least partially fixing the first component and second component together. The first and second component may be at least partially fixed together such that the serration of the serrated surface of the first component is coordinated with the array of louvres. The first and second component may be at least partially fixed together such that a periodicity of the serrated surface is equal to a periodicity of the array of louvres. Herein, the periodicity of a serrated surface refers to the interval of individual serrations forming the serrated surface. In some embodiments, the step of at least partially fixing together the first and second components may be performed after at least one of the first component and second components has been formed.

The serrated surface may comprise a plurality of (individual) serrations, optionally an array of (individual) serrations. Each of the serrations may be formed by a portion of the serrated surface of the first component that is angled with respect to a general plane of the reflection suppression device. The or each portion of the serrated surface forming a serration may have a constant angle with respect to the plane of the reflection suppression device. In other words, the serration/angled surface may have a linear profile. The serrated surface may be described as having a sawtooth configuration or shape. Alternatively, the or each portion of the serrated surface forming a serration may have a changing angle with respect to the plane of the reflection suppression device. In other words, the serration/angled surface may have a curved profile. In some embodiments, the serration of the sunlight-receiving surface provides an array of angled surfaces that direct sunlight. In the context of a head-up display, the angled surfaces may direct sunlight-including sunlight reflected by another optical component of the system-away from the eye-box. In particular, each of the angled surfaces forms an interface between the core material and air such that most of the sunlight incident thereon (e.g. more than 95% of incident sunlight) is reflected.

The first component formed in the first step of the method may comprise a first surface and a second surface opposite to the first surface. The first surface may form the (first) serrated surface described above. In some embodiments, the first step of the method may further comprise processing the transparent material to form a second serrated surface. The second surface may form the second serrated surface. The second serrated surface may be coordinated (e.g. have a periodic shape that is in-phase) with the first serrated surface. The periodicity of serrations of the second serrated surface may be equal to the periodicity of the serrations of the first surface (and so the periodicity of the serrations of the second serrated surface may also be equal to the periodicity of the array of louvres). The profile of the serrations of the first surface may be coordinated with profile of the serrations of the second surface. This may mean that the thickness of the first component may be substantially constant. The thickness may be defined as the size of the first component in a direction substantially normal to the plane defined by the reflection suppression device. In some embodiments, the serrations of the first surface may be parallel to the respective serrations of the second surface. This may be in embodiments where the profile of the serrations of the first (and second) surface is linear. The first and second serrated surfaces being coordinated may advantageously ensure that parallel light rays transmitted through different parts of the first component remain parallel when output from the transparent material. In particular, the light rays may exit the second surface at the same angle that the light rays are incident on the first surface (and vice versa). This means that the angle of light passing through the first component is independent of the incidence position of the light on the first component. This simplifies the geometry of the reflection suppression device and means that light intentionally transmitted through the reflection suppression device (for example, head-up display light) is not dispersed. This applies to both glare and light intentionally projected through the reflection suppression device (e.g. light of the head-up display). This is not the case in embodiments where the thickness of the first component is not constant or non-uniform.

In some embodiments, the first step comprises forming a first component as a single continuous component. Louvres may be at least partially fixed to the single continuous component after the single continuous component has been formed. In all embodiments, the first component is arranged to provide mechanical support and rigidity to the reflection suppression device. However, it may be particularly advantageous to provide the first component as a single continuous element as such a structure may be stronger and more rigid than a first component assembled from a plurality of smaller pieces. Furthermore, it may quicker to process/form a first component as a single component. Rather than manufacturing a plurality of pieces of first component individually, the first component may be provided in a single process. In contrast, in other case, it may be advantageous to manufacture a plurality of smaller sections of transparent material (e.g. transparent elements) and then arrange or combine them to form the first component.

In some embodiments, the first step comprises forming a plurality of transparent elements. Each of the transparent elements may comprise a serrated/angled surface, optionally a serrated/angled top surface. In such cases, the first step may further comprise assembling the plurality of transparent elements to form the first component. In some embodiments, each of the plurality of transparent elements is separated from an adjacent serrated element by a louvre in an assembled first component. In such embodiments, a discontinuous serrated surface may be formed. In some embodiments, each transparent element of the plurality of transparent elements may be immediately adjacent another transparent element. An advantage of assembling the first component from a plurality of transparent elements, rather than as a single component, is that the manufacturing method is more flexible. For example, a first component/reflection suppression device of any size may be formed simply be changing the number of transparent elements used to form the first component. In this way, the manufacturing method may be easily adapted to suit optical components having different dimensions. Another advantage is that forming the first component from a plurality of elements in this way more easily allows for the elements forming the first component to comprise different materials and different combinations of materials having different properties. For example, the plurality of serrated transparent elements may be formed from a soft polymer. This may be advantageous because shaping a soft polymer may be easier than shaping a hard material. However, a soft polymer on its own may not provide a first component with enough mechanical strength and rigidity to prevent deformation of the louvres. Thus the plurality of transparent elements may be combined with a substrate (or substrates)—i.e. a further feature of the first component—which does not need to be shaped to be serrated but which provides strength. The substrate (or substrates) may be formed of a harder and/or more rigid material than the soft polymer.

The transparent material that is processed in the first step may be a material having a refractive index of greater than 1. The first surface may be adjacent an air gap. So, the difference in refractive index of the transparent material and air may result in refraction of light incident on the first surface. This may bend the light. The louvres and serrations may be arranged such that the incident light is bent towards the louvres to be blocked by the louvres. This may assist in reflection/glare suppression. The transparent material may be formed of or comprise glass or a polymer such as silicone, resin, plastic.

In some embodiments, the transparent material may be provided in the form of an unshaped piece of material, for example a block or a slab of material, prior to the processing of the first step of the method. The unshaped piece of material may be in the form of a solid (i.e. in solid phase). The first step may then comprise extruding, hot embossing or cutting the unshaped piece of transparent material.

In some embodiments, the extruding, hot embossing or cutting may directly transform the unshaped piece of material into the first component (having a serrated surface, as described above). Such embodiments may result in the first component being formed as a single continuous component. In some embodiments, the transparent material (for example, the unshaped piece of material) may comprise a first surface and a second surface. The first step may comprise hot embossing or cutting the first surface of the transparent material to form a first serrated surface. The first step may further comprise hot embossing or cutting the second surface of the transparent material to form a second serrated surface. As described above, the first and second serrated surfaces may be coordinated with one another.

In some embodiments, the extruding, hot embossing or cutting may be used to form a plurality of (individual) transparent elements. The formation of the plurality of individual transparent elements may comprise shaping the transparent elements to each have at least one angled/serrated surface. In such embodiments, the first step may further comprise assembling the plurality of transparent elements to form the first component from the plurality of transparent elements. Assembling the transparent elements may comprise the step of at least partially fixing the first component and second component together.

In some embodiments, the transparent material may be provided as a (molten) liquid prior/during the first step of the method. The first step may comprise injection moulding the molten transparent material. In some embodiments, injection moulding may be used to directly form the first component from the liquid transparent material. This may be in combination with an appropriate mould. In some embodiments, injection moulding may be used to form a plurality of transparent elements. In such embodiments, the first step may further comprise assembling the plurality of transparent elements to form the first component from the plurality of injection moulded transparent elements. Assembling the injection moulded transparent elements may comprise the step of at least partially fixing the first component and second component together.

In some embodiments, the first step may comprise injection moulding the molten transparent material, for example into a mould, and may further comprise further processing of the transparent material after the injection moulding step. For example, the further processing of the transparent material may comprise at least one of hot embossing, cutting or otherwise shaping the transparent material. The further processing may comprise forming the serrated surface in the transparent material. For example, the first step may comprise injecting molten transparent material into a mould and allowing the molten transparent material to set, cure, cool or otherwise solidify. This may form a block of transparent material. The further processing may further comprise processing the block of transparent material, for example a top surface of the block of transparent material. The first step/processing may comprise (hot) embossing the top surface of the block of transparent material to form the serrated surface. The inventors have recognised that the combination of injection moulding with further processing can be advantageous. For example, injection moulding may be a fast and efficient method for forming a block of transparent material. Furthermore, as described below, injection moulding may advantageously allow the first and second components to be integrally formed (such that the step of forming the first component may be simultaneous with the step of partially fixing the first and second components). However, injection moulding may also have limitations, for example limitations in the smallest feature size that can easily be formed. Other processing techniques may more easily allow for the formation of small, precise features (such as the individual serrations of a serrated surface). Thus, by combining two processes, a first component can substantially be formed using injection moulding and finished (i.e. forming the serrated surface) using another process such as embossing.

In some embodiments, strips of continuous material may be supported in the mould prior to the injection moulding step. In such embodiments, the strips of continuous material may form an array of louvres which are embedded in or integrally formed within the transparent material after or as a result of the injection moulding step (and the cooling step). In some embodiments, the mould may comprise features such as inserts. Each of the inserts may form a blind channel or blind cavity in the transparent material/transparent block when the transparent material has been injected into the mould and then removed. In such embodiments, louvres may be formed in each of the blind channels/cavities.

The second step may comprise forming the louvres such that each louvre has a width defined between a proximal end and a distal end. Each louvre is arranged at an orientation angled relative to the general plane defined by the reflection suppression device, and wherein the separation between adjacent louvres is such that the distal end/edge of one louvre overlaps with the proximal end of the adjacent louvre. The overlap may be such that reflected light (or glare) is suppressed by the louvres at all input angles.

In some embodiments, the overlap is a spatial overlap. That is, a footprint of a first louvre overlaps with a footprint of a second louvre, wherein the first louvre is immediately adjacent the second louvre in the array of louvres. Alternatively, it may be said that a projection of the first louvre onto the first surface overlaps with a projection of the second louvre onto the first surface. In this way, the physical geometry of the array of louvres may be what suppresses reflections. In some embodiments, the overlap is an optical overlap in which case the louvres may not necessarily spatially (i.e. physical) overlap. This is because it may not be necessary for the louvers to spatially overlap in order to achieved suppression of reflective light or glare at all angles of elevation of the sun/another glare light source. In particular, the transparent material (having a refractive index of greater than 1) may cause light (glare) to be refracted. The serrated nature (angle) of the first component may be such that the refracted light may be re-directed so that reflected light (or glare) is suppressed by the louvres at all input angles without the need of a spatial (i.e. physical) overlap of louvres. In this respect, it is said that the louvres “optically” overlap even though they may not physically overlap (in the vertical direction).

In embodiments, the louvres are upstanding. In some embodiments, the louvres are perpendicular. In some embodiments, the louvres are tilted. In particular, the louvres may be perpendicular or tilted from an orthogonal orientation relative to the plane of the reflection suppression device and/or planar reflective surface of the optical component. The side walls of the louvres may be parallel such that the louvres are substantially rectangular. Alternatively, one or both of the sidewalls of the louvres may be sloped, such that each louvre has a trapezoid cross section. A cross-section of the louvres of the louvre array may have the appearance of a cross-section of a venetian blind. In some embodiments, each louvre may be elongated. Each louvre may extend substantially along a length or width of the reflection suppression device.

In some embodiments, the second step comprises forming the second component such that the louvres are tilted relative to a general plane of the reflection suppression device. The louvres formed in the second step are formed of a light absorbing material and so the louvres are configured to attenuate sunlight, such as absorb sunlight. In examples, all of the louvres in the array have substantially the same pitch, orientation and geometry. The thickness and angle of the louvres may be chosen so as to minimise the occlusion of light passing through the reflection suppression device at a particular angle. In the context of a head up display, the thickness and angle of the louvres may be chosen to minimise occlusion of picture-forming light relayed by the head-up display system through the reflection suppression device.

In some embodiments, the light absorbing material comprises a light absorbing paint. In such cases, step two of the method may comprise painting (the light absorbing paint). In some embodiments, this may comprise painting at least a portion (of one or more surfaces) of the first component. Painting the light absorbing material may be the most space efficient way to form a louvre. In particular, at least from certain angles, the thickness of a painted louvre may be minimised and so occlusion of (for example), head up display light may advantageously be minimised. The light absorbing paint may comprise pigments arranged to substantially absorb visible light. The light absorbing paint may be black paint.

In some embodiments, the light absorbing material has the form of a continuous strip. In some embodiments, the light absorbing material has the form of a plurality of continuous strips. Each strip of the plurality of continuous strips may be processed to form an individual louvre of the array of louvres. The continuous strip may have a thickness of 5 millimetres. The strip may have a length of 200 millimetres or more. The strip may comprise a light absorbing plastic, rubber, silicone or metal. Optionally, the strip further comprises a coating. A light absorbing material in the form of a continuous strip may be slightly thicker than a louvre painted directly on to the first component. So, such a continuous strip may occlude light (in particular, projected light from a head up display) slightly more than a painted louvre. However, the spacing between louvres formed of continuous strip may be an order of magnitude greater than the thickness of each strip. So, the amount of occlusion may still be acceptably small. Furthermore, providing the light absorbing material in the form of a continuous strip may allow for more efficient manufacturing methods. For example, as described below, it may be possible to lay up a mould with an array of louvres (in the form of a plurality of continuous strips) and then form the first component around the louvres, for example by injection moulding.

In some embodiments, the second step may comprise embedding the array of louvres in a transparent material. The transparent material may act as a support structure. In some embodiments, the array of louvres may be embedded in the transparent material that is processed to form the first component (for example, when the first component is formed by injection moulding the transparent material). In some embodiments, the array of louvres may be embedded in a different transparent material to the transparent material of the first component. In other words, the second component may comprise an array of louvres embedded in a transparent material.

The first step may comprise injection moulding the transparent material. The first step may comprise injection moulding the transparent material using a mould. The mould may comprise two primary parts or plates. The two primary plates may be separable from one another. The mould may comprise one or more cavities. The one or more cavities may be shaped according to predetermined shape of the component to be moulded. The one or more cavities may be defined when the first and second primary plates are in contact with one another. The mould may comprise one or more input ports. The mould may comprise one or more exit ports. Gates and runner lines may be defined in the mould and may connect the one or more input ports to the one or more cavities and on to the one or more output ports. During the first step, liquid or molten transparent material may be injected into the one or more input ports. The liquid or molten transparent material may then fill the one or more cavities before exiting out of the one or more output ports. The transparent material may be injected under pressure. The transparent material and/or the mould may be maintained at a temperature above ambient temperature while the transparent material is injected into the mould. The first step may further comprise cooling, setting and/or curing the transparent material after it has been injected into the one or more cavities. The first step may further comprise removing the cooled/set/cured transparent material from the mould.

The one or more cavities may be configured to shape the injected transparent material in accordance with a predetermined shape of the first component (or portions/elements of the first component). For example, the mould may comprise one or more cavities having at least a first surface arranged to form at least a portion of the serrated surface of the first component. The mould may comprise one or more cavities having a length that is 200 millimetres or more, optionally 300 millimetres or more. The one or more cavities may have a length of 500 millimetres or less, optionally 400 millimetres or less. The length of the one or more cavities may correspond to the length of the first component.

In some embodiments, the first step comprises injection moulding the transparent material to form the first component as a single piece. For example, the one or more cavities of the mould may be arranged (such as shaped) so that the first component can be formed as a single piece. In other words, the first component may be integrally formed. In such cases, advantageously, no assembly step may be required after the transparent material has been removed from the mould in order to form the first component. Furthermore, as above, such structures are advantageously mechanically strong and rigid. If there is more than one cavity, these cavities may be connected to one another and/or may be continuous in order to provide the first component as a single piece.

In some embodiments, the mould comprises a cavity having a first serrated surface. The mould may comprise only this cavity. The serrated surface may comprise a plurality of serrations. The serrations may form a continuous serrated surface. The first serrated surface of the cavity may form the first serrated surface of the first component (described above) when molten transparent material is injected into the cavity in the first step of the method. The cavity may have a second serrated surface. The second serrated surface may be on an opposite side of the cavity to the first serrated surface. The serrations of the second serrated surface may be coordinated with the serrations of the first serrated surface. The first and/or second serrated surfaces may have a sawtooth configuration. In some embodiments, the first serrated surface is defined by one of the primary parts of the mould and the second serrated surface is defined by the other of the primary parts of the mould. The second serrated surface of the cavity may form the second serrated surface of the first component (described above) when molten transparent material is injected into the cavity in the first step of the method.

In some embodiments, the one or more cavities of the mould are arranged such that the injection moulded first component comprises a frame and a plurality of serrated transparent elements. The one or more cavities of the mould may be arranged such that a first end of each of the transparent members is attached to (integrally formed with) the frame. The frame advantageously contributes to the mechanical strength of the reflection suppression device. The frame may be an artefact of the manufacturing process. If a reflection suppression device comprising a plurality of serrated transparent elements (forming a discontinuous serrated surface) is to be injection moulded as a single component, then liquid transparent material must be able to flow continuously throughout the mould. The mould may comprise a plurality of first cavities for forming a plurality of transparent elements. If liquid transparent material asis flow through each of these first cavities, a further second (support) cavity may be provided in the mould which connects all of the first cavities. The inventors have realised that this second cavity can be used to form a first side of a frame. By placing the frame at an end of the first component, occlusion of light by the frame is minimised. Furthermore, the inventors have realised that the frame may provide additional strength and support to the manufactured reflection suppression device. The one or more cavities of the mould may be arranged such that the frame comprises a first side extending in a first direction. The one or more cavities of the mould may be arranged such that the plurality of serrated members extend in a second direction which is angled relative to the first direction, optionally perpendicular to the first direction. The one or more cavities of the mould may be arranged such that the frame comprises a second side opposite to the first side. The first side may be parallel to the second side. A second end of each of the serrated members (opposite to the first end) may be attached to (integrally formed with) the second side of the frame.

In some embodiments, the first step comprises injection moulding the transparent material and the second step comprises supporting the light absorbing material in a support structure. The support structure may be defined within the mould that is used for injection moulding the first component. The support structure may be defined within one or more cavities defined within the mould. The support structure may comprise a plurality of slots arranged to receive light absorbing material (for example, continuous strips of light absorbing material). At least one of the cavities of the mould (comprising slots) may be substantially planar. The slots may be arranged to maintain the light absorbing material at an angle with respect to the plane of the cavity. The first step comprises at least partially fixing the first component and second component together by injection moulding the transparent material into the mould. Thus, the first and second component may be integrally formed. This is advantageously a quick and simple way to manufacture a reflection suppression device comprising an array of louvres and a serrated first component. There is no need for the louvres to be individually fixed to different portions of the first component. Instead, the louvres can simply be laid up in the mould which is then filled with liquid transparent material and then set/dried/cured. The louvers of the second component may then be embedded in the first component. In other words, the first and second component may be integrally formed. In this embodiment, step two of the method may be performed prior to step one.

In some embodiments, the first step may comprise injection moulding individual features or elements of the first component separately from one another. For example, the first step may comprise injection moulding the plurality of (serrated) transparent elements, described above. Each of these transparent elements may be manufactured as stand-alone components (although, of course, a mould could be provided comprising a plurality of separate cavities for manufacturing a plurality of separate transparent elements simultaneously). The first step may further comprise assembling the first component using the individual features or elements such as the plurality of serrated transparent elements. As described in more detail below, the assembly step may comprise fixing transparent elements and louvres together in an alternating fashion to form the first component.

In some embodiments, the processing of the first step comprises forming a plurality of transparent elements. The plurality of transparent elements may be formed by injection moulding (as in the preceding paragraph, for example), extrusion or cutting a transparent material. The first step may comprise forming a first component comprising a plurality of transparent elements. Each transparent element may be substantially elongated. Each transparent element may extend in a first direction. At least a first surface, optionally a top surface, of each of the transparent members may be serrated. A second surface of each of the transparent members may also be serrated. When a plurality of transparent elements are suitably arranged (for example as an array), a serrated surface may be formed by the transparent elements. The serrated surface may be a discontinuous serrated surface. An array of transparent elements may define a sawtooth structure. The serrations may have a linear profile. The serrations may be parallel to one another. Each of the transparent elements may have quadrilateral cross-section. Each of the transparent elements may have a cross-section in the shape of a parallelogram. The parallel sides of the parallelogram may define the serrations.

The first step of the method may comprise at least partially fixing the first component to the second component. This may comprise at least partially fixing transparent elements and louvres in an alternating configuration. In some embodiments, at least partially fixing the first component to the second component comprises at least partially fixing a first transparent element to a first side of a first louvre and a second transparent element to a second side of a second louvre.

The first step of the method may comprise at least partially fixing a plurality of the transparent elements on to a transparent substrate also referred to herein as a core layer. The serrated surface of the first component may be formed by at least a surface of at least some of the transparent elements fixed to the transparent substrate. The transparent substrate may provide mechanical strength and rigidity to the first component. The provision of a transparent substrate may be particularly advantageous when the transparent elements are formed of a relatively softer material such as soft polymer (e.g. silicone). The transparent substrate may be substantially planar. The transparent substrate may comprises a first planar surface and a second planar surface. The first planar surface may be opposite to the first planar surface. The first step may comprise at least partially fixing a first plurality of the transparent elements on to the first planar surface of the transparent substrate and a second plurality of the transparent elements on to the second planar surface of the transparent substrate. Thus, the first step may comprise forming a first component comprising a first serrated surface and a second serrated surface, wherein the first serrated surface is formed by at least a surface of each of the first plurality of transparent elements and the second serrated surface is formed by at least a surface of each of the second plurality of transparent elements.

In some embodiments, the second step comprises painting the light absorbing material to form a plurality of louvres. In such embodiments, the light absorbing material may comprise a light absorbing paint. The second step may further comprise allowing the paint to dry or cure. The second step of the method (comprising painting the light absorbing material) may be performed during or after the first step. In some embodiments, the second step comprises painting the light absorbing material on to the formed first component. In such cases, the second step of the method may be performed after the first step of the method. In some embodiments, the second step comprises painting the light absorbing material on to at least a portion (for example, at least a portion of a surface of) each of a plurality of transparent elements formed in the first step. As described above, when the first step comprises forming a plurality of transparent elements, the first step may further comprise assembling the plurality of transparent elements. The second step may be performed after the plurality of transparent elements have been formed but before they are assembled (in other words, the second step may be performed during the first step). Alternatively, the second step may be performed after the plurality of transparent elements have been assembled (in other words, the second step may be performed after the first step).

The second step may comprise adjoining or gluing light absorbing material to form a plurality of louvres. In such cases, the light absorbing material may have the form of a continuous strip of material. The second step of the method (comprising gluing or adjoining the light absorbing material) may be performed during or after the first step. In some embodiments, the second step comprises gluing or adjoining the light absorbing material on to the formed first component. In such cases, the second step of the method may be performed after the first step of the method. In some embodiments, the second step comprises gluing or adjoining the light absorbing material on to at least a portion (for example, at least a portion of a surface of) each of a plurality of transparent elements formed in the first step. For example, the second step may be performed after the plurality of transparent elements have been formed but before they are assembled (in other words, the second step may be performed during the first step). In some embodiments, the second step may be performed after the plurality of transparent elements have been assembled (in other words, the second step may be performed after the first step).

When the second step comprises gluing the light absorbing material, the second step may comprise applying a layer of glue or adhesive on to the light absorbing material and/or on to the first component or plurality of transparent elements. The second step may comprise bringing the light absorbing material and first component (or respective transparent element) into contact. The second step may comprise curing, setting or drying the glue or adhesive. In some embodiments, the glue or adhesive may be a UV curing glue or adhesive. In this case, the curing step may comprise irradiating the glue or adhesive with ultraviolet light for a predetermined time. In some embodiments, the step of applying the glue may comprise the use of a photoresist process.

The glue or adhesive (when dry, set or cured) may have a refractive index that is substantially equal to the refractive index of the transparent material. In this way, the glue or adhesive may have a substantially similar optical performance as the transparent material. Such a selection of a glue or adhesive may reduce the aberration of light passing through the reflection suppression device at the boundary between the first component and each of the louvres. This aberration may otherwise affect a small proportion of glare to be transmitted by the reflection suppression at some specific angles.

In some embodiments, the method further comprises a third step. The step may be to at least partially fix a third component and the first component together. The third component may be a diffraction or diffractive film. The serrated surface may be a first (top) surface of the first component. The third step comprises at least partially fixing the fourth component to a second surface of the first component (the second surface being substantially opposite to the first surface). The diffractive film may comprise a layered structure arranged to redirects light by diffraction, for example rather than refraction or reflection. The diffractive film may be arranged to act as a holographic optical element. The diffractive film may be arranged such that light transmitted through the diffractive film is diffracted, optionally by holographic volume diffraction. The diffractive film may have a modulated refractive index. The diffractive film may comprise a photopolymer such as dichromated gelatin The photopolymer may be maintained between a first and second transparent substrate. The diffractive film may be arranged to compensate for refraction of light by the transparent material of the first component (which may have a refractive index of greater than one). This may be particularly advantageous in embodiments in which the thickness of the first component is variable. A variable thickness of the first component may cause dispersion of light (for example head-up display light) transmitted through the first component. The diffractive film may be arranged so that this dispersion of light is compensated for. For example, the diffractive film may comprise a diffractive structure (formed, for example, by index modulation of a photopolymer layer of the diffractive film) configured to steer the light. The diffractive structure may be repeated periodically along the length of the diffractive film. Each diffractive structure may be coordinated with or correspond to the serrations. Each diffractive structure may extend between adjacent louvres of the reflection suppression device.

In some embodiments, the method further comprises forming a fourth component by applying a transparent coating layer to the first and/or second component. The transparent coating layer may cover the serrated first surface. The transparent coating layer may cover the array of louvres. The transparent coating layer may advantageous act as protective cover for the reflection suppression device.

In a third aspect, there is provided a method of manufacturing a reflection suppression device. The method comprises a first step of forming a first component of the reflection suppression device by processing a transparent material to form a serrated surface. Processing the transparent material comprises at least one selected from the group comprising extruding, injection moulding or cutting the transparent material to form a plurality of transparent elements. The method further comprises a second step of forming a second component of the reflection suppression device by processing a light absorbing material to form a plurality of louvres arranged in an array. Processing the light absorbing material comprises at least one selected from the group comprising: adjoining, gluing or painting. The first and second steps comprise at least partially fixing the first component and second component together such that a periodicity of the serrated surface is equal to a periodicity of the array of louvres. The first step may further comprise assembling the plurality of transparent elements to form the first component. The step of at least partially fixing the first component and the second component may comprise at least partially fixing transparent elements and louvres in an alternating configuration.

At least partially fixing the first component to the second component may comprise at least partially fixing a first transparent element to a first side of a first louvre and a second transparent element to a second side of a second louvre. The second step may comprise adjoining or gluing the first transparent element to the first side of the first louvre and adjoining or gluing the first transparent element to the second side of the second louvre. Alternatively, at least partially fixing the first component to the second component may comprise painting at least a portion of a first side wall of each transparent element with a light absorbing paint. The method may then further comprise assembling the plurality of painted transparent elements to form the first component. The second step may comprise adjoining or gluing a first sidewall of a first transparent element to a second sidewall of a second transparent element, at least one of the first and second sidewalls being painted with light absorbing paint.

Each of the transparent elements may have an elongated shape with a quadrilateral cross-section, optionally a parallelogram shaped cross-section. The cross-section of each transparent element may comprise a first surface and a second surface. At least one of the first surface and the second surface may contribute to the serrated surface. A separation between the first surface and the second surface may be 50% or less, optionally 33% or less, the length of a louvre in the array of louvres. A separation between the first surface and the second surface may be substantially equal to the length of a louvre in the array of louvres.

In a fourth aspect, there is provided a method of manufacturing a reflection suppression device. The method comprises a first step of forming a first component of the reflection suppression device by processing a transparent material to form a serrated surface. Processing the transparent material comprises injection moulding molten transparent material. The method comprises a second step of forming a second component of the reflection suppression device by processing a light absorbing material to form a plurality of louvres arranged in an array. Processing the light absorbing material comprises at least one selected from the group comprising: adjoining or gluing. The second step further comprises at least partially fixing the first component and second component together such that a periodicity of the serrated surface is equal to a periodicity of the array of louvres. The first step may comprise manufacturing an integrally formed single first component. The second step may comprise adjoining or gluing a plurality of strips of light absorbing material to the first component to form the second component. The first step may comprise manufacturing an integrally formed single first component comprising a plurality of substantially parallel transparent members separated by spaces. The second step may comprise inserting the strips of light absorbing material in the spaces between the parallel transparent members.

In a fifth aspect, there is provided a method of manufacturing a reflection suppression device. The method comprises a first step of forming a first component of the reflection suppression device by processing a light absorbing material to form a plurality of louvres arranged in an array. Processing the light absorbing material comprises supporting the light absorbing material in a support structure. The method further comprises a second step of forming a second component of the reflection suppression device by processing a transparent material to form a serrated surface. Processing the transparent material comprises injection moulding molten transparent material. The second step comprises at least partially fixing the first component and second component together such that a periodicity of the serrated surface is equal to a periodicity of the array of louvres. The second step may comprise injection moulding the transparent material using a mould. The mould may comprise an array of slots forming the support structure. The first step may comprise supporting the light absorbing material in the array of slots. The mould may comprise one or more cavities. The second step may comprise cooling/setting/curing the transparent material.

In a sixth aspect, there is provided a method of manufacturing a reflection suppression device. The method comprises a first step of forming a first component of the reflection suppression device by processing a transparent material to form a serrated surface. Processing the transparent material comprises at least one selected from the group comprising injection moulding, hot embossing or cutting the transparent material. The method further comprises a second step of forming a second component of the reflection suppression device by processing a light absorbing material to form a plurality of louvres arranged in an array. Processing the light absorbing material comprises at least one selected from the group comprising: adjoining, gluing or painting. The second steps comprises at least partially fixing the first component and second component together such that a periodicity of the serrated surface is equal to a periodicity of the array of louvres. The first step may comprise forming the first component as a single integrally formed component. The second step may be performed after the first step. The first step may comprise hot embossing or cutting a block or slab of transparent material to form the first component. The block or slab of transparent material may comprise three layers including a core layer sandwiched between first and second layers, the first core layer comprising a first material and the first and second layers comprising a second material different to the first material. The first material may be softer than the second material. The block or slab may comprise a first surface and a second surface opposite to the first surface. The first step may comprise hot embossing or cutting the first surface to form the (first) serrated surface. The method may further comprise applying a diffraction film to the second surface.

The first step may further comprise hot embossing or cutting the second surface to form a second serrated surface of the first component, the second serrated surface being opposite to the first serrated surface. The (or each) serrated surface may comprise a series of first facet surfaces having a first angle with respect to a plane of the first component and a series of second facet surfaces having a second angle with respect to a plane of the first component, the first and second facet surfaces alternating with respect to one another. The second step may comprise adjoining, gluing or painting light absorbing material (a strip of or paint) on to each of the first facet surfaces.

The first step may comprise forming a plurality of transparent elements. The first step may comprise fixing, such as adjoining or gluing, the plurality of transparent elements on to a transparent core layer. The core layer may comprise a first surface and a second surface opposite to the first surface, and the first step may comprise fixing a first plurality of the plurality of transparent elements to the first surface of the core layer and fixing a second plurality of the plurality of transparent elements to the second surface of the core layer.

According to a seventh aspect, there is provided a method of manufacturing a layered reflection suppression device. The layer reflection suppression device is for a head-up display for a vehicle and is for receiving a holographic wavefront from the head-up display. The method comprises providing a first layer formed of a transparent material. The first layer comprises a first serrated surface. The method further comprises providing an intermediate layer comprising a plurality of louvres in an array, each louvre comprising a light absorbing material. The method further comprises providing a second layer formed of a transparent material. The second layer comprises a second serrated. The method comprises at least partially fixing the first layer to a surface of the intermediate layer and the second layer to an opposing surface of the intermediate layer to provide the reflection suppression device. The first layer is arranged to provide a first turn of the holographic wavefront having at least a component on a first plane containing a surface normal of the intermediate layer/reflection suppression device. The second layer is arranged to provide a second turn of the holographic wavefront having at least a component on the first plane. The component of the second turn on the first plane is equal and opposite to the component of the first turn on the first plane.

In some embodiments, the step of at least partially fixing the first layer and second layer to opposing surface of the intermediate layer comprises laminating the first, intermediate and second layers.

In some embodiments, the step of providing the first layer comprises processing a transparent material. This may comprise at least one selected from the group comprising extruding, injection moulding, hot embossing or cutting the transparent material. The step of providing the first layer may comprise forming an integrally formed first layer.

In some embodiments, the step of providing the second layer comprises processing a transparent material. This may comprise at least one selected from the group comprising extruding, injection moulding, hot embossing or cutting the transparent material. The step of providing the first layer may comprise forming an integrally formed first layer.

In some embodiments, the step of providing the intermediate layer comprises providing an intermediate layer in which the array of louvres are embedded in a transparent material. The intermediate layer may be provided as a film. The step of providing the intermediate layer may comprise processing a light absorbing material to form a plurality of louvres arranged in an array. Processing the light absorbing material comprises at least one selected from the group comprising: adjoining, gluing, painting or supporting the light absorbing material in a support structure. The processing may further comprise embedding the light absorbing material in a transparent material.

In some embodiments, the refractive index of the transparent material of the first and second layers (and, when present, of the intermediate layer) may be substantially the same.

In some embodiments, the first layer comprises a second surface which opposes the first serrated surface. The second surface may be a non-serrated surface, such as a planar or flat surface. The step of at least partially fixing the first layer to the intermediate layer may comprise at least partially fixing the second surface of the first layer to the intermediate layer. This may comprise applying an adhesive such that the adhesive is between the second (non-serrated) surface of the first layer and the intermediate layer.

In some embodiments, the second layer comprises a second surface which opposes the first serrated surface. The second surface may be a non-serrated surface, such as a planar or flat surface. The step of at least partially fixing the second layer to the intermediate layer may comprise at least partially fixing the second surface of the first layer to the intermediate layer. This may comprise applying an adhesive such that the adhesive is between the second (non-serrated) surface of the second layer and the intermediate layer.

Each of the second to seventh aspects may be methods of manufacturing a reflection suppression device for a head-up display for a vehicle. The reflection suppression device may be for disposition on an optical component of the head-up display. The optical component may comprise a reflective surface. The optical component may be a mirror. The optical component may be waveguide comprising a reflective surface. The methods of each of the second to seventh aspects may additionally comprise positioning or depositing the reflection suppression device on to the optical component (for example, mirror or waveguide) of the head-up display.

In an eighth aspect there is provided a head-up display for a vehicle, wherein the head-up display comprises an optical component having a reflective surface arranged, during head-up display operation, in a configuration that is conducive to sunlight glare; and a reflection (or glare) suppression device disposed on the optical component to receive sunlight on an optical path to the reflective surface, wherein the reflection suppression device is a reflection suppression device manufactured according to one of the methods of the second to seventh aspects. For example, the reflection suppression device may comprise a first component formed of transparent material and having a serrated surface and a second component in form of a plurality of louvres (such as an array of louvres) comprising a light absorbing material. The first material and the second material may be at least partially fixed together such that a periodicity of the serrated surface is equal to a periodicity of the array of louvres.

In some embodiments, the louvres are tilted with respect to a plane of the reflection suppression device. In some embodiments, the louvres are configured to attenuate sunlight such as absorb sunlight. In some embodiments, the array of louvres is configured to transmit image light of the head-up display output by the optical component. In some embodiments, the optical component is a waveguide. Optionally, wherein the waveguide is substantially planar and, optionally, arranged during head-up display operation in a substantially flat configuration relative to ground. In some embodiments, the transparent material of the first component is substantially transmissive to image light of the head-up display. In some embodiments, the serration provides an array of angled surfaces having an angle of orientation to direct sunlight away from the eye-box. In some embodiments, the angled surfaces change the angle of reflection of sunlight received thereby. In some embodiments, the louvres of the array of louvres are substantially parallel. In some embodiments, each louvre of the array of louvres has substantially the same geometry.

In an ninth aspect there is provided a reflection suppression device comprising a first component. The first component is formed of a transparent material and comprises at least a first serrated surface. The second component comprises a plurality of louvres arranged in an array. The louvres comprise a light absorbing material. The first component is at least partially fixed to the second component such that a periodicity of the serrated surface is equal to a periodicity of the array of louvres.

The first component may have been formed by extruding, injection moulding or hot embossing a source of transparent material. The second component may have been formed by adjoining or gluing a plurality of strips of light absorbing material to the first component. The second component may have been formed by painting a light absorbing material on to surfaces of the first component.

The first component may comprise a first serrated surface and a second serrated surface opposite to the first serrated surface. The serrations of the first serrated surface may be coordinated with the serrations of the second serrated surface such that the periodicity of the serrations of the first serrated surface are the same as the serrations of the second serrated surface.

The first component may comprise a central core sandwiched between a first region and a second region. The first region may comprise the first serrated surface. The second region may comprise the second serrated surface. The central core may extend unbroken along a length of the first component.

Each serration may comprise a first facet and a second facet. The first facet may have a first angle with respect to a plane of the reflection suppression device. The second facet may have a second angle with respect to the plane of the reflection suppression device. Each of the array of louvres may be at least partially fixed to a first facet of each serration. The second facet of each serration may correspond to the angled surface (described in earlier aspects). Each louvre may not extend into or through the core. Thus, when the first component comprises a first and second serrated surface, the second component may comprise a first array of louvres and a second array of louvres. Each of the louvres of the first array of louvres may be at least partially fixed to a first facet of a serration of the first serrated surface. Each of the louvres of the second array of louvres may be at least partially fixed to a first facet of a serration of the second serrated surface. Thus, the first array of louvres may form a first layer of louvres. The second array of louvres may form a second layer of louvres. The first layer of louvres may be above the second layer of louvres in a direction substantially parallel to the length of the louvres. The first layer of louvres may be separated from the second layer of louvres by the central core of the first component.

The first component may be integrally formed and may be formed as a single component. The first component may consist of a single transparent material (for example, a transparent polymer). Alternatively, the central core layer of the first component may be formed of a first material and the first and second region of the first component may be formed of a second material. Both the first and second material may be transparent but the first material may be different to the second material. For example, the second material may be relatively softer than the first material. Thus, the second material may be easier to shape during manufacture of the first (and second) serrated surfaces. The harder first material may be provide mechanical strength to the first component.

A reflection suppression device, as described above, may advantageously suppress glare and have mechanical strength and rigidity while being suitable for fast and efficient mass production techniques, as discussed above. The reflection suppression device may advantageously be manufactured by the manufacturing methods described in relation to the second and seventh aspects.

In a tenth aspect there is provided a reflection suppression device. The reflection suppression device comprises a first layer comprising a first serrated surface arranged to receive a holographic wavefront from the waveguide. The first layer is formed of a transparent material. The reflection suppression device further comprises an intermediate layer arranged to receive the holographic wavefront from the first layer. The intermediate layer comprises a plurality of louvres in an array. Each louvre comprises a light absorbing material. The reflection suppression device further comprises a second layer arranged to receive the holographic wavefront from the intermediate layer. The second layer comprises a second serrated surface. The second layer and the louvres of the intermediate layer are arranged in cooperation to define a range of light ray angles that can pass therethrough. This may mean that the light ray angles can pass therethrough without incidence on a louvre of the louvre array. One or more light (ray) receiving surfaces of the first serrated surface make an angle with respect to a normal of a plane defined by the second layer, the angle being greater than a maximum of the range of angles.

In an eleventh aspect there is provided a reflection suppression device. The reflection suppression device comprises a first layer comprising a first serrated surface arranged to receive a holographic wavefront from the waveguide. The first layer is formed of a transparent material. The reflection suppression device further comprises an intermediate layer arranged to receive the holographic wavefront from the first layer. The intermediate layer comprises a plurality of louvres in an array. Each louvre comprises a light absorbing material. The reflection suppression device further comprises a second layer arranged to receive the holographic wavefront from the intermediate layer. The second layer comprises a second serrated surface. The intermediate layer may also comprise a transparent material. The louvre array may be formed in (e.g. embedded in) the transparent material of the intermediate layer. The transparent material of the first layer may have a refractive index that is substantially equal to a refractive index of the transparent material of the intermediate layer. In some embodiments, the second layer is formed of a transparent material. A refractive index of the transparent material of the second layer may be substantially equal to the refractive index of the transparent material of the first layer and/or the transparent material of the intermediate layer.

In a twelfth aspect, there is provided a reflection suppression device. The reflection suppression device comprises a first layer comprising a first serrated surface arranged to receive a holographic wavefront from the waveguide. The first layer is formed of a transparent material. The reflection suppression device further comprises an intermediate layer arranged to receive the holographic wavefront from the first layer. The intermediate layer comprises a plurality of louvres in an array. Each louvre comprises a light absorbing material. The reflection suppression device further comprises a second layer arranged to receive the holographic wavefront from the intermediate layer. The second layer comprises a second serrated surface. The intermediate layer may also comprise a transparent material. In some embodiments, each serration of the first serrated surface may comprise a first facet surface. The first facet surface may comprise the angled portion and may have a first angle with respect to a plane of the first layer. Each serration of the first serrated surface may comprise a second facet surface having a second angle with respect to a plane of the first component. Thus, the first serrated surface may comprise the first and second facet surfaces in an alternating configuration. The second serrated surface may similarly comprise first and second facet surfaces in an alternating configuration.

In some embodiments, one or more (optionally, each) second facet of the first and/or second serrated surfaces are arranged to suppress specular reflection of light incident thereon. For example, said second facets may comprise a coating or layer such as paint arranged to diffusely reflect and/or absorb light incident thereon. For example, the paint may be a black paint.

In some embodiments, the first and second facets of each serration of at least the first surface (optionally also the second layer) meet at a respective corner. Said corner may be a substantially curved corner connecting the first and second facet (rather than a sharp corner, for example). The substantially curved corner may be an artefact of the manufacturing process. A radius of curvature of the (or each) curved corner may be relatively very small. In some embodiments, a radius of curvature of the (or each) corner may be 100 micrometres or less. In some embodiments, a radius of curvature of the (or each) corner may be 50 micrometres or less. In some embodiments, a radius of curvature of the (or each) corner may be 20 micrometres or less. In some embodiments, a radius of curvature of the (or each) corner may be 10 micrometres or less. In some embodiments, a radius of curvature of (or each) corner may be 5 micrometres of less.

To substantially reduce or eliminate glare caused by unintended scattering, each of the corners of the first and/or second layer may be treated/processed.

In some embodiments, each serration corner of the first and/or second layer may be arranged to diffusely scatter light. For example, each serration corner may be frosted. Such diffuse scattering may mean that scattered light of low intensity is emitted over a range of angles (rather than more specular scattering in which higher intensity light is emitted at discrete angles). Thus, while some scattered light may be received at the eye-box, it will be of very low intensity and so be effectively negligible. By providing serration corners (of the second layer) that are arranged to diffusely scatter light, the manufacturing tolerances required to produce the second layer may be substantially reduced without overly increasing the amount of unwanted light being directed to the eye-box.

In some embodiments, at least a portion of each serration corner of the first and/or second layer may comprise a coating or layer, for example a substantially opaque and/or diffuse coating. The coating may comprise paint such as black paint. The coating may be arranged to diffusely scatter light and/or absorb light to substantially reduce or eliminate glare caused by unintended scattering caused by the serration corner(s). The coating may cover at least 50% of the serration corner.

As described above, each of the second facets of the first and second layers may be painted. The paint on the second facet may extend to/around the serration corner. So, the paint on the second facet may also form the coating on the at least portion of the serration corner.

In some embodiments, a tangent to each serration corner may be defined at a first position on the serration corner. The tangent may be parallel to a plane of the respective first facet. The coating may extend around the serration corner from the second facet at least to the first position on the serration corner (defined by the tangent).

Features and advantages described in relation to one aspect may be applicable to other aspects.

In the present disclosure, the term “replica” is merely used to reflect that spatially modulated light is divided such that a complex light field is directed along a plurality of different optical paths. The word “replica” is used to refer to each occurrence or instance of the complex light field after a replication event—such as a partial reflection-transmission by a pupil expander. Each replica travels along a different optical path. Some embodiments of the present disclosure relate to propagation of light that is encoded with a hologram, not an image—i.e., light that is spatially modulated with a hologram of an image, not the image itself. It may therefore be said that a plurality of replicas of the hologram are formed. The person skilled in the art of holography will appreciate that the complex light field associated with propagation of light encoded with a hologram will change with propagation distance. Use herein of the term “replica” is independent of propagation distance and so the two branches or paths of light associated with a replication event are still referred to as “replicas” of each other even if the branches are a different length, such that the complex light field has evolved differently along each path. That is, two complex light fields are still considered “replicas” in accordance with this disclosure even if they are associated with different propagation distances-providing they have arisen from the same replication event or series of replication events.

A “diffracted light field” or “diffractive light field” in accordance with this disclosure is a light field formed by diffraction. A diffracted light field may be formed by illuminating a corresponding diffractive pattern. In accordance with this disclosure, an example of a diffractive pattern is a hologram and an example of a diffracted light field is a holographic light field or a light field forming a holographic reconstruction of an image. The holographic light field forms a (holographic) reconstruction of an image on a replay plane. The holographic light field that propagates from the hologram to the replay plane may be said to comprise light encoded with the hologram or light in the hologram domain. A diffracted light field is characterized by a diffraction angle determined by the smallest feature size of the diffractive structure and the wavelength of the light (of the diffracted light field). In accordance with this disclosure, it may also be said that a “diffracted light field” is a light field that forms a reconstruction on a plane spatially separated from the corresponding diffractive structure. An optical system is disclosed herein for propagating a diffracted light field from a diffractive structure to a viewer. The diffracted light field may form an image.

The term “hologram” is used to refer to the recording which contains amplitude information or phase information, or some combination thereof, regarding the object. The term “holographic reconstruction” is used to refer to the optical reconstruction of the object which is formed by illuminating the hologram. The system disclosed herein is described as a “holographic projector” because the holographic reconstruction is a real image and spatially-separated from the hologram. The term “replay field” is used to refer to the 2D area within which the holographic reconstruction is formed and fully focused. If the hologram is displayed on a spatial light modulator comprising pixels, the replay field will be repeated in the form of a plurality diffracted orders wherein each diffracted order is a replica of the zeroth-order replay field. The zeroth-order replay field generally corresponds to the preferred or primary replay field because it is the brightest replay field. Unless explicitly stated otherwise, the term “replay field” should be taken as referring to the zeroth-order replay field. The term “replay plane” is used to refer to the plane in space containing all the replay fields. The terms “image”, “replay image” and “image region” refer to areas of the replay field illuminated by light of the holographic reconstruction. In some embodiments, the “image” may comprise discrete spots which may be referred to as “image spots” or, for convenience only, “image pixels”.

The terms “encoding”, “writing” or “addressing” are used to describe the process of providing the plurality of pixels of the SLM with a respective plurality of control values which respectively determine the modulation level of each pixel. It may be said that the pixels of the SLM are configured to “display” a light modulation distribution in response to receiving the plurality of control values. Thus, the SLM may be said to “display” a hologram and the hologram may be considered an array of light modulation values or levels.

It has been found that a holographic reconstruction of acceptable quality can be formed from a “hologram” containing only phase information related to the Fourier transform of the original object. Such a holographic recording may be referred to as a phase-only hologram. Embodiments relate to a phase-only hologram but the present disclosure is equally applicable to amplitude-only holography.

The present disclosure is also equally applicable to forming a holographic reconstruction using amplitude and phase information related to the Fourier transform of the original object. In some embodiments, this is achieved by complex modulation using a so-called fully complex hologram which contains both amplitude and phase information related to the original object. Such a hologram may be referred to as a fully-complex hologram because the value (grey level) assigned to each pixel of the hologram has an amplitude and phase component. The value (grey level) assigned to each pixel may be represented as a complex number having both amplitude and phase components. In some embodiments, a fully-complex computer-generated hologram is calculated.

Reference may be made to the phase value, phase component, phase information or, simply, phase of pixels of the computer-generated hologram or the spatial light modulator as shorthand for “phase-delay”. That is, any phase value described is, in fact, a number (e.g. in the range 0 to 2π) which represents the amount of phase retardation provided by that pixel. For example, a pixel of the spatial light modulator described as having a phase value of π/2 will retard the phase of received light by π/2 radians. In some embodiments, each pixel of the spatial light modulator is operable in one of a plurality of possible modulation values (e.g. phase delay values). The term “grey level” may be used to refer to the plurality of available modulation levels. For example, the term “grey level” may be used for convenience to refer to the plurality of available phase levels in a phase-only modulator even though different phase levels do not provide different shades of grey. The term “grey level” may also be used for convenience to refer to the plurality of available complex modulation levels in a complex modulator.

The hologram therefore comprises an array of grey levels—that is, an array of light modulation values such as an array of phase-delay values or complex modulation values. The hologram is also considered a diffractive pattern because it is a pattern that causes diffraction when displayed on a spatial light modulator and illuminated with light having a wavelength comparable to, generally less than, the pixel pitch of the spatial light modulator. Reference is made herein to combining the hologram with other diffractive patterns such as diffractive patterns functioning as a lens or grating. For example, a diffractive pattern functioning as a grating may be combined with a hologram to translate the replay field on the replay plane or a diffractive pattern functioning as a lens may be combined with a hologram to focus the holographic reconstruction on a replay plane in the near field.

Although different embodiments and groups of embodiments may be disclosed separately in the detailed description which follows, any feature of any embodiment or group of embodiments may be combined with any other feature or combination of features of any embodiment or group of embodiments. That is, all possible combinations and permutations of features disclosed in the present disclosure are envisaged.

### BRIEF DESCRIPTION OF THE DRAWINGS

Specific embodiments are described by way of example only with reference to the following figures:

FIG. 1 is a schematic showing a reflective SLM producing a holographic reconstruction on a screen;

FIG. 2 shows an image for projection comprising eight image areas/components, V1 to V8, and cross-sections of the corresponding hologram channels, H1-H8;

FIG. 3 shows a hologram displayed on an LCOS that directs light into a plurality of discrete areas;

FIG. 4 shows a system, including a display device that displays a hologram that has been calculated as illustrated in FIGS. 2 and 3;

FIG. 5 shows a perspective view of a first example two-dimensional pupil expander comprising two replicators;

FIGS. 6A and 6B are schematic views of an automotive head-up display system showing potential areas of sunlight glare;

FIG. 7 is a schematic view of a reflection suppression device formed on a transmission surface of a pupil expander of an automotive head-up display system;

FIG. 8 is a schematic view of a portion of the reflection suppression device of FIG. 7, showing the refraction of light rays passing through the suppression device;

FIGS. 9A and 9B show views of a mould used to injection mould a reflection suppression device in accordance with a first example method of manufacture, FIG. 9A is a schematic view of a top view of a primary part of the mould and FIG. 9B is a schematic cross-sectional view of the mould;

FIGS. 10A and 10B show cross-sectional schematic views of the injection mould of FIGS. 9A and 9B during the method of manufacture, FIG. 10A showing a first step of the method and FIG. 10B showing a second step of the method;

FIGS. 11A and 11B show a reflection suppression device manufactured according to the first example;

FIGS. 12A to 12C schematically show at least some of the steps of a second example method of manufacturing a reflection suppression device;

FIGS. 13A to 13C schematically show at least some of the steps of a third example method of manufacturing a reflection suppression device;

FIGS. 14A to 14C schematically show at least some of the steps of a fourth example method of manufacturing a reflection suppression device;

FIG. 15 schematically shows reflection suppression device manufactured according to a fifth example method of manufacture;

FIGS. 16A and 16B schematically show at least some of the steps of a sixth example method of manufacturing a reflection suppression device;

FIG. 17A schematically shows at least some of the steps of a seventh example method of manufacturing a reflection suppression device;

FIGS. 18A and 18B schematically show at least some of the steps of a ninth example method of manufacturing a reflection suppression device, FIG. 18A showing a cross-section of a mould used in the ninth example;

FIG. 19 is a schematic side view of a first reflection suppression device according to the disclosure in combination with a turning layer;

FIG. 20 is a schematic perspective view of the first reflection suppression device of FIG. 19;

FIG. 21A is a schematic cross-sectional view of a portion of the first reflection suppression device of FIG. 19, the cross-section being in a first (y-z) plane;

FIG. 21A is a schematic cross-sectional view of a portion of the first reflection suppression device of FIG. 19, the cross-section being in a second (x-z) plane;

FIG. 22 is a schematic perspective view of a second reflection suppression device according to the disclosure which replaces the need for the turning layer (of FIG. 19;

FIG. 23A is a schematic cross-sectional view of a portion of the first reflection suppression device of FIG. 22, the cross-section being in a first (y-z) plane;

FIG. 23A is a schematic cross-sectional view of a portion of the first reflection suppression device of FIG. 22, the cross-section being in a second (x-z) plane;

FIG. 24 is a schematic cross-sectional view of a third reflection suppression device;

FIG. 25 is a close-up of the third reflection suppression device of FIG. 24;

FIG. 26 shows a range of light ray paths through the third reflection suppression device of FIG. 24; and

FIGS. 27A to 27C and 28A to 28C schematically show at least some of the steps of a ninth example method of manufacturing a reflection suppression device.

The same reference numbers will be used throughout the drawings to refer to the same or like parts.

### DETAILED DESCRIPTION OF EMBODIMENTS

The present invention is not restricted to the embodiments described in the following but extends to the full scope of the appended claims. That is, the present invention may be embodied in different forms and should not be construed as limited to the described embodiments, which are set out for the purpose of illustration.

Terms of a singular form may include plural forms unless specified otherwise.

A structure described as being formed at an upper portion/lower portion of another structure or on/under the other structure should be construed as including a case where the structures contact each other and, moreover, a case where a third structure is disposed there between.

In describing a time relationship—for example, when the temporal order of events is described as “after”, “subsequent”, “next”, “before” or suchlike—the present disclosure should be taken to include continuous and non-continuous events unless otherwise specified. For example, the description should be taken to include a case which is not continuous unless wording such as “just”, “immediate” or “direct” is used.

Although the terms “first”, “second”, etc. may be used herein to describe various elements, these elements are not to be limited by these terms. These terms are only used to distinguish one element from another. For example, a first element could be termed a second element, and, similarly, a second element could be termed a first element, without departing from the scope of the appended claims.

Features of different embodiments may be partially or overall coupled to or combined with each other, and may be variously inter-operated with each other. Some embodiments may be carried out independently from each other, or may be carried out together in co-dependent relationship.

In the present disclosure, the term “substantially” when applied to a structural units of an apparatus may be interpreted as the technical feature of the structural units being produced within the technical tolerance of the method used to manufacture it.

### Conventional Optical Configuration for Holographic Projection

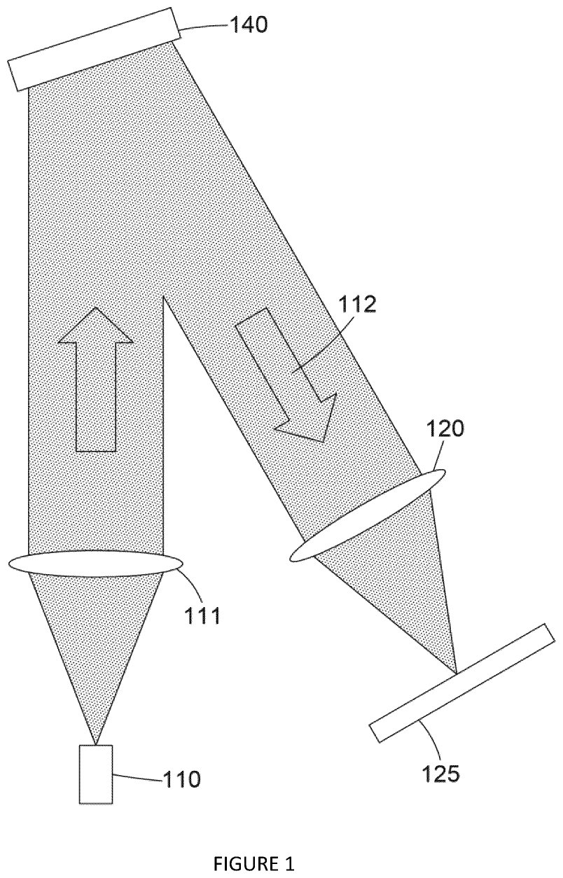

FIG. 1 shows an embodiment in which a computer-generated hologram is encoded on a single spatial light modulator. The computer-generated hologram is a Fourier transform of the object for reconstruction. It may therefore be said that the hologram is a Fourier domain or frequency domain or spectral domain representation of the object. In this embodiment, the spatial light modulator is a reflective liquid crystal on silicon, “LCOS”, device. The hologram is encoded on the spatial light modulator and a holographic reconstruction is formed at a replay field, for example, a light receiving surface such as a screen or diffuser.

A light source 110, for example a laser or laser diode, is disposed to illuminate the SLM 140 via a collimating lens 111. The collimating lens causes a generally planar wavefront of light to be incident on the SLM. In FIG. 1, the direction of the wavefront is off-normal (e.g. two or three degrees away from being truly orthogonal to the plane of the transparent layer). However, in other embodiments, the generally planar wavefront is provided at normal incidence and a beam splitter arrangement is used to separate the input and output optical paths. In the embodiment shown in FIG. 1, the arrangement is such that light from the light source is reflected off a mirrored rear surface of the SLM and interacts with a light-modulating layer to form an exit wavefront 112. The exit wavefront 112 is applied to optics including a Fourier transform lens 120, having its focus at a screen 125. More specifically, the Fourier transform lens 120 receives a beam of modulated light from the SLM 140 and performs a frequency-space transformation to produce a holographic reconstruction at the screen 125.

Notably, in this type of holography, each pixel of the hologram contributes to the whole reconstruction. There is not a one-to-one correlation between specific points (or image pixels) on the replay field and specific light-modulating elements (or hologram pixels). In other words, modulated light exiting the light-modulating layer is distributed across the replay field.

In these embodiments, the position of the holographic reconstruction in space is determined by the dioptric (focusing) power of the Fourier transform lens. In the embodiment shown in FIG. 1, the Fourier transform lens is a physical lens. That is, the Fourier transform lens is an optical Fourier transform lens and the Fourier transform is performed optically. Any lens can act as a Fourier transform lens but the performance of the lens will limit the accuracy of the Fourier transform it performs. The skilled person understands how to use a lens to perform an optical Fourier transform In some embodiments of the present disclosure, the lens of the viewer's eye performs the hologram to image transformation.

### Hologram Calculation

In some embodiments, the computer-generated hologram is a Fourier transform hologram, or simply a Fourier hologram or Fourier-based hologram, in which an image is reconstructed in the far field by utilising the Fourier transforming properties of a positive lens. The Fourier hologram is calculated by Fourier transforming the desired light field in the replay plane back to the lens plane. Computer-generated Fourier holograms may be calculated using Fourier transforms. Embodiments relate to Fourier holography and Gerchberg-Saxton type algorithms by way of example only. The present disclosure is equally applicable to Fresnel holography and Fresnel holograms which may be calculated by a similar method. In some embodiments, the hologram is a phase or phase-only hologram. However, the present disclosure is also applicable to holograms calculated by other techniques such as those based on point cloud methods.

In some embodiments, the hologram engine is arranged to exclude from the hologram calculation the contribution of light blocked by a limiting aperture of the display system. British patent application 2101666.2, filed 5 Feb. 2021 and incorporated herein by reference, discloses a first hologram calculation method in which eye-tracking and ray tracing are used to identify a sub-area of the display device for calculation of a point cloud hologram which eliminates ghost images. The sub-area of the display device corresponds with the aperture, of the present disclosure, and is used exclude light paths from the hologram calculation. British patent application 2112213.0, filed 26 Aug. 2021 and incorporated herein by reference, discloses a second method based on a modified Gerchberg-Saxton type algorithm which includes steps of light field cropping in accordance with pupils of the optical system during hologram calculation. The cropping of the light field corresponds with the determination of a limiting aperture of the present disclosure. British patent application 2118911.3, filed 23 Dec. 2021 and also incorporated herein by reference, discloses a third method of calculating a hologram which includes a step of determining a region of a so-called extended modulator formed by a hologram replicator. The region of the extended modulator is also an aperture in accordance with this disclosure.

In some embodiments, there is provided a real-time engine arranged to receive image data and calculate holograms in real-time using the algorithm. In some embodiments, the image data is a video comprising a sequence of image frames. In other embodiments, the holograms are pre-calculated, stored in computer memory and recalled as needed for display on a SLM. That is, in some embodiments, there is provided a repository of predetermined holograms.

### Large Field of View and Eye-Box Using Small Display Device

Broadly, the present disclosure relates to image projection. It relates to a method of image projection and an image projector which comprises a display device. The present disclosure also relates to a projection system comprising the image projector and a viewing system, in which the image projector projects or relays light from the display device to the viewing system. The present disclosure is equally applicable to a monocular and binocular viewing system. The viewing system may comprise a viewer's eye or eyes. The viewing system comprises an optical element having optical power (e.g., lens/es of the human eye) and a viewing plane (e.g., retina of the human eye/s). The projector may be referred to as a ‘light engine’. The display device and the image formed (or perceived) using the display device are spatially separated from one another. The image is formed, or perceived by a viewer, on a display plane. In some embodiments, the image is a virtual image and the display plane may be referred to as a virtual image plane. In other examples, the image is a real image formed by holographic reconstruction and the image is projected or relayed to the viewing plane. In these other examples, spatially modulated light of an intermediate holographic reconstruction formed either in free space or on a screen or other light receiving surface between the display device and the viewer, is propagated to the viewer. In both cases, an image is formed by illuminating a diffractive pattern (e.g., hologram or kinoform) displayed on the display device.

The display device comprises pixels. The pixels of the display may display a diffractive pattern or structure that diffracts light. The diffracted light may form an image at a plane spatially separated from the display device. In accordance with well-understood optics, the magnitude of the maximum diffraction angle is determined by the size of the pixels and other factors such as the wavelength of the light.

In embodiments, the display device is a spatial light modulator such as liquid crystal on silicon (“LCOS”) spatial light modulator (SLM). Light propagates over a range of diffraction angles (for example, from zero to the maximum diffractive angle) from the LCOS, towards a viewing entity/system such as a camera or an eye. In some embodiments, magnification techniques may be used to increase the range of available diffraction angles beyond the conventional maximum diffraction angle of an LCOS.

In some embodiments, the (light of a) hologram itself is propagated to the eyes. For example, spatially modulated light of the hologram (that has not yet been fully transformed to a holographic reconstruction, i.e. image)—that may be informally said to be “encoded” with/by the hologram—is propagated directly to the viewer's eyes. A real or virtual image may be perceived by the viewer. In these embodiments, there is no intermediate holographic reconstruction/image formed between the display device and the viewer. It is sometimes said that, in these embodiments, the lens of the eye performs a hologram-to-image conversion or transform. The projection system, or light engine, may be configured so that the viewer effectively looks directly at the display device.

Reference is made herein to a “light field” which is a “complex light field”. The term “light field” merely indicates a pattern of light having a finite size in at least two orthogonal spatial directions, e.g. x and y. The word “complex” is used herein merely to indicate that the light at each point in the light field may be defined by an amplitude value and a phase value, and may therefore be represented by a complex number or a pair of values. For the purpose of hologram calculation, the complex light field may be a two-dimensional array of complex numbers, wherein the complex numbers define the light intensity and phase at a plurality of discrete locations within the light field.

In accordance with the principles of well-understood optics, the range of angles of light propagating from a display device that can be viewed, by an eye or other viewing entity/system, varies with the distance between the display device and the viewing entity. At a 1 metre viewing distance, for example, only a small range of angles from an LCOS can propagate through an eye's pupil to form an image at the retina for a given eye position. The range of angles of light rays that are propagated from the display device, which can successfully propagate through an eye's pupil to form an image at the retina for a given eye position, determines the portion of the image that is ‘visible’ to the viewer. In other words, not all parts of the image are visible from any one point on the viewing plane (e.g., any one eye position within a viewing window such as eye-box.)

In some embodiments, the image perceived by a viewer is a virtual image that appears upstream of the display device—that is, the viewer perceives the image as being further away from them than the display device. Conceptually, it may therefore be considered that the viewer is looking at a virtual image through an ‘display device-sized window’, which may be very small, for example 1 cm in diameter, at a relatively large distance, e.g., 1 metre. And the user will be viewing the display device-sized window via the pupil(s) of their eye(s), which can also be very small. Accordingly, the field of view becomes small and the specific angular range that can be seen depends heavily on the eye position, at any given time.

A pupil expander addresses the problem of how to increase the range of angles of light rays that are propagated from the display device that can successfully propagate through an eye's pupil to form an image. The display device is generally (in relative terms) small and the projection distance is (in relative terms) large. In some embodiments, the projection distance is at least one—such as, at least two—orders of magnitude greater than the diameter, or width, of the entrance pupil and/or aperture of the display device (i.e., size of the array of pixels).

Use of a pupil expander increases the viewing area (i.e., user's eye-box) laterally, thus enabling some movement of the eye/s to occur, whilst still enabling the user to see the image. As the skilled person will appreciate, in an imaging system, the viewing area (user's eye box) is the area in which a viewer's eyes can perceive the image. The present disclosure encompasses non-infinite virtual image distances—that is, near-field virtual images.

Conventionally, a two-dimensional pupil expander comprises one or more one-dimensional optical waveguides each formed using a pair of opposing reflective surfaces, in which the output light from a surface forms a viewing window or eye-box. Light received from the display device (e.g., spatially modulated light from a LCOS) is replicated by the or each waveguide so as to increase the field of view (or viewing area) in at least one dimension. In particular, the waveguide enlarges the viewing window due to the generation of extra rays or “replicas” by division of amplitude of the incident wavefront.

The display device may have an active or display area having a first dimension that may be less than 10 cms such as less than 5 cms or less than 2 cms. The propagation distance between the display device and viewing system may be greater than 1 m such as greater than 1.5 m or greater than 2 m. The optical propagation distance within the waveguide may be up to 2 m such as up to 1.5 m or up to 1 m. The method may be capable of receiving an image and determining a corresponding hologram of sufficient quality in less than 20 ms such as less than 15 ms or less than 10 ms.

In some embodiments-described only by way of example of a diffracted or holographic light field in accordance with this disclosure—a hologram is configured to route light into a plurality of channels, each channel corresponding to a different part (i.e. sub-area) of an image. The channels formed by the diffractive structure are referred to herein as “hologram channels” merely to reflect that they are channels of light encoded by the hologram with image information. It may be said that the light of each channel is in the hologram domain rather than the image or spatial domain. In some embodiments, the hologram is a Fourier or Fourier transform hologram and the hologram domain is therefore the Fourier or frequency domain. The hologram may equally be a Fresnel or Fresnel transform hologram. The hologram may also be a point cloud hologram. The hologram is described herein as routing light into a plurality of hologram channels to reflect that the image that can be reconstructed from the hologram has a finite size and can be arbitrarily divided into a plurality of image sub-areas, wherein each hologram channel would correspond to each image sub-area. Importantly, the hologram of this example is characterised by how it distributes the image content when illuminated. Specifically and uniquely, the hologram divides the image content by angle. That is, each point on the image is associated with a unique light ray angle in the spatially modulated light formed by the hologram when illuminated—at least, a unique pair of angles because the hologram is two-dimensional. For the avoidance of doubt, this hologram behaviour is not conventional. The spatially modulated light formed by this special type of hologram, when illuminated, may be divided into a plurality of hologram channels, wherein each hologram channel is defined by a range of light ray angles (in two-dimensions). It will be understood from the foregoing that any hologram channel (i.e. sub-range of light ray angles) that may be considered in the spatially modulated light will be associated with a respective part or sub-area of the image. That is, all the information needed to reconstruct that part or sub-area of the image is contained within a sub-range of angles of the spatially modulated light formed from the hologram of the image. When the spatially modulated light is observed as a whole, there is not necessarily any evidence of a plurality of discrete light channels.

Nevertheless, the hologram may still be identified. For example, if only a continuous part or sub-area of the spatially modulated light formed by the hologram is reconstructed, only a sub-area of the image should be visible. If a different, continuous part or sub-area of the spatially modulated light is reconstructed, a different sub-area of the image should be visible. A further identifying feature of this type of hologram is that the shape of the cross-sectional area of any hologram channel substantially corresponds to (i.e. is substantially the same as) the shape of the entrance pupil although the size may be different—at least, at the correct plane for which the hologram was calculated. Each light/hologram channel propagates from the hologram at a different angle or range of angles. Whilst these are example ways of characterising or identifying this type of hologram, other ways may be used. In summary, the hologram disclosed herein is characterised and identifiable by how the image content is distributed within light encoded by the hologram. Again, for the avoidance of any doubt, reference herein to a hologram configured to direct light or angularly-divide an image into a plurality of hologram channels is made by way of example only and the present disclosure is equally applicable to pupil expansion of any type of holographic light field or even any type of diffractive or diffracted light field.

The system can be provided in a compact and streamlined physical form. This enables the system to be suitable for a broad range of real-world applications, including those for which space is limited and real-estate value is high. For example, it may be implemented in a head-up display (HUD) such as a vehicle or automotive HUD.

In accordance with the present disclosure, pupil expansion is provided for diffracted or diffractive light, which may comprise diverging ray bundles. The diffracted light field may be defined by a “light cone”. Thus, the size of the diffracted light field (as defined on a two-dimensional plane) increases with propagation distance from the corresponding diffractive structure (i.e. display device). It can be said that the pupil expander/s replicate the hologram or form at least one replica of the hologram, to convey that the light delivered to the viewer is spatially modulated in accordance with a hologram.

In some embodiments, two one-dimensional waveguide pupil expanders are provided, each one-dimensional waveguide pupil expander being arranged to effectively increase the size of the exit pupil of the system by forming a plurality of replicas or copies of the exit pupil (or light of the exit pupil) of the spatial light modulator. The exit pupil may be understood to be the physical area from which light is output by the system. It may also be said that each waveguide pupil expander is arranged to expand the size of the exit pupil of the system. It may also be said that each waveguide pupil expander is arranged to expand/increase the size of the eye box within which a viewer's eye can be located, in order to see/receive light that is output by the system.

### Light Channelling

The hologram formed in accordance with some embodiments, angularly-divides the image content to provide a plurality of hologram channels which may have a cross-sectional shape defined by an aperture of the optical system. The hologram is calculated to provide this channelling of the diffracted light field. In some embodiments, this is achieved during hologram calculation by considering an aperture (virtual or real) of the optical system, as described above.

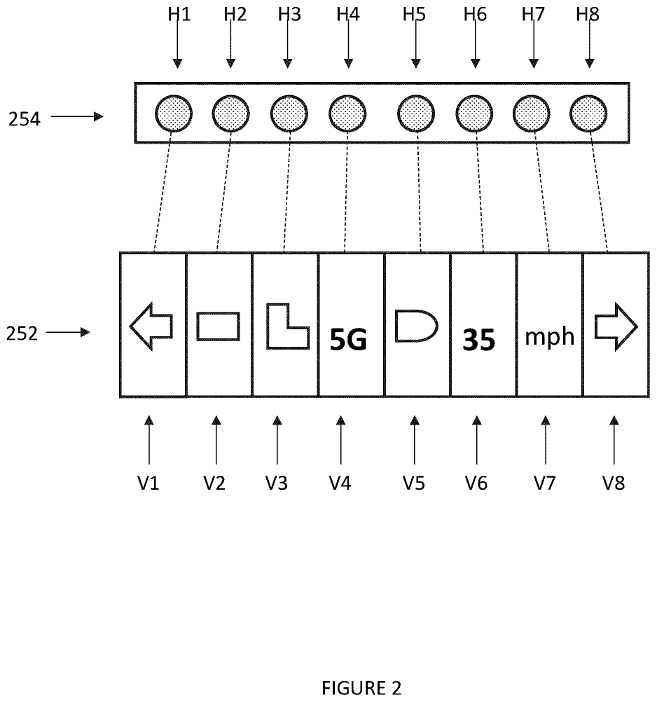

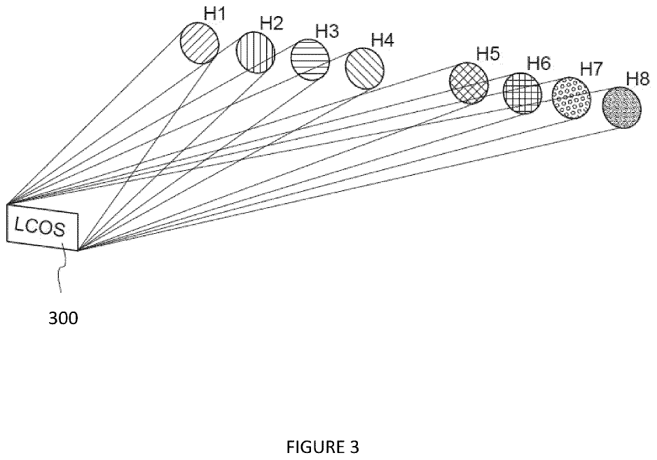

FIGS. 2 and 3 show an example of this type of hologram that may be used in conjunction with a pupil expander as disclosed herein. However, this example should not be regarded as limiting with respect to the present disclosure.

FIG. 2 shows an image 252 for projection comprising eight image areas/components, V1 to V8. FIG. 2 shows eight image components by way of example only and the image 252 may be divided into any number of components. FIG. 2 also shows an encoded light pattern 254 (i.e., hologram) that can reconstruct the image 252—e.g., when transformed by the lens of a suitable viewing system. The encoded light pattern 254 comprises first to eighth sub-holograms or components, H1 to H8, corresponding to the first to eighth image components/areas, V1 to V8. FIG. 2 further shows how a hologram may decompose the image content by angle. The hologram may therefore be characterised by the channelling of light that it performs. This is illustrated in FIG. 3. Specifically, the hologram in this example directs light into a plurality of discrete areas. The discrete areas are discs in the example shown but other shapes are envisaged. The size and shape of the optimum disc may, after propagation through the waveguide, be related to the size and shape of an aperture of the optical system such as the entrance pupil of the viewing system.

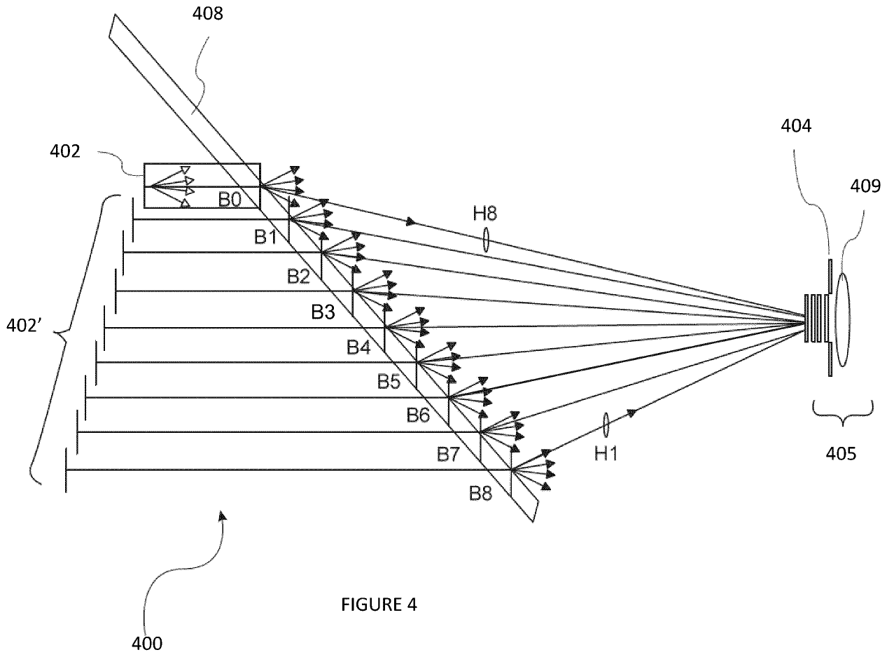

FIG. 4 shows a system 400, including a display device that displays a hologram that has been calculated as illustrated in FIGS. 2 and 3.

The system 400 comprises a display device, which in this arrangement comprises an LCOS 402. The LCOS 402 is arranged to display a modulation pattern (or ‘diffractive pattern’) comprising the hologram and to project light that has been holographically encoded towards an eye 405 that comprises a pupil that acts as an aperture 404, a lens 409, and a retina (not shown) that acts as a viewing plane. There is a light source (not shown) arranged to illuminate the LCOS 402. The lens 409 of the eye 405 performs a hologram-to-image transformation. The light source may be of any suitable type. For example, it may comprise a laser light source.

The viewing system 400 further comprises a waveguide 408 positioned between the LCOS 402 and the eye 405. The presence of the waveguide 408 enables all angular content from the LCOS 402 to be received by the eye, even at the relatively large projection distance shown. This is because the waveguide 508 acts as a pupil expander, in a manner that is well known and so is described only briefly herein.

In brief, the waveguide 408 shown in FIG. 4 comprises a substantially elongate formation. In this example, the waveguide 408 comprises an optical slab of refractive material, but other types of waveguide are also well known and may be used. The waveguide 408 is located so as to intersect the light cone (i.e., the diffracted light field) that is projected from the LCOS 402, for example at an oblique angle. In this example, the size, location, and position of the waveguide 408 are configured to ensure that light from each of the eight ray bundles, within the light cone, enters the waveguide 408. Light from the light cone enters the waveguide 408 via its first planar surface (located nearest the LCOS 402) and is guided at least partially along the length of the waveguide 408, before being emitted via its second planar surface, substantially opposite the first surface (located nearest the eye). As will be well understood, the second planar surface is partially reflective, partially transmissive. In other words, when each ray of light travels within the waveguide 408 from the first planar surface and hits the second planar surface, some of the light will be transmitted out of the waveguide 408 and some will be reflected by the second planar surface, back towards the first planar surface. The first planar surface is reflective, such that all light that hits it, from within the waveguide 408, will be reflected back towards the second planar surface. Therefore, some of the light may simply be refracted between the two planar surfaces of the waveguide 408 before being transmitted, whilst other light may be reflected, and thus may undergo one or more reflections, (or ‘bounces’) between the planar surfaces of the waveguide 408, before being transmitted.

FIG. 4 shows a total of nine “bounce” points, B0 to B8, along the length of the waveguide 408. Although light relating to all points of the image (V1-V8) as shown in FIG. 2 is transmitted out of the waveguide at each “bounce” from the second planar surface of the waveguide 408, only the light from one angular part of the image (e.g. light of one of V1 to V8) has a trajectory that enables it to reach the eye 405, from each respective “bounce” point, B0 to B8. Moreover, light from a different angular part of the image, V1 to V8, reaches the eye 405 from each respective “bounce” point. Therefore, each angular channel of encoded light reaches the eye only once, from the waveguide 408, in the example of FIG. 4.

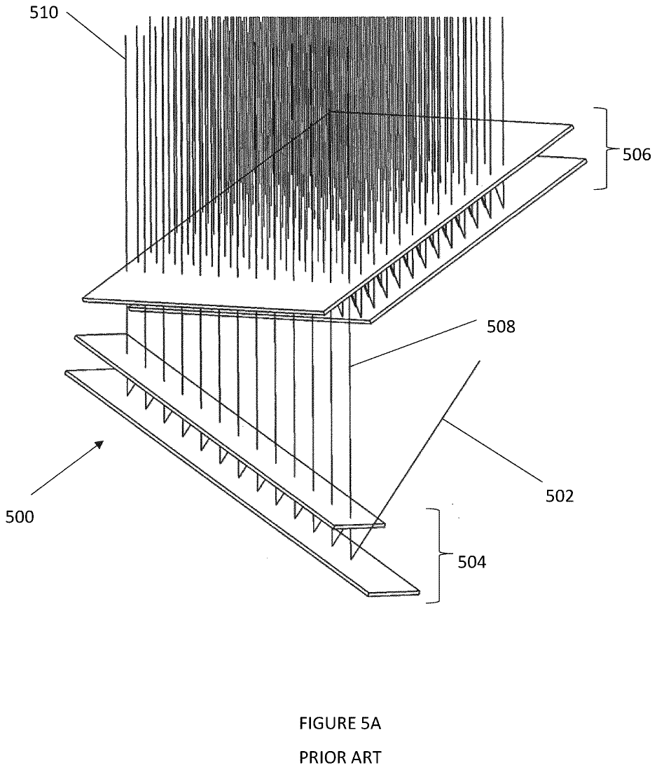

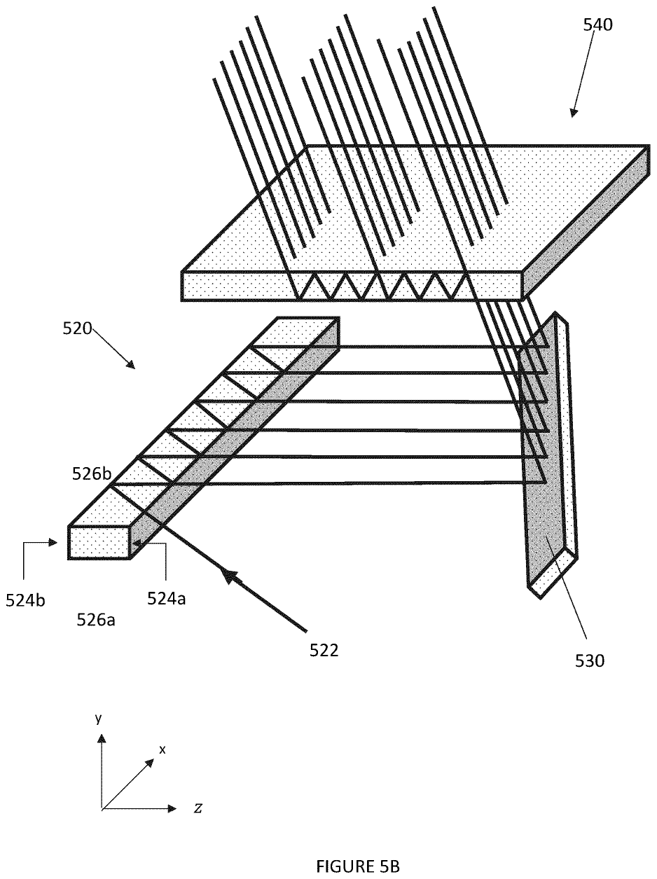

The waveguide 408 forms a plurality of replicas of the hologram, at the respective “bounce” points B1 to B8 along its length, corresponding to the direction of pupil expansion. As shown in FIG. 5, the plurality of replicas may be extrapolated back, in a straight line, to a corresponding plurality of replica or virtual display devices 402′. This process corresponds to the step of “unfolding” an optical path within the waveguide, so that a light ray of a replica is extrapolated back to a “virtual surface” without internal reflection within the waveguide. Thus, the light of the expanded exit pupil may be considered to originate from a virtual surface (also called an “extended modulator” herein) comprising the display device 402 and the replica display devices 402′.

Although virtual images, which require the eye to transform received modulated light in order to form a perceived image, have generally been discussed herein, the methods and arrangements described herein can be applied to real images.

### Two-Dimensional Pupil Expansion

Whilst the arrangement shown in FIG. 4 includes a single waveguide that provides pupil expansion in one dimension, pupil expansion can be provided in more than one dimension, for example in two dimensions. Moreover, whilst the example in FIG. 4 uses a hologram that has been calculated to create channels of light, each corresponding to a different portion of an image, the present disclosure and the systems that are described herebelow are not limited to such a hologram type.

FIG. 5A shows a perspective view of a system 500 comprising two replicators, 504, 506 arranged for expanding a light beam 502 in two dimensions.

In the system 500 of FIG. 5A, the first replicator 504 comprises a first pair of surfaces, stacked parallel to one another, and arranged to provide replication—or, pupil expansion—in a similar manner to the waveguide 408 of FIG. 4. The first pair of surfaces are similarly (in some cases, identically) sized and shaped to one another and are substantially elongate in one direction. The collimated light beam 502 is directed towards an input on the first replicator 504. Due to a process of internal reflection between the two surfaces, and partial transmission of light from each of a plurality of output points on one of the surfaces (the upper surface, as shown in FIG. 5A), which will be familiar to the skilled reader, light of the light beam 502 is replicated in a first direction, along the length of the first replicator 504. Thus, a first plurality of replica light beams 508 is emitted from the first replicator 504, towards the second replicator 506.

The second replicator 506 comprises a second pair of surfaces stacked parallel to one another, arranged to receive each of the collimated light beams of the first plurality of light beams 508 and further arranged to provide replication—or, pupil expansion—by expanding each of those light beams in a second direction, substantially orthogonal to the first direction. The first pair of surfaces are similarly (in some cases, identically) sized and shaped to one another and are substantially rectangular. The rectangular shape is implemented for the second replicator in order for it to have length along the first direction, in order to receive the first plurality of light beams 508, and to have length along the second, orthogonal direction, in order to provide replication in that second direction. Due to a process of internal reflection between the two surfaces, and partial transmission of light from each of a plurality of output points on one of the surfaces (the upper surface, as shown in FIG. 5A), light of each light beam within the first plurality of light beams 508 is replicated in the second direction. Thus, a second plurality of light beams 510 is emitted from the second replicator 506, wherein the second plurality of light beams 510 comprises replicas of the input light beam 502 along each of the first direction and the second direction. Thus, the second plurality of light beams 510 may be regarded as comprising a two-dimensional grid, or array, of replica light beams.

Thus, it can be said that the first and second replicators 504, 505 of FIG. 5A combine to provide a two-dimensional replicator (or, “two-dimensional pupil expander”). Thus, the replica light beams 510 may be emitted along an optical path to an expanded eye-box of a display system, such as a head-up display.

In the system of FIG. 5A, the first replicator 504 is a waveguide comprising a pair of elongate rectilinear reflective surfaces, stacked parallel to one another, and, similarly, the second replicator 504 is a waveguide comprising a pair of rectangular reflective surfaces, stacked parallel to one another. In other systems, the first replicator may be a solid elongate rectilinear waveguide and the second replicator may be a solid planar rectangular shaped waveguide, wherein each waveguide comprises an optically transparent solid material such as glass. In this case, the pair of parallel reflective surfaces are formed by a pair of opposed major sidewalls optionally comprising respective reflective and reflective-transmissive surface coatings, familiar to the skilled reader.

FIG. 5B shows a perspective view of a system 500 comprising two replicators, 520, 540 arranged for replicating a light beam 522 in two dimensions, in which the first replicator is a solid elongated waveguide 520 and the second replicator is a solid planar waveguide 540.

In the system of FIG. 5B, the first replicator/waveguide 520 is arranged so that its pair of elongate parallel reflective surfaces 524a, 524b are perpendicular to the plane of the second replicator/waveguide 540. Accordingly, the system comprises an optical coupler arranged to couple light from an output port of first replicator 520 into an input port of the second replicator 540. In the illustrated arrangement, the optical coupler is a planar/fold mirror 530 arranged to fold or turn the optical path of light to achieve the required optical coupling from the first replicator to the second replicator. As shown in FIG. 5B, the mirror 530 is arranged to receive light-comprising a one-dimensional array of replicas extending in the first dimension—from the output port/reflective-transmissive surface 524a of the first replicator/waveguide 520. The mirror 530 is tilted so as to redirect the received light onto an optical path to an input port in the (fully) reflective surface of second replicator 540 at an angle to provide waveguiding and replica formation, along its length in the second dimension. It will be appreciated that the mirror 530 is one example of an optical element that can redirect the light in the manner shown, and that one or more other elements may be used instead, to perform this task.

In the illustrated arrangement, the (partially) reflective-transmissive surface 524a of the first replicator 520 is adjacent the input port of the first replicator/waveguide 520 that receives input beam 522 at an angle to provide waveguiding and replica formation, along its length in the first dimension. Thus, the input port of first replicator/waveguide 520 is positioned at an input end thereof at the same surface as the reflective-transmissive surface 524a. The skilled reader will understand that the input port of the first replicator/waveguide 520 may be at any other suitable position.

Accordingly, the arrangement of FIG. 5B enables the first replicator 520 and the mirror 530 to be provided as part of a first relatively thin layer in a plane in the first and third dimensions (illustrated as an x-z plane). In particular, the size or “height” of a first planar layer—in which the first replicator 520 is located—in the second dimension (illustrated as the y dimension) is reduced. The mirror 530 is configured to direct the light away from a first layer/plane, in which the first replicator 520 is located (i.e. the “first planar layer”), and direct it towards a second layer/plane, located above and substantially parallel to the first layer/plane, in which the second replicator 540 is located (i.e. a “second planar layer”). Thus, the overall size or “height” of the system—comprising the first and second replicators 520, 540 and the mirror 530 located in the stacked first and second planar layers in the first and third dimensions (illustrated as an x-z plane)—in the second dimension (illustrated as the y dimension) is compact. The skilled reader will understand that many variations of the arrangement of FIG. 5B for implementing the present disclosure are possible and contemplated.

The image projector may be arranged to project a diverging or diffracted light field. In some embodiments, the light field is encoded with a hologram. In some embodiments, the diffracted light field comprises diverging ray bundles. In some embodiments, the image formed by the diffracted light field is a virtual image.

In some embodiments, the first pair of parallel/complementary surfaces are elongate or elongated surfaces, being relatively long along a first dimension and relatively short along a second dimension, for example being relatively short along each of two other dimensions, with each dimension being substantially orthogonal to each of the respective others. The process of reflection/transmission of the light between/from the first pair of parallel surfaces is arranged to cause the light to propagate within the first waveguide pupil expander, with the general direction of light propagation being in the direction along which the first waveguide pupil expander is relatively long (i.e., in its “elongate” direction).

There is disclosed herein a system that forms an image using diffracted light and provides an eye-box size and field of view suitable for real-world application—e.g. in the automotive industry by way of a head-up display. The diffracted light is light forming a holographic reconstruction of the image from a diffractive structure—e.g. hologram such as a Fourier or Fresnel hologram. The use diffraction and a diffractive structure necessitates a display device with a high density of very small pixels (e.g. 1 micrometer)—which, in practice, means a small display device (e.g. 1 cm). The inventors have addressed a problem of how to provide 2D pupil expansion with a diffracted light field e.g. diffracted light comprising diverging (not collimated) ray bundles.

In some embodiments, the display system comprises a display device—such as a pixelated display device, for example a spatial light modulator (SLM) or Liquid Crystal on Silicon (LCoS) SLM-which is arranged to provide or form the diffracted or diverging light. In such aspects, the aperture of the spatial light modulator (SLM) is a limiting aperture of the system. That is, the aperture of the spatial light modulator—more specifically, the size of the area delimiting the array of light modulating pixels comprised within the SLM-determines the size (e.g. spatial extent) of the light ray bundle that can exit the system. In accordance with this disclosure, it is stated that the exit pupil of the system is expanded to reflect that the exit pupil of the system (that is limited by the small display device having a pixel size for light diffraction) is made larger or bigger or greater in spatial extend by the use of at least one pupil expander.

The diffracted or diverging light field may be said to have “a light field size”, defined in a direction substantially orthogonal to a propagation direction of the light field. Because the light is diffracted/diverging, the light field size increases with propagation distance.

In some embodiments, the diffracted light field is spatially-modulated in accordance with a hologram. In other words, in such aspects, the diffractive light field comprises a “holographic light field”. The hologram may be displayed on a pixelated display device. The hologram may be a computer-generated hologram (CGH). It may be a Fourier hologram or a Fresnel hologram or a point-cloud hologram or any other suitable type of hologram. The hologram may, optionally, be calculated so as to form channels of hologram light, with each channel corresponding to a different respective portion of an image that is intended to be viewed (or perceived, if it is a virtual image) by the viewer. The pixelated display device may be configured to display a plurality of different holograms, in succession or in sequence. Each of the aspects and embodiments disclosed herein may be applied to the display of multiple holograms.

The output port of the first waveguide pupil expander may be coupled to an input port of a second waveguide pupil expander. The second waveguide pupil expander may be arranged to guide the diffracted light field-including some of, preferably most of, preferably all of, the replicas of the light field that are output by the first waveguide pupil expander—from its input port to a respective output port by internal reflection between a third pair of parallel surfaces of the second waveguide pupil expander.

The first waveguide pupil expander may be arranged to provide pupil expansion, or replication, in a first direction and the second waveguide pupil expander may be arranged to provide pupil expansion, or replication, in a second, different direction. The second direction may be substantially orthogonal to the first direction. The second waveguide pupil expander may be arranged to preserve the pupil expansion that the first waveguide pupil expander has provided in the first direction and to expand (or, replicate) some of, preferably most of, preferably all of, the replicas that it receives from the first waveguide pupil expander in the second, different direction. The second waveguide pupil expander may be arranged to receive the light field directly or indirectly from the first waveguide pupil expander. One or more other elements may be provided along the propagation path of the light field between the first and second waveguide pupil expanders.

The first waveguide pupil expander may be substantially elongated and the second waveguide pupil expander may be substantially planar. The elongated shape of the first waveguide pupil expander may be defined by a length along a first dimension. The planar, or rectangular, shape of the second waveguide pupil expander may be defined by a length along a first dimension and a width, or breadth, along a second dimension substantially orthogonal to the first dimension. A size, or length, of the first waveguide pupil expander along its first dimension make correspond to the length or width of the second waveguide pupil expander along its first or second dimension, respectively. A first surface of the pair of parallel surfaces of the second waveguide pupil expander, which comprises its input port, may be shaped, sized, and/or located so as to correspond to an area defined by the output port on the first surface of the pair of parallel surfaces on the first waveguide pupil expander, such that the second waveguide pupil expander is arranged to receive each of the replicas output by the first waveguide pupil expander.

The first and second waveguide pupil expander may collectively provide pupil expansion in a first direction and in a second direction perpendicular to the first direction, optionally, wherein a plane containing the first and second directions is substantially parallel to a plane of the second waveguide pupil expander. In other words, the first and second dimensions that respectively define the length and breadth of the second waveguide pupil expander may be parallel to the first and second directions, respectively, (or to the second and first directions, respectively) in which the waveguide pupil expanders provide pupil expansion. The combination of the first waveguide pupil expander and the second waveguide pupil expander may be generally referred to as being a “pupil expander”.

It may be said that the expansion/replication provided by the first and second waveguide expanders has the effect of expanding an exit pupil of the display system in each of two directions. An area defined by the expanded exit pupil may, in turn define an expanded eye-box area, from which the viewer can receive light of the input diffracted or diverging light field. The eye-box area may be said to be located on, or to define, a viewing plane.

The two directions in which the exit pupil is expanded may be coplanar with, or parallel to, the first and second directions in which the first and second waveguide pupil expanders provide replication/expansion. Alternatively, in arrangements that comprise other elements such as an optical combiner, for example the windscreen (or, windshield) of a vehicle, the exit pupil may be regarded as being an exit pupil from that other element, such as from the windscreen. In such arrangements, the exit pupil may be non-coplanar and non-parallel with the first and second directions in which the first and second waveguide pupil expanders provide replication/expansion. For example, the exit pupil may be substantially perpendicular to the first and second directions in which the first and second waveguide pupil expanders provide replication/expansion.

The viewing plane, and/or the eye-box area, may be non-coplanar or non-parallel to the first and second directions in which the first and second waveguide pupil expanders provide replication/expansion. For example, a viewing plane may be substantially perpendicular to the first and second directions in which the first and second waveguide pupil expanders provide replication/expansion.

In order to provide suitable launch conditions to achieve internal reflection within the first and second waveguide pupil expanders, an elongate dimension of the first waveguide pupil expander may be tilted relative to the first and second dimensions of the second waveguide pupil expander.

### Combiner Shape Compensation

An advantage of projecting a hologram to the eye-box is that optical compensation can be encoded in the hologram (see, for example, European patent 2936252 incorporated herein by herein). The present disclosure is compatible with holograms that compensate for the complex curvature of an optical combiner used as part of the projection system. In some embodiments, the optical combiner is the windscreen of a vehicle. Full details of this approach are provided in European patent 2936252 and are not repeated here because the detailed features of those systems and methods are not essential to the new teaching of this disclosure herein and are merely exemplary of configurations that benefit from the teachings of the present disclosure.

### Control Device

The present disclosure is also compatible with optical configurations that include a control device (e.g. light shuttering device) to control the delivery of light from a light channelling hologram to the viewer. The holographic projector may further comprise a control device arranged to control the delivery of angular channels to the eye-box position. British patent application 2108456.1, filed 14 Jun. 2021 and incorporated herein by reference, discloses the at least one waveguide pupil expander and control device. The reader will understand from at least this prior disclosure that the optical configuration of the control device is fundamentally based upon the eye-box position of the user and is compatible with any hologram calculation method that achieves the light channeling described herein. It may be said that the control device is a light shuttering or aperturing device. The light shuttering device may comprise a 1D array of apertures or windows, wherein each aperture or window independently switchable between a light transmissive and a light non-transmissive state in order to control the delivery of hologram light channels, and their replicas, to the eye-box. Each aperture or window may comprise a plurality of liquid crystal cells or pixels.

### Reflection Suppression to Mitigate Glare

In operation, the transmission/exit surface (i.e. expanded exit pupil) of the second replicator 506 of the two-dimensional pupil expander of FIG. 5 forms an external surface or “output port” from which image light is transmitted through air to an eye-box area for viewing. Accordingly, the transmission surface may be exposed to sunlight from the environment in which the head-up display is used. Received sunlight may cause glare to the viewer, in particular due to reflections of sunlight associated with the pupil expander 506 and/or a turning film, if used in conjunction with the pupil expander 506. For example, glare may arise if rays of sunlight are directly reflected from the external transmission surface, or other surfaces of the pupil expander 506, at angles such that rays of sunlight follow an optical path directly to the viewing area/eye-box. This is described herein as “direct glare”. In another example, glare may arise if sunlight is coupled into the pupil expander 506 at angles such that rays of sunlight follow the same optical path within the pupil expander as rays of image light, or are otherwise reflected by surfaces thereof, in order to reach the viewing area/eye-box indirectly (e.g. via an optical combiner, such as a vehicle windscreen). This is described herein as “veiling glare”.

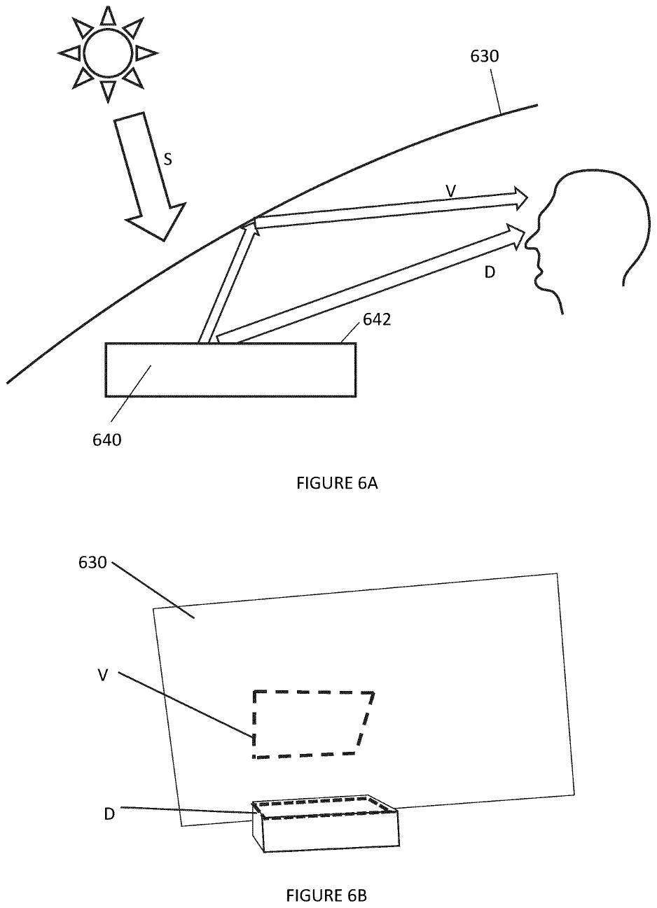

FIG. 6A shows the optical path of rays of sunlight S incident on the transmission/exit surface 642 of a (bulk optic) waveguide pupil expander 640 of a head-up display (HUD) in an automotive application. In particular, sunlight S at a relatively high elevation angle to the horizon is incident through a vehicle windscreen 630 onto the external transmission/exit surface 642 of the pupil expander 640. In the example, the transmission/exit surface 642 is located in a substantially horizontal plane in an aperture in the vehicle dashboard (not shown). Some sunlight rays D may be directly reflected from the pupil expander 640 (e.g. by one or more reflective layers thereof) towards the viewing area/eye-box and cause “direct glare”. Some other light rays V may be indirectly reflected from the pupil expander 640 (e.g. by one or more reflective layers thereof) towards the viewing area/eye box, via the windscreen 730 and cause “veiling glare”. Thus, light rays V may follow the same optical path(s) as image light output from the pupil expander 640. In either case, the glare arising from reflected sunlight may be harmful to the viewer/driver. FIG. 6B shows the view at the viewing area/eye-box indicating the areas of the windscreen and dashboard, from which the viewer/driver may receive sunlight glare. An area of direct glare D is seen at the exit/transmission surface in the vehicle dashboard (not shown) and an area of viewing glare V is seen at the vehicle windscreen. The skilled person will appreciate that the presence of glare from different positions within the illustrated areas D and V at a particular point in time may depend on the elevation angle of the sun and the configuration of the display system (both internally and in situ).

### Reflection Suppression Device

Accordingly, there is a reflection suppression device to be position over the transmission surface of the second replicator/pupil expander, or more generally the output port of the HUD or any other optical component comprising a reflective surface, to reduce the risk of glare to the viewer. The reflection suppression device comprises a louvre structure comprising a plurality of parallel louvres comprising a light absorbing material. The orientation (e.g. the side-wall angle(s), pitch and geometry (e.g. length, width and thickness)) of the louvres is chosen to allow image light to be transmitted from the HUD at the desired range of angles necessary to reach the viewing area/eye-box. The inventors have recognized that an array of louvres, typically in the form of longitudinal rectangular-shaped louvre slats, may be used to control the direction and/or suppress reflections of sunlight that may be incident on the transmission surface/output port of the HUD due to its upwardly facing/horizontal orientation in a vehicle dashboard adjacent the vehicle windscreen. The reflection suppression device further comprises a transparent support structure configured to provide mechanical strength and rigidity to the reflection suppression device. In particular, the support structure may be configured to substantially prevent deformation of the array louvres which would otherwise cause the louvres to deviate from the desired angle. The inventors have identified that one problem with the inclusion of the transparent structure is that sunlight (or other unwanted light) may be reflected by a surface of the transparent support structure. So, the transparent structure may introduce another source of glare into the optical system. The transparent support structure can be shaped so as to form a serrated top (or external) surface, the serrations of the serrated surface being co-ordinated with the louvres. Each of the serrations forms an angled surface. The angle of the angled surface is chosen so that light that is reflected by the angled top surface in such a way that the reflected light is not relayed to the eye-box. Thus, the serrated surface of the transparent structure acts to suppress glare as well as to improve mechanical stability.

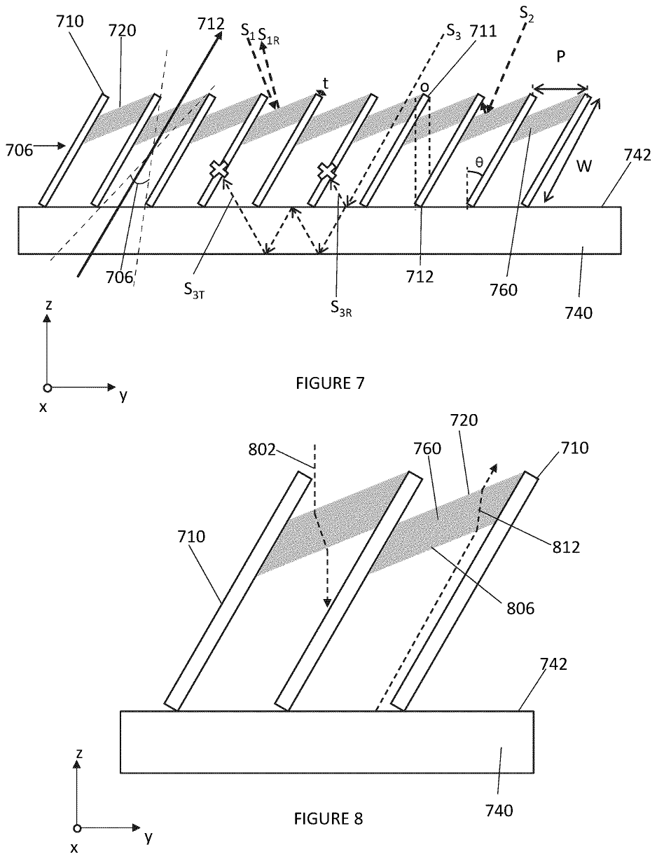

FIG. 7 shows an example of a reflection suppression device. The reflection suppression device comprises a light control layer in the form of louvre structure 706 for reducing glare due to reflected sunlight in accordance with reflection suppression devices of the present invention. The louvre structure 706 comprises a plurality of parallel louvres/louvre slats 710. Each louvres 710 has a length extending in the x direction. Thus, the length (long dimension) of the louvres/louvre slats 710 is parallel to a first dimension (illustrated as the x dimension). Each louvre is angled with respect to the z axis (in other words, is angled with respect to the normal of a plane defined by the x and y axis). The louvre slats 710 comprise a light absorbing or light attenuating (e.g. light diffusing) material in order to block light rays incident thereon. In the illustrated arrangement, the louvre structure 706 is disposed on a substantially planar transmission surface 742 forming the output port of a second replicator/waveguide pupil expander 740, which is arranged to internally reflect and replicate image light to provide pupil expansion in the second dimension. However, in other embodiments, the transmission surface 742 could be replaced with a reflective surface of any other optical component.

Light rays of the image light are formed and output by the waveguide 740 at the transmission surface 742. A single ray of image light 712 is shown in FIG. 7. However, it should be clear that rays of image light will be output along the waveguide pupil expander 740 in the y direction. Each ray of image light will be parallel and so emitted at the same angle as 712. The louvre slats are inclined at angle θ (as shown in FIG. 7). Angle θ is defined as the angle with respect to the normal of the transmission surface (i.e. the angle with respect to the z axis in FIG. 7). Angle θ is chosen to be equal to the angle of the image light 712. The angled orientation of the louvre slats 710 enables the light rays of the replicas of the image light 712 to pass between the louvre slats 710 without deviation from the required optical path/s via the windscreen to the viewing area/eye-box. The louvres are configured with an orientation, pitch and geometry arranged to limit the range of transmission angles 708 from the second (top/external) surface, as shown by dashed lines. So, while image light 712 is shown being parallel to the louvres 710, in actual fact all light having an angle falling with range of angles 708 may pass through the reflection suppression structure without deviation and be received at an eye-box.

In this example, the width of the louvres 710 and the pitch p between adjacent louvres 710 and/or the orientation angle θ of the louvres 710 are selected such that there is an overlap (or overhang) between adjacent louvres (in the y dimension). In particular, the distal end/edge 711—the end that is remote/distal with respect to the transmission surface 742—of one louvre overlaps (or overhangs) the proximal end/edge 712 of the adjacent/neighbouring louvre in the second dimension, as shown by overlap o. It may be said that the proximal end/edge 712 of one or a pair of neighbouring louvres/louvre slats 710 is in the shadow of the overlap (or overhang) o of the distal end/edge 711 of the other of the pair of neighbouring louvres/louvre slats 710.

The reflection suppression device further comprises a transparent support structure. In this example, the transparent support structure comprises a plurality of transparent elements 760 made of a transparent material such as glass or a transparent polymer material. In this example, the transparent material has a refractive index of greater than 1. Each of the transparent elements 760 are provided between adjacent louvres 710. Each transparent element 760 is in contact with a first louvre 710 at a first end and in contact with a second louvre 710 at a second end. In some examples, the transparent element 760 is fixed such as glued to each of the first and second louvres. A top surface 720 of each of the transparent elements is angled with respect to the transmission surface 742 (i.e. is angled with respect to the normal of a plane defined by the x and y axis). The top surface 720 of each of the transparent elements 760 forms a serrated surface, with each top surface 720 forming one of the serrations such that the serrated surface comprises an array of serrations. In this embodiment, the serrations are uniformly spaced and are aligned with the louvres. Thus, it may be said that the periodicity of the serrations is substantially equal to the periodicity of the array of louvres.

The reflection suppression device of FIG. 7 is configured to prevent sunlight glare to a viewer at the viewing area/eye-box from various angles of elevation and as a result of passing through various routes within the reflection suppression device.

FIG. 7 shows a ray of sunlight S₁ from the sun at a first elevation angle (with respect to the horizon) and incident on the louvre structure 706. Some of these rays (not shown) of sunlight S₁ may be incident directly on the louvre slats 710 where the light is absorbed or attenuated without reaching the transmission surface 742. In addition, some of these rays (shown) of sunlight S₁ may be incident on the transparent elements 760 between the louvre slats 710 as shown. Owing to the serrated configuration and orientation of the transparent structures 760, these rays of sunlight S₁ may be specularly reflected by one or more surfaces of the transparent structure 760. Because of the angled top surface of the serrated transparent surface, the reflected rays of sunlight S_{1R} are directed on an optical path away from the viewing area/eye-box as shown by the arrow. In particular, S_{1R} is reflected in such a way as to fall outside of the range of angles 706.

FIG. 7 further shows a ray of sunlight S₂ from the sun at a second elevation angle, which is higher/greater than the first elevation angle and incident on the louvre structure 706. Owing to the configuration and orientation of the transparent structures 760, the rays of sunlight S₂ may be specularly reflected by one or more surfaces of the transparent structure 760 in a direction onto one of the louvres 710, and thus absorbed or attenuated. This blocks/reduces the intensity of reflected rays of sunlight S_{2R} which may be directed towards the viewing area/eye-box as shown by the arrow. However, rays of sunlight S₂ that are incident on, and transmitted through, the transparent structures 760 may reach the transmission surface 742.

FIG. 7 further shows ray of sunlight S₃ from the sun at a third elevation angle which is different to the first and second angles of elevation. In this scenario, sunlight S₃ is received at an angle that enables the light rays to pass between the louvres/louvre slats 710 (e.g. parallel to the sidewalls of the louvre slats 710) and to be (directly) incident on the transmission surface 742 of the waveguide pupil expander 740 (after being transmitted through a transparent element 760. In this scenario, a proportion of the incident sunlight S₃ may be specularly reflected from the transmission surface 742 as reflected rays S_{3R}. However, due to the parameters of the louvre structure 706, as described herein, the reflected rays S_{3R} are specularly reflected along an optical path that is blocked by a louvre/louvre slat 710, and thus absorbed or attenuated as shown by cross X. Furthermore, the remaining proportion of incident sunlight S₃ may be transmitted through the transmission surface 742 into the waveguide pupil expander 740. In this case, as shown in FIG. 7, the light rays may be internally reflected between the opposed reflective surfaces of the waveguide 740 as shown by arrows (from right to left—the opposite direction to the direction of pupil expansion). At each internal reflection/bounce at the partially reflective-partially transmissive surface 742, some light rays are emitted from the transmission surface 742 as transmitted rays S_{3T}. However, once again, the transmitted rays S_{3T} are emitted from the transmission surface 742 along an optical path that is blocked by a louvre/louvre slat 710, and thus also absorbed or attenuated as shown by cross X. The overlap o of the louvres described above may ensure that the sunlight cannot escape being absorbed by the louvres 710 (whether that be after transmission or reflection).

Accordingly, the optical path of rays of sunlight incident on the reflection suppression device comprising the louvre structure and the transparent support structure, at substantially all angles of elevation of the sun follow an optical path that is blocked, and thus absorbed or attenuated, by at least one of the louvres/louvre slats 710. Thus, the risk of sunlight being reflected towards the viewing area/eye-box and causing glare is reduced/mitigated. This is achieved while the transparent support structure also provides mechanical strength and stability to the reflection suppression device.

For simplicity, refraction effects (particularly, refraction caused when light is transmitted through the transparent support structure) have not shown in FIG. 7. However, because, in this example, the transparent support structure comprises transparent elements 760 formed of a transparent material having a refractive index of greater than 1, light will be refracted as it passes from air into the transparent element 760. This is shown in FIG. 8 which shows a close-up view of three of the louvres 710 of FIG. 7 and the associated transparent elements 760.

A single light ray 812 of the image light formed and output by the waveguide 740 at the transmission surface 742 is shown in FIG. 8. FIG. 8 shows how each transparent element has a parallelogram structure. In particular, the top surface 720 of each transparent element 760 is parallel to a bottom surface 806. In other words, the top and bottom surface 720, 806 correspond to one another and the thickness of the transparent element 760 (i.e. the distance between the top surface 720 and the bottom surface 806) is constant. The single light ray 812 is initially output from the waveguide 740 at an angle such that the single light ray 812 is parallel to the adjacent louvre. When the single light ray 812 is input into the transparent element 760, the change in refractive index at the air/transparent element boundary causes the direction/angle of the single light ray 812 to deviate slightly. When the single light ray 812 is output from the transparent element 760, the change in refractive index at the transparent element/air boundary causes the direction/angle of the single light ray 812 to deviate slightly in an opposite direction to the air/transparent element boundary. Advantageously, because the top and bottom surfaces of the transparent element 760 are parallel, the overall shift in light rays passing through transparent element 760 will be constant for all light rays at all positions. Thus, while the transparent element 760 may cause a slight positional shift in the light rays emitted, this shift does not cause distortion of an image viewed at the eye-box.

Sunlight that is input into the transparent element 760 will also be refracted by the transparent element. Sunlight is represented by single ray 802 in FIG. 8. FIG. 8 shows how 802 is deviated/shifted slightly as a result of refraction, but this does prevent the sunlight from eventually being absorbed by the louvres 710.

Above, it has been described how a (spatial) overlap of louvres 710 ensures that sunlight cannot escape being absorbed by a louvre. This (spatial) overlap comprises the proximal end of one of the of louvres 710 being in shadow of the distal end of another of the louvres 710. However, in some embodiments, a spatial overlap may not be strictly necessary. This is because the transparent element can be arranged so that the refraction effect caused by the transparent element steers the sunlight towards a nearby louvre, as shown in FIG. 8. The upshot of this is that the reflection suppression device may optically appear to have overlapping louvres, even if the louvres do not (quite) spatially overlap. This may be referred to as an optical overlap. So, in some embodiments, the louvres 710 may not spatially overlap but do at least optically overlap. In such cases, the louvres 710 may still be referred to as overlapping.

### Methods of Manufacture

Generally, there are provided methods for manufacturing reflection suppression devices having the glare suppression advantages and mechanical robustness and rigidity of the reflection suppression device described in relation to FIG. 7. These methods all allow for mass production of such reflection suppression devices with high speed and at low cost.

Each of the methods comprises a first step of forming a first component and a second step of forming a second component. The first component corresponds to the support structure shown in FIG. 7. The second component corresponds to the array of louvres 706 shown in FIG. 7. In more detail, the first step comprises processing a transparent material to form a serrated surface, wherein processing the transparent material comprises at least one selected from the group comprising extruding, injection moulding, hot embossing or cutting the transparent material. The second step comprises processing a light absorbing material to form a plurality of louvres arranged in an array, wherein processing the light absorbing material comprises at least one selected from the group comprising: adjoining, gluing, painting or supporting the light absorbing material in a support structure. The method further comprises at least partially fixing the first component and the second component together such that a periodicity of the serrated surface (of the first component) is equal to a periodicity of the array of louvres (of the second component), and optionally the periodicity of the two components is substantially in-phase. This fixing step may be part of the first or second manufacturing steps.

Herein, a number of specific examples of methods are described by way of example only of the principles described above. It should be clear that these examples are not limiting.

### First Example

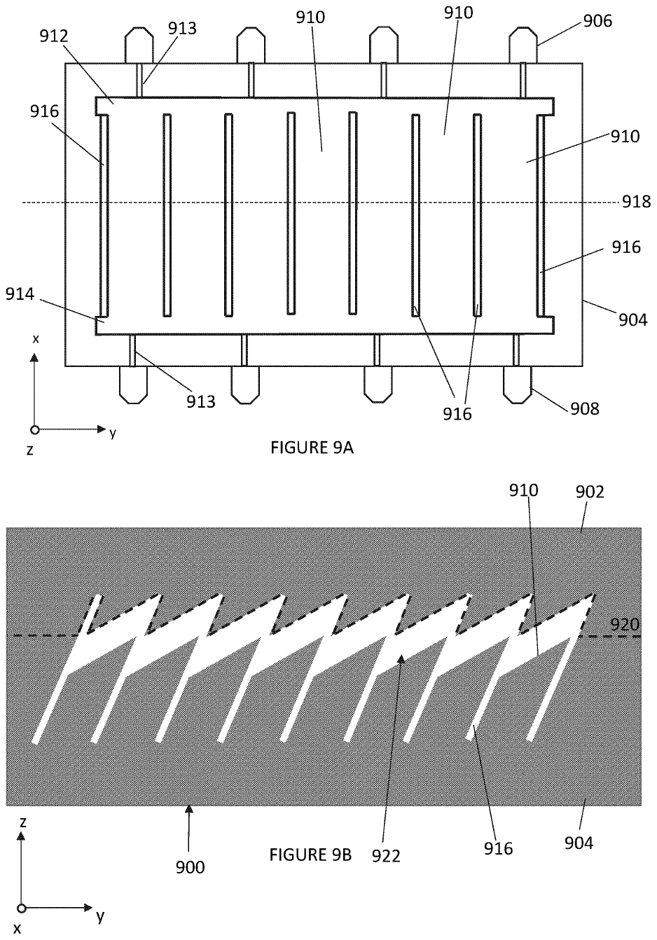

A first example of a method of manufacturing a reflection suppression device is described in relation to FIGS. 9A, 9B, 10A, 10B, 11A and 11B.

The first example of the method comprises injection moulding the molten transparent material to form first component of the reflection suppression device. Before the injection moulding step is carried out, a plurality of strips of light absorbing material are arranged in an array within supports defined in the mould used in the injection moulding processes to form the second component. Thus, following injection moulding the molten transparent material (and subsequent cooling of the material), an integrally formed reflection suppression device is formed in which the array of louvres (second component) are fixed to the light absorbing material of the first component as a result of injection moulding.

An injection mould 900 for manufacturing the reflection suppression device by injection moulding is shown in FIGS. 9A and 9B. The injection mould 900 comprises two primary plates: a first primary plate 902 and a second primary plate 904. The first and second primary plates 902, 904 are separable from one another. Each of the first and second primary plates 902, 904 comprise a body comprising indentations. When the first and second primary plates 902, 904 are brought together, one or more cavities are defined by the indentations in the respective bodies.

FIG. 9A is a schematic view of the second primary plate 904 from above (in the x-y plane), separate from the first primary plate. The second primary plate 904 comprises a plurality of input ports 906 and a plurality of output ports 908. The example of FIG. 9 comprises four each of input and output ports. This is merely exemplary. There could be any number of input and output ports and the number of input ports may be different to the number of output ports. The second primary plate 904 further comprises a plurality of first indentations 910. Each first indentation 910 is shaped to form at least a portion of one of the transparent elements 760 as shown in FIG. 7. Each of the first indentations 910 is parallel. A first (top) end of each first indentation 910 is connected to a second indentation 912. A second (bottom) end of each first indentation 910 is connected a third indentation 914. Each of the input ports 906 is connected to the second indentation 912 by runner lines 913. Each of the output ports 908 is connected to the third indentation 914. The second primary plate 904 further defines slots 916 formed in the body of the second primary plate 904. Each of first indentations 910 is separated by a slot 916. Each slot 916 is arranged to receive a strip of light absorbing material.

FIG. 9B shows a cross-sectional view of the mould 900, the cross-section being in a plane that is parallel to the y and z-axis and through line 918 shown in FIG. 9A. The first and second primary plates 902, 904 are shown together in FIG. 9B. The dotted line 920 represents the interface between the two plates. FIG. 9A shows how first indentations 910 in the second primary plate 904 match corresponding indentations in the first primary plate 902. This forms a cavity 922. A single cavity 922 is formed in the example of FIGS. 9A and 9B because the first indentations 910 are all connected to one another by the second and third indentations.

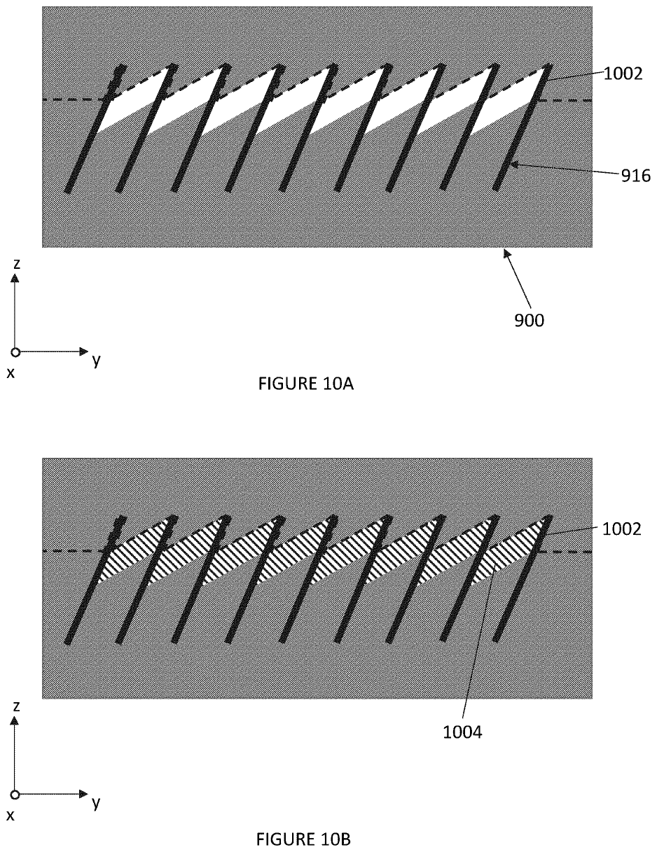

FIGS. 10A and 10B show steps of a method for injection moulding a reflection suppression device using the mould of FIGS. 9A and 9B. FIG. 10A shows a step of forming a second component of the suppression device by supporting strips 1002 of a light absorbing material in the slots 916 of the mould, the slots 916 acts as a support structure for the strips 1002. In this example, the strips comprise a strip of metal coated in an opaque material. In other examples, the strips may not comprise the coating. In other examples, the strips may be formed of light absorbing plastic or rubber. The strips 1002 form the array of louvres in the manufactured suppression device. The slots 916 are arranged (in particular, angled) so that the strips 1002 are supported in the desired position and orientation required of the louvres in the final product. FIG. 10B shows a step of forming a first component of the suppression device by injection moulding molten transparent material 1004 using the mould 900. In particular, the molten transparent material 904 is injected (under pressure) through the input ports 906. The molten transparent material 1004 is then forced through the runner lines 913 and on into the cavity 922 defined by the various indentations of the mould. The molten transparent material 1004 is forced first into a portion of the cavity 922 defined by the second indentation 912 and fills this portion of the cavity 922. So, the flow of molten transparent material 1004 is substantially in the y-direction. The molten transparent material 1004 is then forced into each of the portions of the cavity 922 defined by the first indentations 910 and fills those portions. The molten transparent material 1004 then passes into and fills a portion of cavity 922 defined by the third indentation 912 before finally exiting the mould out of exit ports 908 (via runner lines 913). The supply of molten transparent material at the input ports is stopped after a predetermined time period. The mould is then cooled so that the molten transparent material sets. Because the cavity 922 of the mould 900 is filled by transparent material, the shape of the transparent material corresponds to the shape of the cavity 922 (and so the shape of various indentations). During manufacture, the molten transparent material is forced against the strips 1002 of light absorbing material. When the transparent material sets to form the first component, the strips 1002 of light absorbing material are fixed to the light absorbing material. In other words, the first component and the second component are fixed together with a portion of each of the louvres of the second component being embedded in the first component. In this way, an integrally formed reflection suppression device is formed. The reflection suppression device can then be removed from the mould. The slots and indentations of the mould are arranged such that the first component has a (top and bottom) serrated surfaces and the periodicity of the serrations of the serrated surface is equal to the periodicity of the array of louvres.

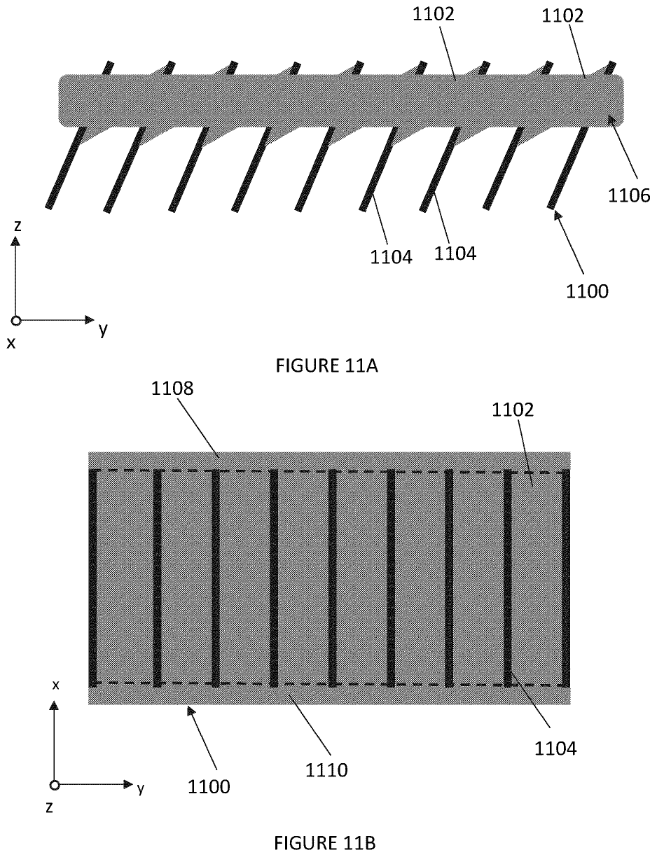

FIGS. 11A and 11B show different schematic views of a reflection suppression device 1100 resulting from the method shown in FIGS. 9 and 10. FIG. 11A is a side view of the reflection suppression device 1100. FIG. 11B is a cross-sectional view of the reflection suppression device 1100, the cross section being taken in the x-y plane. The reflection suppression device 1100 comprises a first component comprising a plurality of transparent elements 1102 integrally formed with an array of louvres 1104 (the second component). The transparent element 1102 and louvres 1104 are arranged in the same way as the transparent elements and louvres described in relation to FIG. 7 (in particular, in relation to glare suppression). The main difference is that FIGS. 11A and 11B additionally show how the reflection suppression device 1100 in this embodiment comprise a frame 1106. The frame 1106 comprises a first side 1108 and a second side 1110. The first and second sides of the frame 1108, 1110 are formed by the portions of the cavity of the mould defined by the second and third indentations 912, 914. So, in the same way that the second and third indentations 912,914 are connected to the ends of each of the first indentations, the first and second sides of the frame are connected to ends of each of the transparent elements 1102. The frame 1106 improves the mechanical strength of the reflection suppression device 1100 without interfering with the optical performance of the reflection suppression device or an associated head up display.

### Second Example

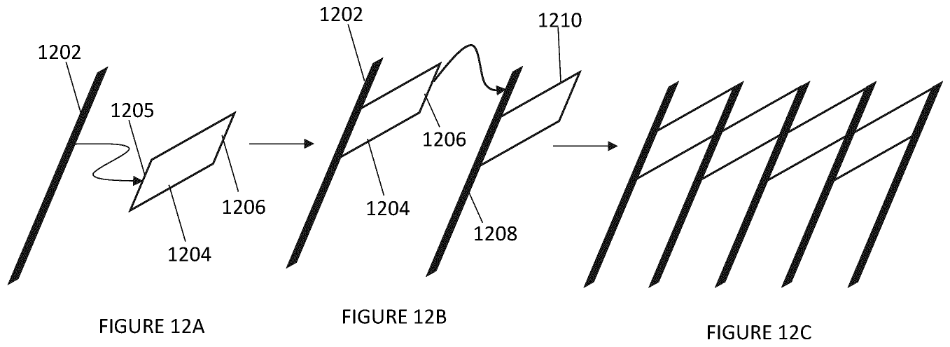

A second example of a method of manufacturing a reflection suppression device is described in relation to FIG. 12A to 12C.

The second example of the method comprises forming a plurality of pieces of transparent material (i.e. plurality of transparent elements) and then assembling the first component from the plurality of transparent element, rather than forming the first component as a single piece as in the first example. Each of the plurality of transparent elements is formed by one of extruding, injection moulding or cutting a source of transparent material into a desired shape (in this example an elongated shaping having a cross-section in the shape of a parallelogram). The step of assembling the first component further comprises providing a plurality of strips of light absorbing material and assembling the strips of light absorbing material and the transparent elements in an alternating configuration.

FIG. 12A shows a first strip 1202 of light absorbing material and a first transparent element 1204 (being elongated and having a parallelogram shaped cross-section). The first transparent element 1204 has been formed by extruding, injection moulding or cutting a source of transparent material into the desired shape. FIG. 12A shows a first step of assembling the first component. The first step comprises gluing a first end 1205 of the first transparent element 1204 to a first side of the first strip 1202 of light absorbing material. The glue is then set or cured. FIG. 12B shows a second step of assembling the first component. The second step comprises gluing a second end 1206 of the first transparent element 1204 to a second side of a second strip 1208 of light absorbing material. The glue is then set or cured. The second strip 1208 of light absorbing material already has a second transparent element 1210 affixed to its first side with glue. Each pair of strip of light absorbing material fixed to a transparent element may be considered a repeat unit. A plurality of repeat units may be fixed together to build up a larger structure. This is shown in FIG. 12C in which four repeat units have been attached together. The last repeat unit has an additional strip of light absorbing material fixed to the second side as an endcap. An advantage of assembling a reflection suppression device in this way is that the a structure of any size may be built without the need for a new mould (which could be expensive). The glue used in this example preferably has a refractive index that substantially matches the refractive index of the transparent material (when the glue is set or cured). The step of setting the glue may simply comprise waiting for a predetermined period of time. However, in some examples, the glue may be UV curable glue and so the step of setting or curing the glue may comprise applying UV radiation to the joint.

The final structure of a reflection suppression device formed in the method of the second example is substantially similar to that of the first example. In particular, a first component comprising a serrated top and bottom surface is formed in combination with a second component comprising an array of louvres and such that a periodicity of the serrated surface is equal to a periodicity of the array of louvres.

### Third Example

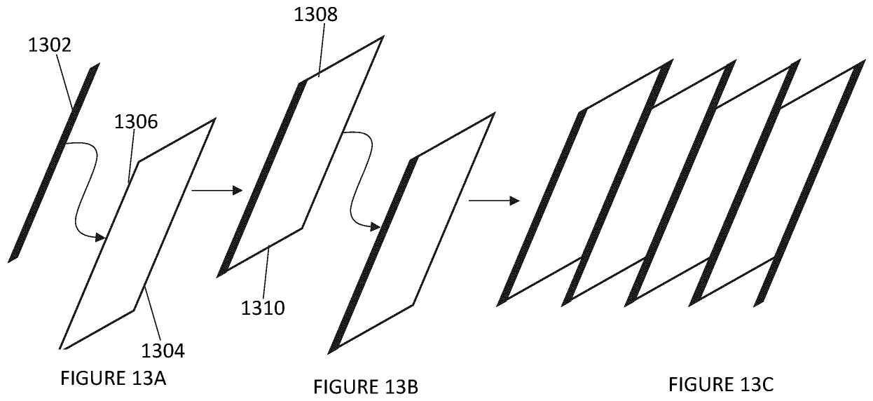

A third example of a method of manufacturing a reflection suppression device is described in relation to FIG. 13A to 13C. The third example method is substantially the same as the second example. However, the cross-sectional shape of each of the plurality of transparent elements is different in the third example relative to the second example. In particular, each repeat unit in the third example comprises a strip 1302 of light absorbing material and a transparent element 1304. However, in the second example, the cross-section of the transparent element 1204 is such that only a relatively small portion of the first side of the strip 1202 is in contact with (glued to) transparent element 1204. Instead, in the third example, the cross-section of the transparent element 1304 is such that the entirety of a first side 1306 of the strip 1302 is in contact with (glued to) transparent element 1304. In particular, a thickness of the transparent element 1304 between its top and bottom surface (1308 and 1310 respectively) is equal to the length of strip 1302 and greater than the corresponding thickness of transparent element 1304.

The final structure of a reflection suppression device formed the method of the third example differs to the previous example only because of the thicker transparent element. Glare is suppressed in exactly the same way as in the method shown in FIG. 7.

An advantage of the structure resulting from the method of the third example is that the thicker transparent element (relative to the first and second example) improves the mechanical strength and stability of the manufactured reflection suppression device. However, the thicker the transparent element, the more HUD light that will be absorbed reducing the intensity of the HUD light received at the eye-box. Thus, there is a choice to be made as to whether to prioritise strength or light intensity. As will be clear, intermediate thicknesses of transparent element, between the thicknesses shown in the second and third examples, are possible. A thickness can be chosen to achieve the desired balance of mechanical strength and intensity of output light.

In a modification of the third example, the louvres may be formed by painting at least one sidewall of each of the transparent elements 1304 with a black paint before the transparent elements are assembled. This may replace the step shown in FIG. 13A.

### Fourth Example

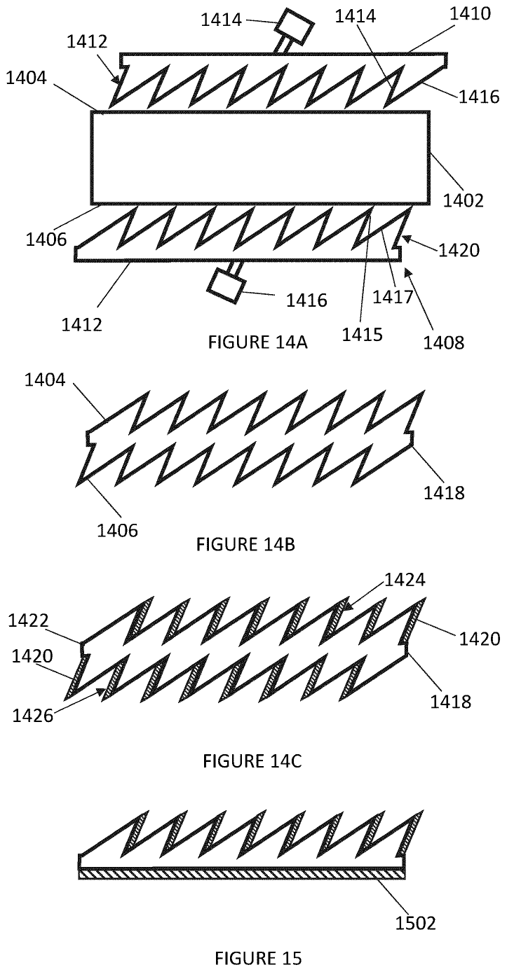

A fourth example of a method of manufacturing a reflection suppression device is described in relation to FIG. 14A to 14C.

Like the first example, the fourth example of the method comprises forming the first component (of transparent material) as a single component. In particular, the fourth example comprises hot embossing a block or slab of transparent material using a tool (hot embossing stamp) having a repeating prismatic structure. The method of the fourth example further comprising adjoining or gluing strips of light absorbing material on to the embossed transparent material or painting light absorbing material on to the embossed transparent material.

FIG. 14A shows a first step of forming the first component. A block 1402 of transparent material has been provided. The block of transparent material, prior to embossing, has a top surface 1404 and a bottom surface 1406. The top surface 1404 is parallel to the bottom surface 1406. The first step of forming the first component comprises using a hot-embossing tool 1408 to shape the both the top surface 1404 and the bottom surface 1406 to have a serrated structure. As shown in FIG. 14A, the tool 1408 comprises a first stamp 1410 adjacent the top surface 1404 and a second stamp 1412 adjacent the bottom surface 1406. The first stamp 1410 comprises a repeating prismatic structure 1412 comprising a front facet 1414 and a back facet 1416. The front and back facets together at least partially define a prism which is repeated along the length of the first stamp 1410. The second stamp 1412 comprises a repeating prismatic structure 1420 which corresponds to the repeating prismatic structure 1412 of the first stamp 1410. The step shown in FIG. 14A comprises bringing the first stamp and second stamp 1410, 1412 together using movement means 1414, 1416 at the same time to compress and shape the block of transparent material in accordance with the prismatic shape of the stamps.

FIG. 14B show an embossed block 1418 of transparent material (i.e. the block after the step of FIG. 14A). The embossed top surface 1404 has a structure corresponding to the prismatic shape of the first stamp 1410 and the embossed bottom surface 1406 has a structure corresponding to the prismatic shape of the second stamp 1412. In particular, the serrated structure is formed from a plurality of prismatic shapes comprising a first facet 1415 and a second facet 1416 corresponding, respectively, with the first and second facets 1414 and 1416 of the stamp. So, FIGS. 14A and 14B show how the first component can be formed as a single component. FIG. 14C shows a step of forming an array of louvres, fixed to the embossed block 1418, as a second component. In some examples, each louvre 1420 of the array of louvres is in the form of a strip of light absorbing material which is adjoined or glued on to appropriate surfaces of the first component. In some examples, each louvre 1420 of the array of louvres is painted on to appropriate surfaces of the first component.

The structure of the reflection suppression device formed in the fourth example (shown in FIG. 14C) differs to the structure formed in the first example. Rather than each louvre being separated by a single transparent element (having, for example, a parallelogram shape), a core 1422 of the first component extends unbroken along the full length of the first component. The core 1422 separates the top serrated surface 1404 from the bottom serrated surface 1406. The core 1422 also separates the louvres 1420 into a top layer 1424 and a bottom layer 1426. Despite the difference in structure, the inventors have found that the reflection suppression device of FIG. 14C is as effective as the reflection suppression device formed in first example. Furthermore, the structure maintains a constant thickness between parallel surfaces of the top and bottom serrated surfaces 1406. So, like in the earlier examples, HUD light is not dispersed by refraction (although each HUD ray may be translationally shifted slightly).

In other examples, the same structure of reflection suppression device could be formed by injection moulding transparent material into the shape shown in FIG. 14B, or by cutting or even extruding the shape shown in FIG. 14B from a block of transparent material. Louvres would then be fixed to the shaped transparent material as in FIG. 14C.

### Fifth Example

A fifth example of a method of manufacturing a reflection suppression device is described in relation to FIG. 15. The fifth method of manufacturing is substantially the same as the fourth method of manufacturing. However, the hot embossing tool used in the fifth example comprises only the first (top) stamp 1410 and no second (bottom) stamp. Thus, the first component formed by hot embossing comprises only a top serrated surface 1502.

A reflection suppression device formed by the fifth method of manufacturing is shown in FIG. 15. The inventors have found that this structure is similarly able to suppress glare as the structure shown, for example, in FIG. 7. However, a problem with the structure of FIG. 15 is that the transparent material has a varying thickness along the length of the reflection suppression device. This is unlike the previous examples in which the thickness between corresponding serrations of top and bottom surfaces is constant. As described previously, the advantage of having constant thickness is that dispersion of HUD light relayed from different portions of the transmission surface is avoided. The geometry of the first component in the reflection suppression device of FIG. 15 does not avoid this dispersion. Optionally, in order to compensate for the dispersion, the method of the fifth example may further comprise applying a diffractive film 1502 to the bottom surface of the first component. The diffractive film can be provided with a diffraction pattern arranged to compensate for the changing thickness of the transparent first component.

### Sixth Example

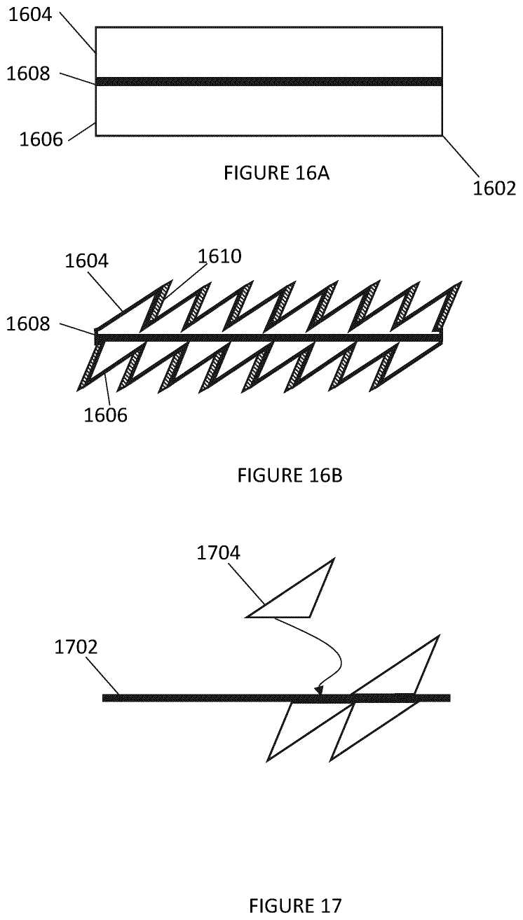

A sixth example of a method of manufacturing a reflection suppression device is described in relation to FIGS. 16A and 16B. The sixth method of manufacturing is exactly the same as the fourth method of manufacturing. However, the block of transparent material 1602 to be embossed has a more complicated structure in the sixth example than in the fourth example. In particular, the block 1602 comprises a layered structure (as shown in FIG. 15A). Top and bottom layers 1604, 1606 of the block 1602 are formed of silicone. A core layer 1608 is positioned between the top and bottom layers 1604, 1606. The core layer is formed of a material that is harder than silicone, for example a hard transparent plastic material. When the block of transparent material 1602 is embossed, the relatively softer silicone top and bottom layers 1604,1606 are shaped by the embossing tool. The core layer 1608 remains unshaped. Louvres 1610 are then glued to or painted on the first component. A reflection suppression device manufactured according to the sixth example is shown in FIG. 16B.

The advantage of manufacturing the first component from a layered block as described above is that the portions of the block (i.e. the top and bottom layers 1604, 1606) are formed of a relatively softer material that requires less effort to shape/emboss while the stronger core layer 1608 ensures that overall structure has enough mechanical strength to support the louvres.

### Seventh Example

A seventh example of a method of manufacturing a reflection suppression device is described in relation to FIG. 17. The seventh method comprises forming a first component of the reflection suppression device by: providing a core layer 1702; providing a plurality of transparent elements 1704; and assembling the first component by attaching (gluing) the plurality of transparent elements 1704 on to the core layer 1702. The core layer 1702 corresponds to the core layer described in the sixth example. The transparent elements 1704 are each formed by injection moulding, extrusion or cutting (similarly to second and third examples). The transparent elements 1704 are shaped to correspond to a single serration of the serrated surface of sixth example. A first plurality of the transparent elements 1704 are glued to a first side of the core layer 1702 and a second plurality of the transparent elements 1704 are glued to a second side of the core layer 1702. Once the first component has been formed as described, an array of louvres may be adjoined, glued or painted on to appropriate surfaces of the first component to form a structure resembling that shown in FIG. 16B.

### Eighth Example

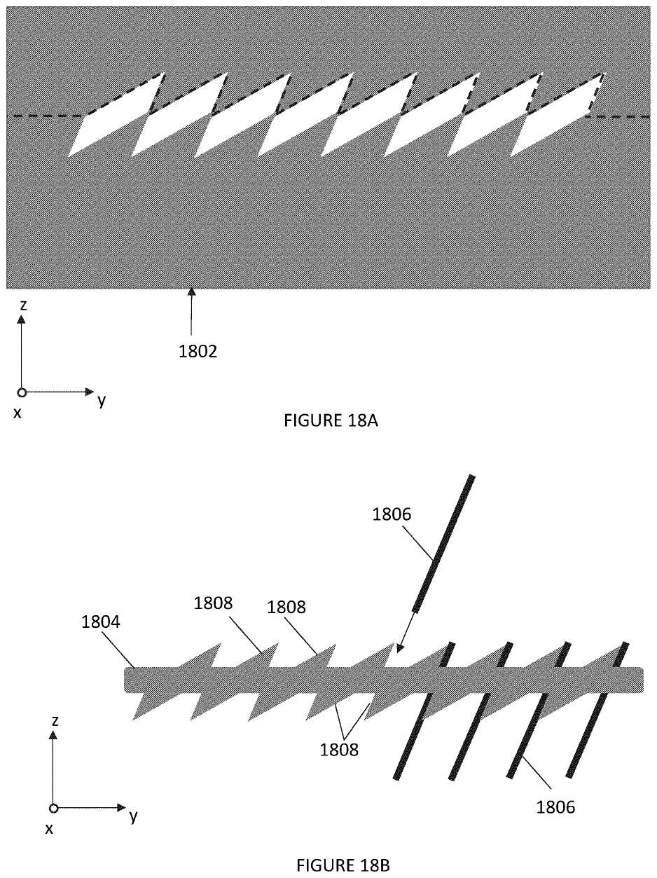

An eighth example of a method of manufacturing a reflection suppression device is described in relation to FIGS. 18A and 18B. The eight example is another method comprising injection moulding and is effectively a modification of the first example. In the eight example, an injection mould 1802 is used to provide a transparent first component. The injection mould 1802 is similar to the injection mould 900 of the first example. However, the injection mould 1802 does not comprise slots for receiving strips of light absorbing material. Instead, the first indentations of the mould are separated by the body of the mould 1802. This is shown in the cross-section of the mould shown in FIG. 18A. The result is that the injection moulded first component comprises a plurality of members each member forming a serration and being separated adjacent members by a gap. Molten transparent material is injected into the mould in the same way as in the first example and then cooled/set/cured to form an integrally formed first component which is then removed from the mould. Unlike in the first example however, the first component is manufactured entirely separately from the louvres. So, the method of the eighth example requires an additional step of fixing strips of light absorbing material to the first component 1804. This comprises inserting strips of light absorbing material 1806 into the gaps formed between members 1808. Glue is used to fix the strips of light absorbing material 1806 in place. This is show in FIG. 18B.

### Head-Up Display Comprising a Reflection Suppression Device

Thus far, a reflection suppression device has been described and a number of different methods of manufacturing a reflection suppression device have been described. Examples of a head-up display comprising a reflection suppression device according to the disclosure will now be described. The reflection suppression device comprised in said examples of the head-up display may or may not have been manufactured according to one of the above method of manufacturing examples.

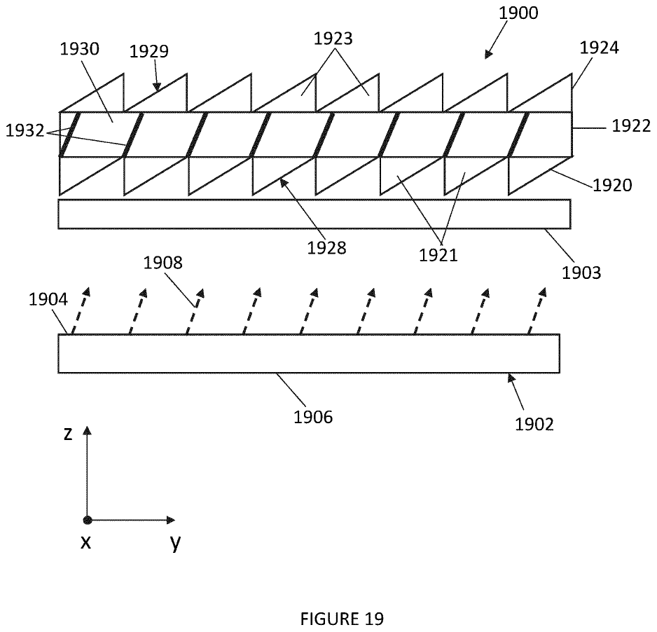

FIG. 19 shows a schematic side-view of a features of a head-up display comprising a first reflection suppression device 1900. The head-up display of FIG. 19 comprises a waveguide 1902, a turning layer 1903, and the first reflection suppression device 1900. The head-up display further comprises a coherent light source (in this example, a laser) and a display device (in this example, a liquid crystal on silicon spatial light modulator) arranged to display a hologram of a picture. The light source and display device are not shown in FIG. 19. In use, the light source of the head-up display illuminates the display device such that light is spatially modulated in accordance with the hologram displayed on the display device, thus forming a holographic wavefront. The holographic wavefront is coupled into a first waveguide (not shown in FIG. 19) where the holographic wavefront is replicated in a first direction a plurality of times (as described previously) to form a one dimensional array of replicas which are then coupled into the waveguide 1902 (which is shown in FIG. 19). The waveguide 1902 comprises a pair of opposing surfaces. A first surface 1904 of the waveguide 1902 is partially transmissive-reflective. A second surface 1906 of the waveguide 1908 is reflective. The waveguide 1902 is arranged to waveguide the replicas of the holographic wavefront coupled in to the waveguide 1902 from the first waveguide between the pair of opposing surfaces. In this way, the holographic wavefront is replicated in a second direction (that is orthogonal to the first direction) a plurality of times (again, as described previously) to form a two dimensional array of replicas. The emission of replicas from the first surface 1904 is represented by the dotted arrows 1908 in FIG. 19. In the y-z plane, the replicas 1908 are angled with respect to a normal of the waveguide 1902 (i.e. the replicas are angled with respect to the z-direction in the y-z plane). In this example, the replicas 1908 of the holographic wavefront (at the first surface of the waveguide 1904) do not have a component on the x-z plane. So, as the skilled reader will appreciate, in a side view of the waveguide 1902 in the x-z plane, the replicas 1908 would appear to be emitted vertically up the page.

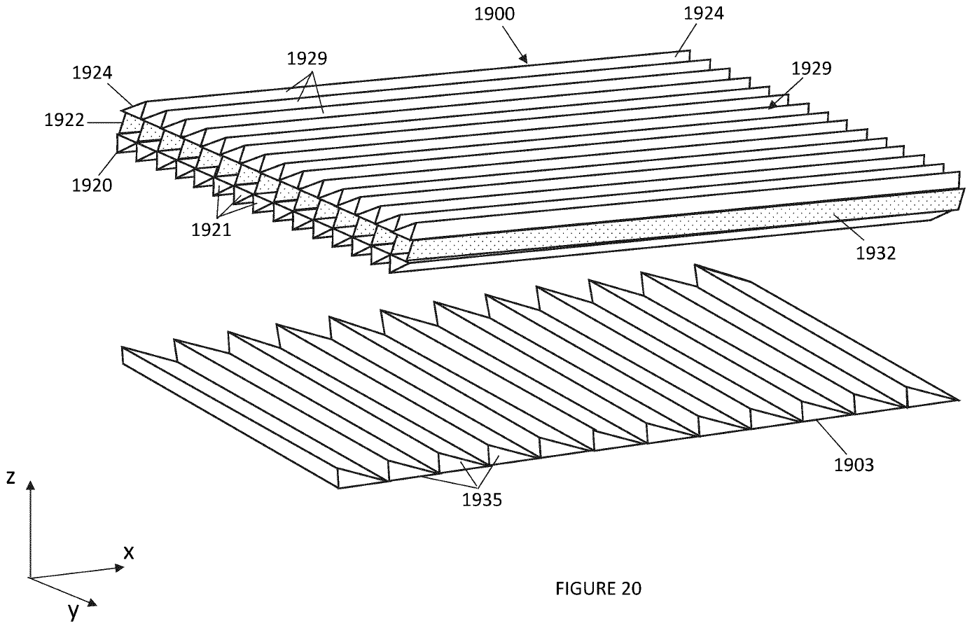

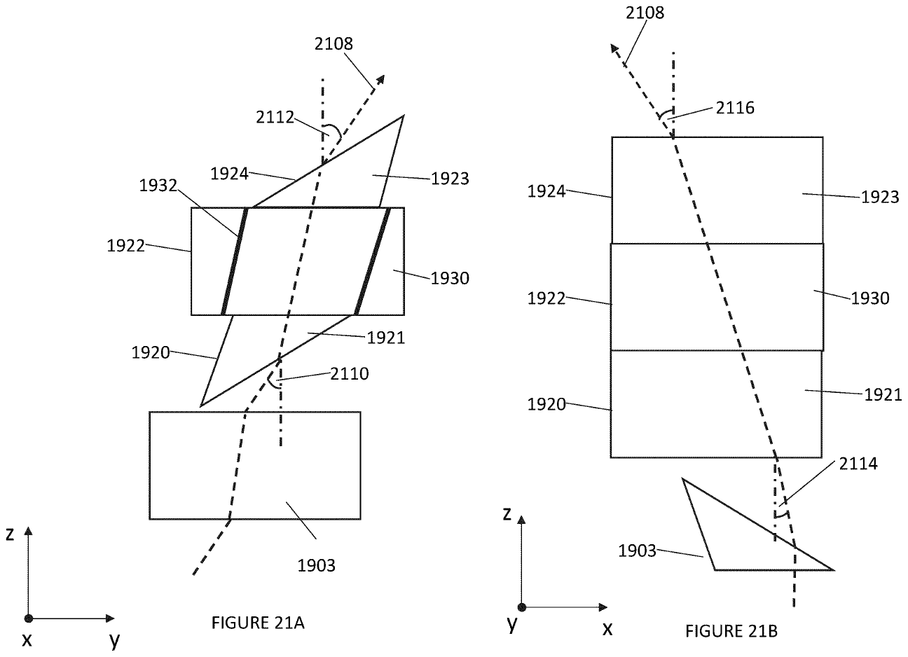

The replicas 1908 of the holographic wavefront emitted by the waveguide 1902 are received by the turning layer 1903 whereby the (replicas of) the holographic wavefront are turned by the turning layer 1903. The turned replicas 1908 are then received by the reflection suppression device 1900. The reflection suppression device 1900 comprises a layered structure which comprises a first layer 1920, an intermediate layer 1922, and a second layer 1924. The first layer 1920 is closest to the waveguide 1908/turning layer 1903. As such, the (replicas of) holographic wavefront (propagating through the reflection suppression device 1900) are received in turn by the first layer 1920, the intermediate layer 1922 and the second layer 1924. The specific arrangement of each of the layers of reflection suppression device 1900 will now be described in more detail with reference to FIGS. 20, 21A and 21B.

FIG. 20 is schematic perspective view of the reflection suppression device 1900 in combination with the turning layer 1903. FIGS. 21A and 21B are different schematic cross-sectional views of a portion of the reflection suppression device 1900 and a corresponding portion of the turning layer 1903. FIGS. 21A and 21B shows the path of a holographic wavefront through the turning layer 1903 and the reflection suppression device 1900. The cross-section in FIG. 21A is in a first plane. The cross-section in FIG. 21B is in a second orthogonal to the first plane. Specifically, the first plane is the y-z plane and the second plane is the x-z plane. In other words, both the first and second plane contain a direction parallel to the surface normal of the waveguide 1902 (i.e. the z-direction). The cross-section of FIG. 21A is a very similar view to that of FIG. 19 (showing the replicas 1908 being emitted from waveguide 1908 at an angle with respect to the normal of the waveguide). The cross-section section of FIG. 21B instead shows the replicas 1908 as appearing to be emitted from the waveguide 1908 perpendicularly to the normal of the first surface 1904 of the waveguide 1902 (because, in this example, the replicas 1908 are emitted without a component being in the x-direction).

The first (bottom) layer 1920 comprises a first serrated surface 1928. An opposing face of the first layer 1920 is a non-serrated (planar) surface. The non-serrated surface of the first layer 1920 is in contact with, and adhered to, a surface of the intermediate layer 1922.

The first layer 1920 is a prismatic structure comprising a plurality/an array of prism elements 1921. The first layer 1920 is integrally formed such that the array of prism elements 1921 form a single component (forming the first layer 1920). The first serrated surface 1928 is defined by first angled surface of each of the prism elements 1921, thus forming a sawtooth-type structure when viewed in the y-z plane (as in FIGS. 19 and 21A, for example). The first layer 1920 is formed of a transparent material which, in this example, is a hard plastic (transparent) material. The first layer 1920 may have been manufactured by, for example, injection moulding, hot embossing, extruding or cutting a source of the transparent material.

The intermediate layer 1922 comprises a transparent material 1930 separating an array of individual louvres 1932. Each louvre 1932 is in the form of a slat, the length of which extends substantially in the x-direction. The louvres 1932 are embedded in the transparent material 1930. In this example, the transparent material 1930 is a material having the same refractive index as the material forming the first layer 1920.

The second (top) layer 1924 comprises a second serrated surface 1929. An opposing face of the second layer 1924 is a non-serrated (planar) surface. The non-serrated surface of the second layer 1924 is in contact with, and adhered to, an opposite surface of the intermediate layer 1922 to the non-serrated surface of the first layer 1920.

The second layer 1924 is a prismatic structure comprising a plurality/an array of prism elements 1923. Like the first layer 1920, the second layer 1924 is integrally formed such that the array of prism elements 1923 form a single component (forming the first layer 1922). The second serrated surface 1929 is defined by first angled surfaces of each of the prism elements 1923, thus forming a sawtooth-type structure when viewed in the y-z plane (as in FIGS. 19 and 21A, for example). The second layer 1924 is formed of a transparent material which, in this example, is a hard plastic (transparent) material. In this example, the second layer 1924 is formed of the transparent material as the first layer 1920 (or, at least, a material having the same refractive index as the transparent material of the first layer 1920). The second layer 1924 may have been manufactured by, for example, injection moulding, hot embossing, extruding or cutting a source of the transparent material.

A periodicity of the serrations of the first and second serrated surfaces 1928, 1929 is equal. Furthermore, the periodicity of the louvres 1932 in the array of louvres is equal to the periodicity of the serrations of the first and second serrated surfaces. Thus, for each serration of the first serrated surface 1928 of the first layer there is a corresponding serration of the second serrated surface 1929 of the second layer and a corresponding louvre 1932.

The first and second layers 1920, 1924 have a thickness in the z-direction. This thickness is defined between the respective serrated surface and non-serrated surface. As is clear from FIGS. 19 and 20A at least, the thickness of the first and second layers varies along the length of each serration (in the y-direction) because of the angled surfaces of each microstructure. The serrations of the first layer are angled in magnitude but opposite in direction to the serration of the second layer. Specifically, an angle a normal of each angled first surface of the first serrated surface 1928 to a normal of the waveguide is, in this example, equal in magnitude but opposite in polarity to an angle between each angled first surface of the second serrated surface 1929 to a normal of the waveguide.

Each of the first and second layers 1920, 1924 are formed of a transparent material which, in this example, has a refractive index greater than 1. Each of the first and second serrated surfaces 1928, 1929 form a transparent material/air interface. Light (in particular, the holographic wavefront 1908) propagating through reflections suppression device will be turned, twice. A first turn will be provided by the first layer 1920 and a second turn will be provided by the second layer 1924. The shape of the serrations, and the refractive index of the transparent material, are selected such that the component of the first turn on the first plane (the y-z plane) is equal but opposite to the component of the second turn on the first plane (the y-z plane).

The first serrated surface 1928 of the reflection suppression device 1900 may be referred to herein as an input side of the reflection suppression device 1900 (because the first serrated surface 1928 receives the holographic wavefront). The second serrated surface 1929 of the reflection suppression device 1900 may be referred to herein as an output side of the reflection suppression device 1900 (because the second serrated surface 1929 emits the holographic wavefront once the holographic wavefront has propagated though the reflection suppression device 1900).

The turning layer 1903, in this example, also has a prismatic structure. However, the prism elements 1935 of the turning layer 1903 extend longitudinally in a direction that is orthogonal to the direction of extension of the prism elements of the first and second layers. Specifically, the prism elements 1935 extend longitudinally in the y-direction rather than the x-direction. As such, the prism elements 1935 are arranged to turn the holographic wavefront exclusively on the second plane (in the y-z plane) rather than on the first plane (the x-z plane). The turns performed by the turning layer 1903 and the first and second layers 1920, 1924 of the reflection suppression device 1900 are shown most clearly in FIGS. 21A and 21B.

FIGS. 21A and 21B show the path followed by one replica 2108 of the holographic wavefront through the turning reflection suppression device 1900. FIG. 21A shows this path when viewed in the first (y-z) plane. FIG. 21B shows this path when viewed in the second (x-z) plane.

The holographic wavefront 2108 is first received by the turning layer 1903, propagates through the turning layer 1903 and is then emitted at an opposite side of the turning layer 1903. As above, the prism elements 1935 of the turning layer 1903 extend substantially in the y direction so, in the y-z plane, the thickness of an individual prism element 1930 for any given cross-section (e.g. the cross-section in FIG. 21A) is substantially uniform. In particular, in the y-z plane, the surface of the turning layer 1903 that receives the holographic wavefront 2108 is, in this example, substantially parallel to the opposing surface of the turning layer 1903 that emits the holographic wavefront 2108. Thus, the received and emitted holographic wavefront 2108 are parallel in the y-z plane shown in FIG. 21A. However, in a cross-section in the x-z plane, the thickness of an individual prism element 1930 varies (in the x-direction). Thus, the received and emitted holographic wavefront 2108 are not parallel in the x-z plane shown in FIG. 21B. In other words, the turning layer 1903 provides a net turn on the holographic wavefront 2108 which is exclusively in the x-z plane.

After being emitted by the turning layer 1903, the holographic wavefront 2108 is received by the first serrated surface 1928 of the first layer 1920. The first turn (referred to above) on the holographic wavefront 2108 is provided by the first layer 1920 as a result of the angle of the first serrated surface 1928 and the refractive index of the first layer 1920. In this example, the refractive index of the materials forming the first, intermediate, and second layers 1920, 1922, 1924 is substantially the same. Thus, the holographic wavefront 2108 is not turned at either a first layer-intermediate layer interface or an intermediate layer-second layer interface as the holographic wavefront 2108 propagates through each respective layer. This is the case in both the x-z and γ-z planes. When the holographic wavefront 2108 is emitted at the second serrated surface 1929 of the second layer the second turn (referred to above) is provided by the second layer (as a result of the angle of the second serrated surface 1929 and the refractive index of the second layer 1924.

In this example, the first turn has a first component on the first plane (y-z) and a second component on the second plane (x-z) and the second turn has a first component on the first plane and a second component on the second plane. The component of the first turn on the first plane is equal and opposite to the component of the second turn on the first plane. This is represented in FIG. 21A by the fact that angle 2110 between the incoming holographic wavefront 2108 at the input side of the reflection suppression device 1900 and the z-direction is equal in magnitude to the angle 2112 between the outgoing holographic wavefront 2108 and the z-direction at the output side of the reflection device 1900 and the z-direction, but opposite in direction. Thus, the net turn in the first plane by the reflection suppression device is zero.

Similarly, the component of the first turn on the second plane is equal and opposite to the component of the second turn on the second plane. This is represented in FIG. 21B by the fact that angle 2114 between the incoming holographic wavefront 2108 at the input side of the reflection suppression device 1900 and the z-direction is equal in magnitude to the angle 2116 between the outgoing holographic wavefront 2108 at the output side of the reflection device 1900 and the z-direction, but opposite in direction (i.e. one turn is clockwise and one is anti-clockwise). The effect of this is that the first and second turns have negligible effect on the angle of the holographic wavefront 2108 emitted by the reflection suppression device relative to the angle of the holographic wavefront 2108 received by the reflection suppression device.

The first reflection suppression device 1900 described above achieves net-zero angles of turn between an input side and an outside side. This is desirable such that the reflection suppression device 1900 does not unintentionally alter the angle of the holographic wavefront, particularly in the first plane. In the first example, a net turn in the second plane is achieved, however, using a turn layer.

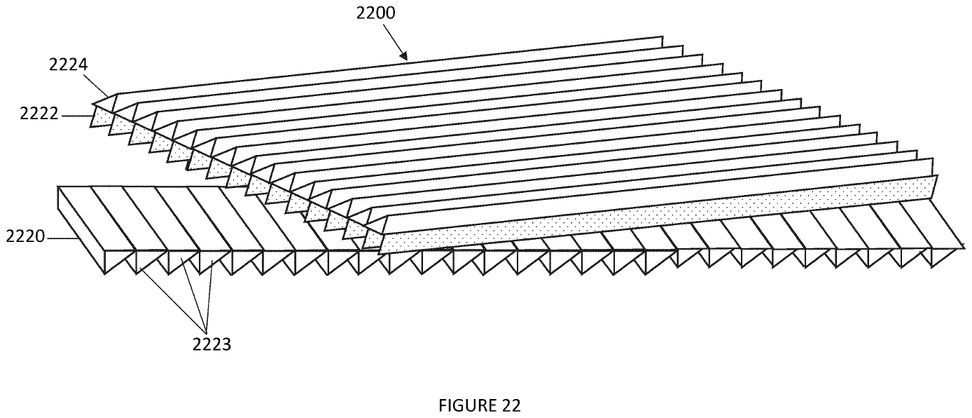

The inventors have recognized that the first and/or second layer may be arranged to achieve a net-zero angle of turn between the input and the output in the first plane while achieving a non-zero net angle of between the input and the output in the second plane. In this way, the turn layer may advantageously be removed while maintaining the advantageous net-zero angle of turn in the first plane. Such a reflection suppression device is shown in FIG. 22.

FIG. 22 is a schematic perspective view of a second reflection suppression device 2200. The second reflection suppression device 2200 comprises a first (bottom) layer 2220, an intermediate layer 2222, and a second (top) layer 2224. The intermediate layer 2222 is between the first layer 2220 and the second layer 2224. The intermediate layer 2222 and the second layer 2224 are identical to the intermediate layer 1922 and the second layer 1924 of the first reflection suppression device 1900. However, the first layer 2220 of the second reflection suppression device differs to the first layer 1920 of the first reflection suppression device. In particular, while the first layer 2220 comprises an array of prism elements 2223, the prism elements 2223 do not extend longitudinally in the x-direction. Instead, each prism element 2223 extends longitudinally in a direction lying in the x-y plane and that is angled with respect to the x-direction and γ-direction. In this example, the angle between the x-direction and the direction of longitudinal extension of each prism element 2223 is 45 degrees. Likewise, in this example, the angle between the y-direction and the direction of longitudinal extension of each prism element 2223 is 45 degrees. However, it should be clear to the skilled reader that these angles may take other non-zero angles, and may not be 45 degrees.

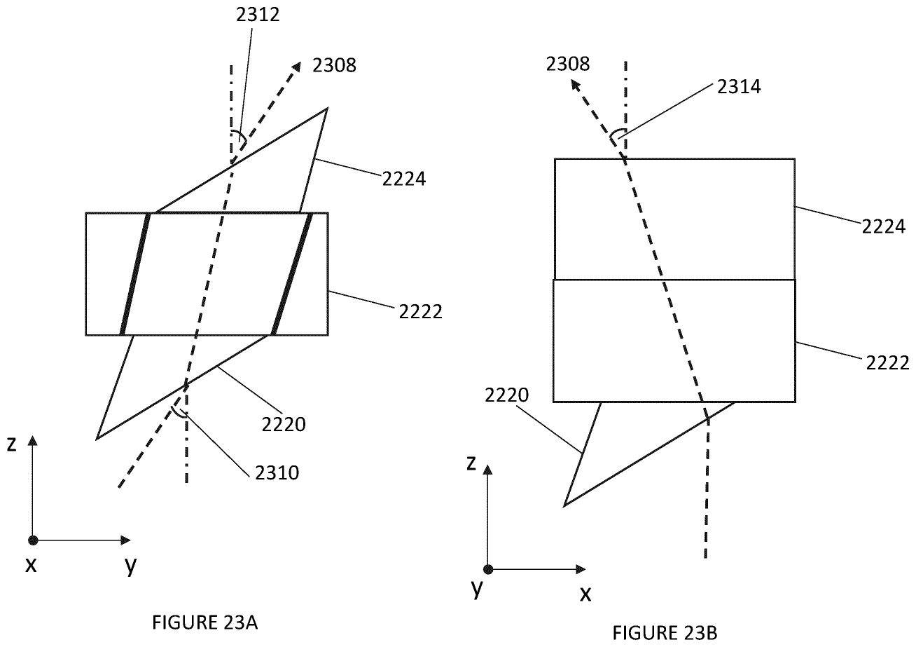

By providing the first layer 2220 having prism elements 2223 extending in this way, a non-zero net turn in the second plane may be achieved using the reflection suppression device 2200 such that the reflection suppression device 2200 may replace the turning layer 1903 of FIG. 19. This is demonstrated in FIGS. 23A and 23B.

FIGS. 23A and 23B are different schematic cross-sectional views of a portion of the reflection suppression device 2200. FIGS. 23A and 23B shows the path of a holographic wavefront 2308 through the reflection suppression device 2200. The cross-section in FIG. 23A is in the first plane (the y-z plane). The cross-section in FIG. 23B is in the second plane (the x-z plane).

Unlike in the first reflection suppression device, in the second reflection suppression device, each prism element of the first layer 2220 forms a structure having a varying thickness in both the first plane and the second plane. However, the serration of the second layer still only forms a structure having a varying thickness in the first plane.

In the first plane, cross-sections of the serrations of the first and second layers may have substantially the same shapes as in FIG. 21A. Thus a net-zero turn is achieved on the first plane. This is represented in FIG. 23A by the fact that angle 2310 between the incoming holographic wavefront 2308 at the input side of the reflection suppression device 2200 and the z-direction is equal in magnitude to the angle 2312 between the outgoing holographic wavefront 2208 at the output side of the reflection device 2100 and the z-direction, but opposite in direction. In the second plane (in FIG. 23B), the cross-section of the serrations of the second layer has substantially the same shape as in FIG. 21B (in particular, having a non-varying thickness). However, the cross-section of the serrations of the first layer do having a varying thickness. This result in a non-net zero turn is being achieved on the second plane. This is represented in FIG. 23B by the fact that angle between the incoming holographic wavefront 2308 at the input side of the reflection suppression device 2200 and the z-direction is zero but the angle 2314 between the outgoing holographic wavefront 2308 at the outside side of the reflection suppression device 2200 and the z-direction is non-zero.

In the second reflection suppression device, a non-zero net turn in the second plane (to replicate the function of the turning film) is achieved by angling the prism elements of the first layer only in the x-y plane. The prism elements of the first layer are thus arranged to provide a non-zero net turn in the second plane while maintaining a zero net turn in the first plane. As the skilled reader will appreciate, a non-zero net turn in the second plane could alternatively be achieved by angling the prism elements of the second layer in the x-y plane, or angling both the prism elements of the first and second layers in the x-y plane.

### Additional Glare Mitigation Features

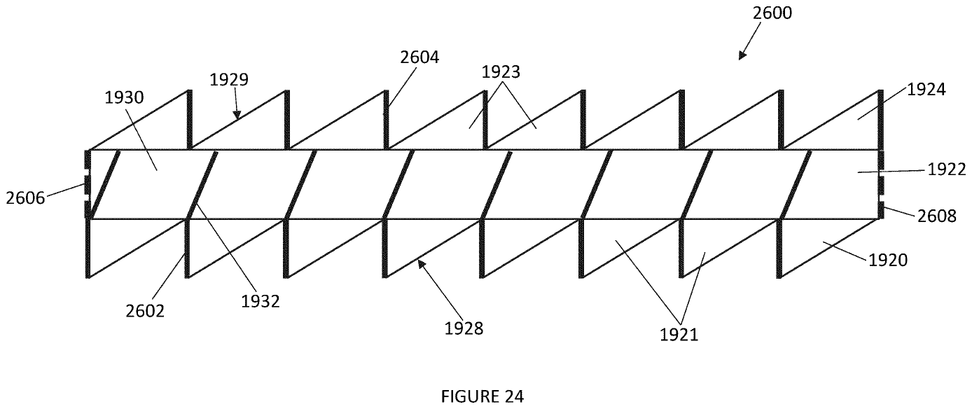

FIG. 24 shows a third reflection suppression device 2600. The third reflection suppression device is similar to the first reflection suppression device 1900, and like features are numbered accordingly. However, the third reflection suppression device 2600 comprises some additional glare mitigation features.

A first additional glare mitigation feature is that minor faces 2606, 2608 of the reflection suppression device (extending between the first and second serrated surfaces 1928, 1929) are provided to reduce reflection of light incident thereon or transmission therethrough. In this example, this is because the minor faces 2606, 2608 comprise an opaque, diffuse, black paint, represented by the broken (dashed) lines in the drawing. Alternatively, these minor faces 2606, 2608 could be frosted to diffusely scatter light.

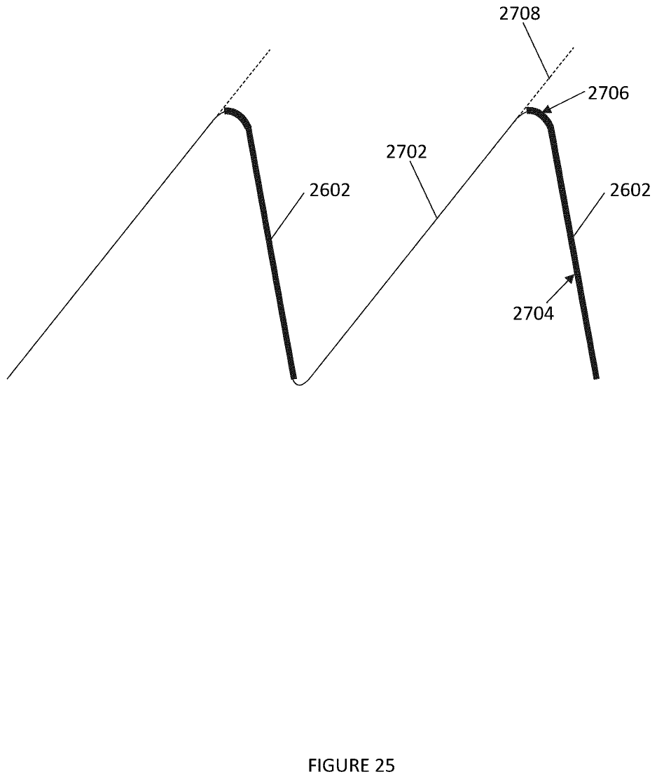

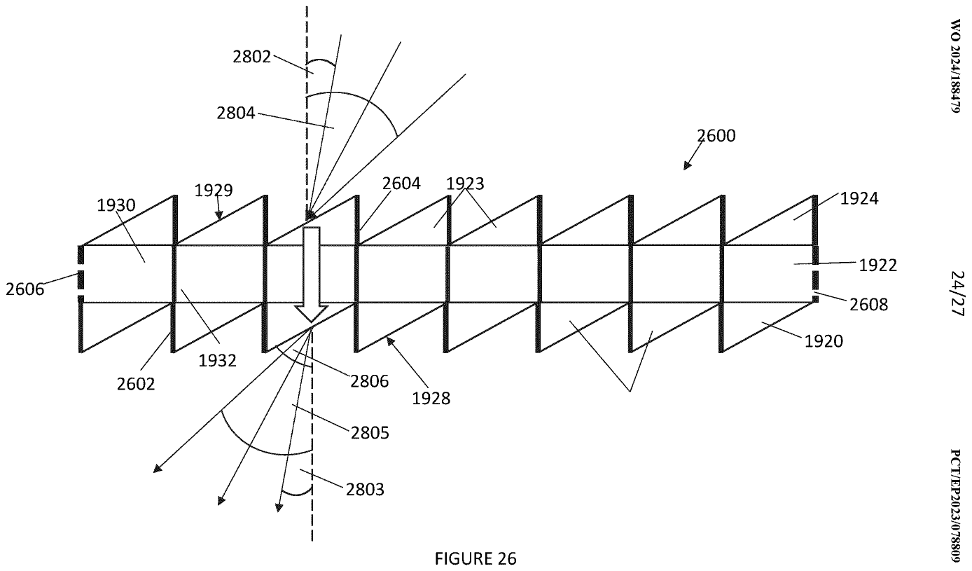

A second additional glare mitigation feature is that surfaces of the first and second serrated surfaces 1928, 1929 comprise a coating 2602,2604 (respectively) which, in this example, is a black paint. This is shown in more detail in FIG. 25, which shows a close-up of two serrations of one of the serrated surfaces. Each serration comprises a first facet surface 2702 and a second facet surface 2704. Each second facet surface 2704 comprises a coating of black paint 2602, as described above. Each first and second facet surface is connected by a corner 2706. In this example, the corner 2706 is a rounded corner, having a radius of curvature of about 20 micrometres. Ideally, the corner 2706 would be a sharp edged corner and, when viewed from afar with the naked eye (as in FIG. 24) may appear to be a sharp edged corner. But, because of limitations of any manufacturing method, in reality, the corner ends up being slightly rounded because an exactly sharp corner is not possible to achieve. The inventors have found that the rounded nature of the corner can be a source of glare at some angles. To prevent from the corner 2706, the paint 2602 is extended beyond the second facet surface 2704 to at least partially cover the rounded corner 2706. The paint therefore prevents glare from being formed by the rounded corners 2706. The inventors have found that it may be preferable for the paint to extend around the rounded corner 2706 to a point whereby a tangent 2708 to said point is parallel to the first facet surface 2702. This is what is shown in FIG. 25 in which the tangent 2708 is represented by a broken line 2708. The inventors have found that another source of glare could be caused by sunlight which propagates through the reflection suppression device, is reflected by the waveguide and is then incident on the first serrated surface again. The inventors have found that it may preferable to angle the first serrated surface in such a way that such sunlight cannot be specularly reflected back on a path which passes through the reflection suppression device again (via the waveguide) to an eye-box. This is shown in FIG. 26.

FIG. 26 shows the third reflection suppression device 2600 but with possible light ray paths through the reflection suppression device 2600 represented by arrows. In particular, FIG. 26 shows a minimum angle (represented by angle 2802) and a maximum angle (represented by angle 2804) that light may be incident on the reflection suppression device 2600 and pass through each of the second, intermediate and first layers. The angles 2802, 2804 are both with respect to a normal represented by the broken line in FIG. 26. The difference between angles 2802 and 2804 corresponds to a range of angles over which light rays may pass through the reflection suppression device. The light rays exit the reflection suppression device 2600 over a similar range of angles extending between a minimum angle 2803 and a maximum angle 2805. The range of angles is determined by a) the pitch and angle of the louvres of the array of louvres; and b) the arrangement of the serrated layers.

The inventors have found, through thorough simulation and experimentation, that the angle of the first facets of the first surface (relative to the normal) should be larger than the maximum angle of the light rays. This is shown by angle 2608 in FIG. 26.

### Ninth Example—Further Example of Method of Manufacture

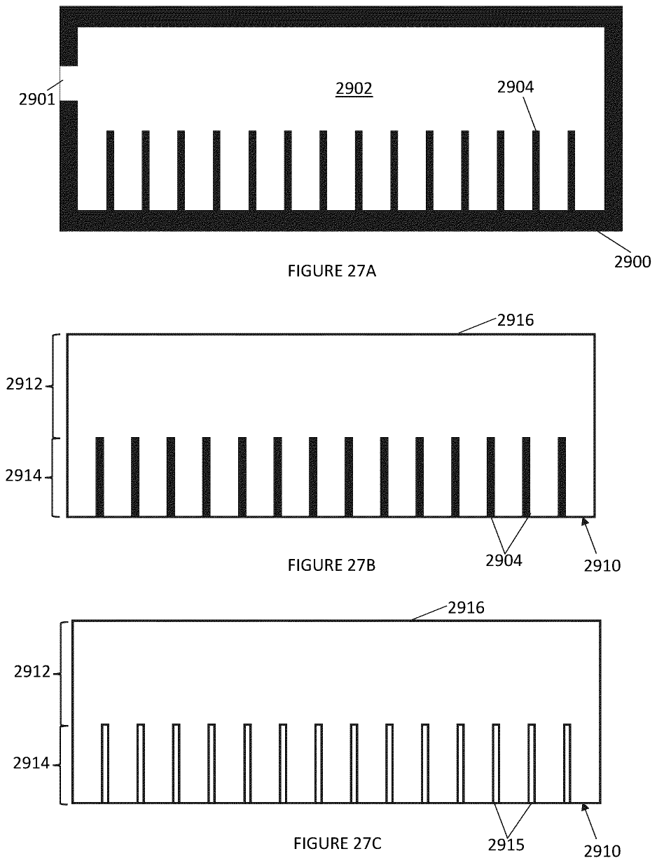

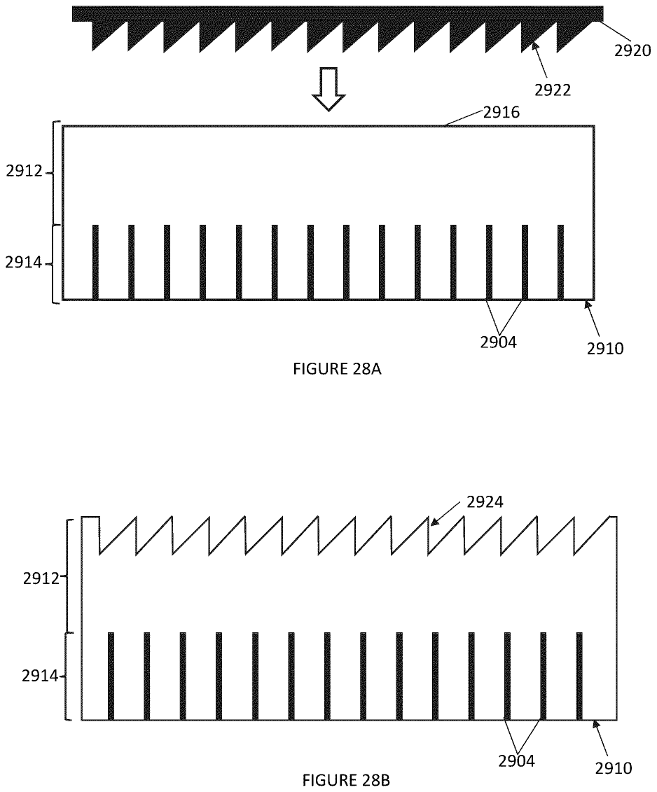

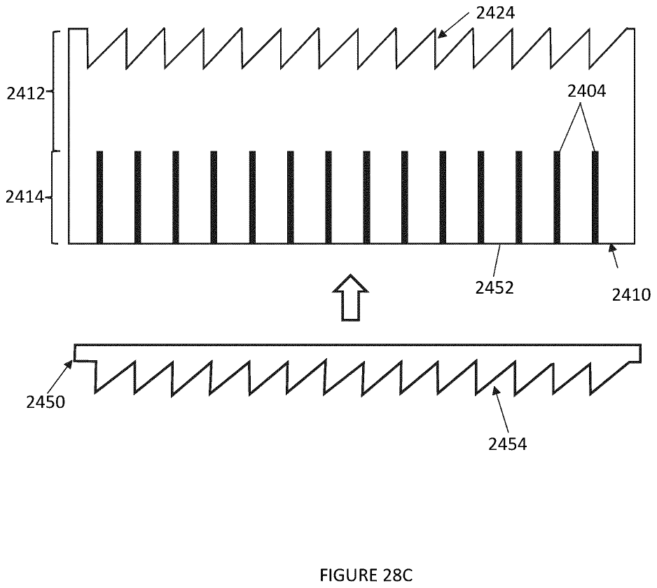

A ninth example of a method of manufacturing a reflection suppression device is described in relation to FIGS. 27A to 27C and 28A to 28C. The ninth example is another method comprising injection moulding. The ninth method comprises injection moulding molten transparent material into a mould to form a first component of the reflection suppression device.

An injection mould 2900 for manufacturing the reflection suppression device by injection moulding is shown in FIG. 27A. FIG. 27A is a cross-sectional view of the mould 2900. The mould 2900 comprises an input port 2901 and a mould body 2902. The mould further comprises a plurality of inserts 2904. The method comprises injecting molten transparent material into an input port 2901 of the mould to fill the mould body 2902 and then allowing the molten transparent material to cool/set/cure. This forms a transparent body 2910. The transparent body 2910 is then removed from the mould.

In some examples, the plurality of inserts 2904 become integrally formed with the transparent body 2910 and are embedded in the transparent body 2910. In such examples, the inserts 2904 are removed from the mould together with the transparent body 2910. This is shown in FIG. 27B. In FIG. 27B, the inserts 2904 form a plurality of louvres in the transparent body 2910. The inserts 2904 comprise light absorbing material. The transparent body 2910 comprises a top portion 2912 and a bottom portion 2914. The inserts 2904 (forming louvres) are contained in the bottom portion.

In some examples, the plurality of inserts 2904 remain part of the mould 2900 (for example, are integrally formed with the body 2902 of the mould). In such examples, the inserts 2904 form blind channels 2915 in the bottom portion 2914 of the transparent body 2900 when removed from the mould 2900. The method further comprises forming an array of louvres by filling the inserts with light absorbing material.

The method of the ninth example further comprises further processing the transparent body 2910 to form a serrated surface. This is shown in FIGS. 28A and 28B. FIG. 28A shows hot embossing a top surface 2916 of the transparent body 2902 using a stamp 2920. The stamp 2920 comprises a serrated surface 2924 such that the stamp 2920 forms a corresponding serrated surface 2924 in the top portion 2912 of the transparent body 2902.

Optionally, the method of the ninth example further comprises applying an additional layer 2950 to a bottom surface 2952 of the device. The additional layer 2950 comprises another serrated surface 2954. The serrated surface 2954 of the additional layer 2950 may be referred to as a first serrated surface. The serrated surface 2924 of the transparent body 2910 may be referred to as a second serrated surface. The first and second serrated surfaces may have the features described above in relation to FIGS. 19 to 23B.

### Additional Features

The methods and processes described herein may be embodied on a computer-readable medium. The term “computer-readable medium” includes a medium arranged to store data temporarily or permanently such as random-access memory (RAM), read-only memory (ROM), buffer memory, flash memory, and cache memory. The term “computer-readable medium” shall also be taken to include any medium, or combination of multiple media, that is capable of storing instructions for execution by a machine such that the instructions, when executed by one or more processors, cause the machine to perform any one or more of the methodologies described herein, in whole or in part.

The term “computer-readable medium” also encompasses cloud-based storage systems. The term “computer-readable medium” includes, but is not limited to, one or more tangible and non-transitory data repositories (e.g., data volumes) in the example form of a solid-state memory chip, an optical disc, a magnetic disc, or any suitable combination thereof. In some example embodiments, the instructions for execution may be communicated by a carrier medium. Examples of such a carrier medium include a transient medium (e.g., a propagating signal that communicates instructions).

It will be apparent to those skilled in the art that various modifications and variations can be made without departing from the scope of the appended claims. The present disclosure covers all modifications and variations within the scope of the appended claims and their equivalents.

The following numbered clauses are also disclosed:

1. A method of manufacturing a reflection suppression device, the method comprising:
a first step of forming a first component of the reflection suppression device by processing a transparent material to form a serrated surface, wherein processing the transparent material comprises at least one selected from the group comprising extruding, injection moulding, hot embossing or cutting the transparent material; and
a second step of forming a second component of the reflection suppression device by processing a light absorbing material to form a plurality of louvres arranged in an array, wherein processing the light absorbing material comprises at least one selected from the group comprising: adjoining, gluing, painting or supporting the light absorbing material in a support structure,
wherein at least one of the first and second steps comprises at least partially fixing the first component and second component together such that a periodicity of the serrated surface is equal to a periodicity of the array of louvres.

2. A method of manufacturing a reflection suppression device as defined in item 1, wherein the serrated surface of the first component is a first serrated surface and wherein the first step of the method further comprises processing the transparent material to form a second serrated surface opposite to the first serrated surface.

3. A method of manufacturing a reflection suppression device as defined in item 1 or 2, wherein the first step comprises integrally forming the first component as a single component.

4. A method of manufacturing a reflection suppression device as defined in item 1, 2 or 3, wherein the transparent material is provided in the form of an unshaped piece of material and wherein the first step comprises extruding, hot embossing or cutting the unshaped piece of material to form the first component.

5. A method of manufacturing a reflection suppression device as defined in any one of items 1 to 3, wherein the first step comprises injection moulding the transparent material into a mould.

6. A method of manufacturing a reflection suppression device as defined in item 5, wherein the transparent material is a liquid during the first step of the method.

7. A method of manufacturing a reflection suppression device as defined in item 5 or 6, wherein the second step comprises supporting the light absorbing material in a support structure, the support structure being defined within the mould.

8. A method of manufacturing a reflection suppression device as defined in item 7, wherein the second step of the method is performed before the first step of the method.

9. A method of manufacturing a reflection suppression device as defined in any one of items 5 to 8, wherein the mould comprises one or more cavities arranged such that the injection moulded first component comprises a frame and a plurality of serrated transparent elements.

10. A method of manufacturing a reflection suppression device as defined in any preceding item, wherein the second step comprises forming the louvres such that each louvre has a width defined between a proximal end and a distal end and each louvre is arranged at an orientation angled relative to the plane containing the reflection suppression device, and wherein the separation between adjacent louvres is such that the distal end/edge of one louvre overlaps with the proximal end of the adjacent louvre.

11. A method of manufacturing a reflection suppression device as defined in any preceding item, wherein the light absorbing material comprises a light absorbing paint and wherein the second step of the method comprises painting.

12. A method of manufacturing a reflection suppression device as defined in any one of items 1 to 10, wherein the light absorbing material is a continuous strip and wherein the second step of the method comprises adjoining or gluing the light absorbing material.

13. A method of manufacturing a reflection suppression device as defined in any of items 1, 2 or 4 to 12, wherein the first step comprises forming a plurality of transparent elements.

14. A method of manufacturing a reflection suppression device as defined in item 13, wherein first step comprises assembling the plurality of transparent elements to form the first component.

15. A method of manufacturing a reflection suppression device as defined in item 14, wherein the first step of the method may comprise at least partially fixing a plurality of the transparent elements on to a transparent substrate

16. A method of manufacturing a reflection suppression device as defined in item 15, wherein the transparent substrate is formed of a first transparent material and the transparent elements is formed of a second transparent material, the second transparent material being softer than the first transparent material.

17. A method of manufacturing a reflection suppression as defined in any preceding item, further comprising a third step of at least partially fixing a diffractive film to the first component on a surface of the first component opposite to the serrated surface.

18. A head-up display for a vehicle, wherein the head-up display comprises an optical component having a reflective surface arranged, during head-up display operation, in a configuration that is conducive to sunlight glare; and a reflection suppression device disposed on the optical component to receive sunlight on an optical path to the reflective surface, wherein the reflection suppression device is a reflection suppression device manufactured according to any one of the preceding items, the reflection suppression device comprising a first component formed of transparent material and having a serrated surface and a second component comprising a plurality of louvres in an array, each louvre comprising a light absorbing material; and wherein the first component and the second component are at least partially fixed together such that a periodicity of the serrated surface is equal to a periodicity of the array of louvres.

1. A head-up display for a vehicle, the head-up display comprising:
a substantially planar waveguide having a reflective surface arranged, during head-up display operation, in a configuration that is conducive to sunlight glare; and
a reflection suppression device, wherein the reflection suppression device comprises:
a first layer comprising a first serrated surface arranged to receive a holographic wavefront from the waveguide and provide a first turn of the holographic wavefront having at least a component on a first plane containing a surface normal of the waveguide, wherein the first layer is formed of a transparent material;
an intermediate layer arranged to receive the holographic wavefront from the first layer, wherein the intermediate layer comprises a plurality of louvres in an array, each louvre comprising a light absorbing material; and
a second layer arranged to receive the holographic wavefront from the intermediate layer, wherein the second layer comprises a second serrated surface arranged to provide a second turn of the holographic wavefront having at least a component on the first plane, and wherein the component of the second turn on the first plane is equal and opposite to the component of the first turn on the first plane.

2. The head-up display as claimed in claim 1, comprising a turning layer arranged to receive the holographic wavefront from the waveguide and provide a turn having a component on a second plane containing a surface normal of the waveguide.

3. The head-up display as claimed in claim 2, wherein the second plane is orthogonal to the first plane.

4. The head-up display as claimed in claim 2, wherein the turning layer is adjacent to the first layer of the reflection suppression device such that the first layer is arranged to receive the holographic wavefront from the turning layer.

5. The head-up display as claimed in claim 2, wherein at least one of the first and second layers of the reflection suppression device form the turning layer.

6. The head-up display as claimed in claim 5, wherein the reflection suppression device is arranged such that a net turn of the holographic wavefront on the second plane is non-zero.

7. The head-up display as claimed in claim 5, wherein the reflection suppression device is arranged in accordance with at least one of the following:
the first layer is arranged such that a magnitude of the component of the first turn on the second plane is greater than a magnitude of the component of the second turn on the second plane;
the second layer is arranged such that the magnitude of the component of the second turn on the second plane is greater than the magnitude of the component of the first turn on the second plane; or
the first and second layer are arranged such that the components of the first and second turns on the second plane are in the same direction.

8. The head-up display as claimed in claim 1, wherein, in a cross-section of the first and second layers that is parallel to the first plane, the serrations of the second serrated surface are substantially parallel to the respective serrations of the first serrated surface.

9. The head-up display as claimed in claim 1, wherein a periodicity of the first serrated surface is substantially equal to a periodicity of the array of louvres.

10. The head-up display as claimed in claim 1, wherein the first layer and second layer comprise a substantially transparent material having a refractive index greater than 1.

11. The head-up display as claimed in claim 1, wherein a thickness of the first layer in the first plane is defined between the first serrated surface and an opposing second surface of the first layer, and wherein the thickness of the first layer in the first plane varies along a length of each individual serration in the first plane in a first direction.

12. The head-up display as claimed in claim 11, wherein a thickness of the second layer in the first plane is defined between the second serrated surface and an opposing second surface of the second layer, and wherein the thickness of the second layer in the first plane varies along a length of each individual serration in the first plane in a first direction.

13. The head-up display as claimed in claim 12, wherein the thickness of a first layer varies differently to the thickness of the second layer in the first direction.

14. The head-up display as claimed in claim 1, wherein an angle of light received at an input side of the reflection suppression device relative to the angle of light transmitted at an output side of the reflection suppression device in the first plane is zero.

15. The head-up display as claimed in claim 1, wherein each of the first layer and the second layers each comprise a plurality of microstructures arranged to form the respective serrated surface of the first and second layer.

16. The head-up display as claimed in claim 15, wherein the microstructures of at least one of the first and second layers extend longitudinally in a second direction, the second direction being substantially parallel to a longitudinal extension of the louvres.

17. The head-up display as claimed in claim 16, wherein the microstructures of one of the first and second layers extend longitudinally in the second direction while the microstructures of the other of the first and second layers extend longitudinally in a third direction that is different to the second direction, and wherein the second and third directions lie in a third plane that is perpendicular to the normal of the waveguide.

18. The head-up display as claimed in claim 1, wherein the intermediate layer comprises a substantially transparent material that has a refractive index that is substantially equal to the refractive index of the substantially transparent material of the first layer.

19. The head-up display as claimed in claim 1, wherein each serration of the first or second serrated surface comprises a first facet surface and a second facet surface meeting at a respective rounded corner, at least a portion of each rounded corner of the first and/or second layer comprising a coating to suppress specular reflection of light incident thereon.

20. The head-up display as claimed in claim 19, wherein a tangent to each serration corner is defined at a first position on the rounded corner, the tangent being parallel to a plane of the respective first facet, wherein the coating extends extend from the second facet at least to the first position on the rounded corner.

21. The head-up display as claimed in claim 1, wherein the reflection suppression device is arranged such that light rays pass therethrough only at a specific range of angles, and wherein one or more light receiving surfaces of the first or second serrated surface makes an angle with respect to a normal of a plane defined by the second layer, the angle being greater than a maximum of the range of angles.

22. A method of manufacturing a layered reflection suppression device that is for a head-up display for a vehicle and for receiving a holographic wavefront from the head-up display, wherein the method comprises:
providing a first layer formed of a transparent material, the first layer comprising a first serrated surface;
providing an intermediate layer comprising a plurality of louvres in an array, each louvre comprising a light absorbing material;
providing a second layer formed of a transparent material, the second layer comprising a second serrated; and
at least partially fixing the first layer to a surface of the intermediate layer and the second layer to an opposing surface of the intermediate layer to provide the reflection suppression device;
wherein the first layer is arranged to provide a first turn of the holographic wavefront having at least a component on a first plane containing a surface normal of the intermediate layer; and
wherein the second layer is arranged to provide a second turn of the holographic wavefront having at least a component on the first plane, the component of the second turn on the first plane being equal and opposite to the component of the first turn on the first plane.

23. The method as claimed in claim 22, wherein at least partially fixing the first layer and second layer to opposing surface of the intermediate layer comprises laminating the first, intermediate and second layers.
